(19) United States
(12) Patent Application Publication
(10) Pub. No.: US 2021/0299672 A1
(43) Pub. Date: Sep. 30, 2021

(54) RACK FOR SAMPLE TUBES

(71) Applicant: BECTON, DICKINSON AND COMPANY, Franklin Lakes, NJ (US)

(72) Inventors: Daniel Justin Lohan, Perkasie, PA (US); Alexandre Daviet, Mungret (IE); Rohini Rao, Baltimore, MD (US); Sharon Leitch, Shrewsbury, PA (US); Ammon David Lentz, York, PA (US); Stephen LaChance, Cockeysville, MD (US)

(21) Appl. No.: 17/344,561

(22) Filed: Jun. 10, 2021

Related U.S. Application Data
(63) Continuation of application No. PCT/US2019/065363, filed on Dec. 10, 2019.
(60) Provisional application No. 62/779,926, filed on Dec. 14, 2018.
(60) Provisional application No. 62/892,263, filed on Aug. 27, 2019.

(51) Int. Cl. B01L 9/06; B01L 3/00

(52) U.S. Cl. CPC B01L 9/06; B01L 2200/16; B01L 2200/025; B01L 3/52

(57) ABSTRACT

An apparatus for holding sample tubes for sample preparation is provided. The apparatus includes a sample tube holder with an opening to accept a sample tube. The apparatus includes a hinge assembly with a hinge plate and a hinge support, wherein the hinge plate is movable relative to the hinge support. In one example, the hinge plate pivots in two rotation directions and slides in two translational directions relative to the hinge support. The hinge plate limits vertical movement of the sample tube within the sample tube holder. In one aspect, a method includes inserting a sample tube into an opening of a sample tube holder and pivoting and sliding a hinge plate relative to a hinge support, wherein the hinge plate limits vertical movement of the sample tube within the sample tube holder.

### CROSS REFERENCE TO RELATED APPLICATION

This application is a continuation of International Application No. PCT/US2019/065363, filed Dec. 10, 2019, which claims the benefit of U.S. Provisional Application No. 62/779,926, filed Dec. 14, 2018, and U.S. Provisional Application No. 62/892,263, filed Aug. 27, 2019, which are hereby incorporated by reference in their entirety.

### BACKGROUND

### Field

The technology described herein generally relates to racks for holding samples and various reagents. The technology more particularly relates to sample tube holders that accept and retain complementary sample tubes, each of which contain a sample for carrying out a predetermined processing operation with one or more reagents, such as preparing biological samples for amplifying and detecting polynucleotides extracted from the samples.

### Description of the Related Art

The medical diagnostics industry is a critical element of today's healthcare infrastructure. At present, however, diagnostic analyses no matter how routine have become a bottleneck in patient care. There are several reasons for this. First, many diagnostic analyses can only be done with highly specialist equipment that is both expensive and only operable by trained clinicians. Such equipment is found in only a few locations—often just one in any given urban area. This means that most hospitals are required to send out samples for analyses to these locations, thereby incurring shipping costs and transportation delays, and possibly even sample loss or mishandling. Second, the equipment in question is typically not available ‘on-demand’ but instead runs in batches, thereby delaying the processing time for many samples because they must wait for a machine to fill up before they can be run.

Understanding that sample flow breaks down into several key steps; it would be desirable to consider ways to automate as many of these as possible. For example, a biological sample, once extracted from a patient, must be put in a form suitable for a processing regime that typically involves using an amplification method, including but not limited to polymerase chain reaction (PCR), TMA, SDA, NASBA, LCR, and Rolling-Cycle Amplification, to amplify a vector of interest. Once amplified, the presence of a nucleotide of interest from the sample needs to be determined unambiguously. Preparing samples for PCR is currently a time-consuming and labor intensive step, though not one requiring specialist skills, and could usefully be automated. By contrast, steps such as PCR and nucleotide detection have customarily only been within the compass of specially trained individuals having access to specialist equipment.

Sample preparation is labor intensive in part because of the number of reagents required, and the need for multiple liquid transfer (e.g., pipetting) operations. Furthermore, the reagents required are of sufficient variety that they typically require different handling from one another and are available from different vendors. Even where reagents can be collected together in a single holder and made ready for use, such as described in application U.S. patent application Ser. No. 12/218,416, filed on Jul. 14, 2008 (and entitled “Reagent Tube, Reagent Holder, and Kits Containing Same”, in the name of Wilson, et al.) and incorporated herein by reference, it would be beneficial to be able to set up a number of sample tubes and reagent holders for use in batches, and to make them available to liquid dispensing tools that can operate on sample tubes and reagent holders in parallel. U.S. patent application Ser. No. 15/017,977, filed on Feb. 8, 2016 and entitled “Rack for Sample Tubes and Reagent Holders”, in the name of Duffy, et al. is also incorporated in its entirety.

The discussion of the background herein is included to explain the context of the technologies described herein. This is not to be taken as an admission that any of the material referred to was published, known, or part of the common general knowledge as of the priority date of any of the claims.

Throughout the description and claims of the specification the word “comprise” and variations thereof, such as “comprising” and “comprises”, is not intended to exclude other additives, components, integers or steps.

### SUMMARY

In some embodiments, an apparatus for holding sample tubes is provided. The apparatus can include a sample tube holder comprising an opening configured to accept a sample tube. The apparatus can include a hinge assembly comprising a hinge plate and a hinge support. In some embodiments, the hinge plate configured to slide and pivot relative to the hinge support between a first configuration and a second configuration. In some embodiments, the hinge plate positioned to permit insertion of the sample tube in the opening in the first configuration. In some embodiments, the hinge plate positioned to limit vertical movement of the sample tube within the sample tube holder in the second configuration.

In some embodiments, the apparatus can include a slide lock coupled to the hinge plate. In some embodiments, the slide lock is configured to slide and pivot relative to a hinge pin, wherein the hinge pin is coupled to the hinge support. In some embodiments, the apparatus can include a spring configured to bias the slide lock against an interior surface of the hinge support. In some embodiments, the apparatus can include a reagent housing. In some embodiments, the sample tube holder and the reagent housing are coupled. In some embodiments, the hinge support and the reagent housing are coupled. In some embodiments, the sample tube holder comprises a plurality of openings configured to accept a plurality of sample tubes. In some embodiments, the sample tube holder comprises two openings configured to accept the sample tube. In some embodiments, the opening constrains the sample tube in a horizontal direction when the sample tube is received in the sample tube holder. In some embodiments, the hinge plate is configured to limit vertical movement of the sample tube within the sample tube holder. In some embodiments, the hinge plate comprises a minor indent along an edge of the hinge plate, wherein the minor indent is configured to overlie a cap of the sample tube. In some embodiments, the hinge plate comprises a major indent along an edge of the hinge plate, wherein the major indent is configured to allow a sample tube to be removed from or inserted into the sample tube holder. In some embodiments, the apparatus can include the sample tube. In some embodiments, the apparatus can include a self-locking tab positioned relative to the hinge plate.

In some embodiments, a method is provided. The method can include pivoting a hinge plate relative to a hinge support. The method can include sliding the hinge plate relative to the hinge support once pivoted, wherein the hinge plate is configured to limit vertical movement of the sample tube within the sample tube holder.

In some embodiments, the hinge plate slides under the biasing force of a spring. In some embodiments, a top surface of the hinge plate is rotated away from a vertical axis of the sample tube when the sample tube is inserted, and wherein the hinge plate is pivoted to be generally perpendicular to the vertical axis of the sample tube. The method can include inserting a pipette tip into the sample tube when the sample tube is within the sample tube holder and the hinge plate has pivoted and slid. The method can include removing a pipette tip from the sample tube when the sample tube is within the sample tube holder and the hinge plate has pivoted and slid.

In some embodiments, an apparatus for holding sample tubes is provided. The apparatus can include a sample tube holder comprising an opening configured to accept a sample tube. The apparatus can include a hinge assembly comprising a hinge plate and a hinge support. In some embodiments, the hinge plate is configured to slide and pivot relative to the hinge support between a first configuration and a second configuration. In some embodiments, the hinge plate positioned to permit insertion of the sample tube in the opening in the first configuration. In some embodiments, the hinge plate positioned to limit vertical movement of the sample tube within the sample tube holder in the second configuration.

In some embodiments, the apparatus can include a reagent housing comprising a slot configured to accept a reagent holder. In some embodiments, the opening is arranged in line with the slot. In some embodiments, the sample tube holder and the reagent housing are coupled. In some embodiments, the hinge support and the reagent housing are coupled. In some embodiments, the sample tube holder comprises a plurality of openings configured to accept a plurality of sample tubes. In some embodiments, the sample tube holder comprises two openings configured to accept the sample tube. In some embodiments, the opening constrains the sample tube in a horizontal direction when the sample tube is received in the sample tube holder. In some embodiments, the hinge plate is configured to apply a force to limit vertical movement of the sample tube within the sample tube holder. In some embodiments, the apparatus is configured to be received in a receiving bay comprising a partition, and wherein the hinge plate is pivoted by the partition when the apparatus is received in the receiving bay. In some embodiments, the hinge plate comprises an indent along an edge of the hinge plate, wherein the indent is configured to abut a cap of the sample tube. In some embodiments, the hinge plate is pivoted when the apparatus is inserted into a diagnostic apparatus. In some embodiments, the apparatus can include the sample tube.

In some embodiments, a method is provided. The method can include inserting a sample tube into an opening of a sample tube holder. The method can include pivoting a hinge plate relative to a hinge support, wherein the hinge plate is configured to limit vertical movement of the sample tube within the sample tube holder.

In some embodiments, pivoting the hinge plate further comprises inserting the sample tube holder into a diagnostic apparatus. In some embodiments, pivoting the hinge plate further comprises contacting the hinge plate with a partition in a receiving bay of the diagnostic apparatus. In some embodiments, the method can include inserting a pipette tip into the sample tube when the sample tube is within the sample tube holder. In some embodiments, the method can include removing a pipette tip from the sample tube when the sample tube is within the sample tube holder.

### BRIEF DESCRIPTION OF THE DRAWINGS

FIG. 1 shows a front perspective view of a first embodiment of a rack for samples tubes and reagent holders.

FIG. 2 shows a back perspective view of the rack of FIG. 1.

FIG. 3 shows a top view of the rack of FIG. 1.

FIG. 4 shows a side view of the rack of FIG. 1.

FIG. 5 shows a front view of the rack of FIG. 1.

FIG. 6 shows a back view of the rack of FIG. 1.

FIG. 7 shows a front perspective view of a sample tube holder of the rack of FIG. 1.

FIG. 8 shows a back perspective view of the sample tube holder of FIG. 7.

FIG. 9 shows a front perspective view of a hinge assembly of the rack of FIG. 1.

FIG. 10A shows a back perspective view of the hinge assembly of FIG. 9.

FIG. 10B shows a back exploded view of the hinge assembly of FIG. 9.

FIG. 11A shows a first side view of the hinge assembly of FIG. 9.

FIG. 11B shows a second side view of the hinge assembly of FIG. 9.

FIG. 12 shows a top view of the hinge assembly of FIG. 9.

FIG. 13 shows an exploded front perspective view of a portion of the hinge assembly of FIG. 9.

FIG. 14 shows an exploded front perspective view of the hinge assembly of FIG. 9.

FIGS. 15A-15C show views of a sample tube holder of the rack of FIG. 1.

FIGS. 16A-16B show views of a sample tube holder of the rack of FIG. 1.

FIG. 17 shows a front perspective view of a diagnostic apparatus and the rack of FIG. 1.

FIG. 18 shows a front perspective view of a diagnostic apparatus.

FIGS. 19A-19B shows a front perspective view of a second embodiment of a rack for samples tubes and reagent holders.

FIGS. 20A-20B shows back perspective views of the rack of FIG. 19A.

FIG. 21 shows a top view of the rack of FIG. 19A.

FIG. 22 shows a side view of the rack of FIG. 19A.

FIG. 23 shows a front view of the rack of FIG. 19A.

FIG. 24 shows a back view of the rack of FIG. 19A.

FIG. 25 shows a front perspective view of a sample tube holder of the rack of FIG. 19A.

FIG. 26 shows a back perspective view of the sample tube holder of FIG. 25.

FIG. 27 shows a front perspective view of a hinge assembly of the rack of FIG. 19A.

FIG. 28 shows a back perspective view of the hinge assembly of FIG. 27.

FIG. 29 shows a front exploded view of the hinge assembly of FIG. 27.

FIGS. 30A-30B show a front views of the hinge assembly of FIG. 27.

FIG. 31 shows a top view of the hinge assembly of FIG. 27.

FIG. 32 shows a front perspective view of a portion of the hinge assembly of FIG. 27.

FIG. 33 shows a front perspective view of a portion of the hinge assembly of FIG. 27.

FIG. 34 shows a top perspective view of a portion of the hinge assembly of FIG. 27.

FIG. 35 shows a top view of a self-locking tab of the rack of FIG. 19A.

FIG. 36 shows a bottom view of the self-locking tab of FIG. 35.

FIG. 37 shows a perspective view of the self-locking tab of FIG. 35.

FIG. 38 shows a side view of the self-locking tab of FIG. 35.

FIG. 39 shows a back view of the self-locking tab of FIG. 35.

FIGS. 40A-40D show views of a sample tube holder of the rack of FIG. 19A.

FIGS. 41A-41B show views of a sample tube holder of the rack of FIG. 19A.

### DETAILED DESCRIPTION

Described herein are hinge assemblies designed for preventing vertical movement or liftoff of a sample tube from a sample tube holder during pipetting operations. The hinge assemblies can include a hinge support coupled to a movable hinge plate. The hinge support can remain stationary and, in some embodiments, remains coupled to a reagent housing of a rack during motion of the hinge plate, for example pivoting and sliding motions of the hinge plate relative to the reagent housing of the rack. The hinge assemblies can include one or more hinge pins, wherein the hinge plate is configured to pivot relative to the hinge support via the one or more hinge pins. In some methods of use, a force is applied to the hinge plate to rotate the hinge plate into contact with one or more sample tubes. In some embodiments, the force can be applied by a partition in a receiving bay that receives the rack. For example, the force can be applied by the partition when the rack makes physical contact with a feature in the receiving bay as the rack is inserted into the receiving bay.

The hinge assembly reliably restrains one or more sample tubes in the sample tube holder. One motion caused by the actuation force can pivot and slide the hinge assembly and thus lock the sample tubes in position. Once pivoted and slid into position, the hinge plate can be designed to contact the plurality of sample tubes simultaneously, thereby securing each sample tube held by the sample tube holder. The hinge assembly, once pivoted and slid, can prevent the sample tubes from experiencing vertical lift during pipetting operations, thereby increasing pipetting efficiency. As described further herein, the sample tubes are advantageously vertically restrained in one motion, reliably and consistently by the hinge assembly.

In some embodiments, the act of placing the rack into a receiving bay simultaneously pivots and slides the hinge plate and locks the sample tubes into place, thereby preventing movement of the sample tubes during subsequent pipetting operations performed on the rack. Prior to lowering the rack into a receiving bay, the sample tube can be easily loaded into the sample tube holder. The hinge plate is pivoted and slid to make contact with the plurality of sample tubes and restrain the plurality of sample tubes in the sample tube holder. The hinge plate applies a consistent and repeatable force to each sample tube in the sample tube holder. The hinge plate allows for easy loading and unloading of the sample tubes, thereby minimizing user error and time to load and unload the rack.

Described herein are racks for supporting, carrying, and transporting reagents and samples for various purposes, in particular in connection with sample preparation in a clinical context. The rack permits placement and retention of one or more sample tubes. The rack permits placement of one or more corresponding reagents holders. The sample tubes and reagent holders can be positioned to carry out liquid dispensing processes, associated with sample preparation such as for polynucleotide amplification. The arrangement of the rack can minimize cross-sample contamination and permit multiple sample preparations to be performed from multiple clinical samples, in series or in parallel.

In some embodiments, the sample in the sample tube is obtained from a source, including an environmental or biological source. In some embodiments, the sample is suspected of having one or more analytes of interest. Biological samples may be obtained from animals (including humans) and encompass fluids, solids, tissues, and gases. Biological samples include urine, saliva, and blood products, such as plasma, serum and the like. The sample tubes can receive any gaseous, liquid, or solid sample. A sample may be provided as a blood sample, a tissue sample (e.g., a swab of, for example, nasal, buccal, anal, or vaginal tissue), a biopsy aspirate, a lysate, as fungi, or a bacteria. The polynucleotides to be amplified can be contained within particles (e.g., cells such as white blood cells, or red blood cells), tissue fragments, bacteria (e.g., gram positive bacteria, or gram negative bacteria), fungi, or spores. One or more liquids (e.g., water, a buffer, blood, blood plasma, saliva, urine, cerebral spinal fluid (CSF), or organic solvent) can be part of the sample and/or is added to the sample during a processing step. The sample tubes can receive any biological or environment sample. Such examples are not however to be construed as limiting the sample types applicable to the present disclosure.

The racks are configured to be insertable into, and removable from, a diagnostic apparatus. The racks are configured for use by the diagnostic apparatus that carries out automated sample preparation, for example, on multiple samples separately or simultaneously. The diagnostic apparatus can carry out sample preparation on multiple reagents separately or simultaneously. The racks as described herein can be used to analyze any nucleic acid containing sample for any purpose, including but not limited to genetic testing, and clinical testing for various infectious diseases in humans.

It will be understood that embodiments of the systems described herein are not limited to racks insertable into and removable from a diagnostic apparatus, nor racks used to analyze nucleic acids. Embodiments of the hinge assembly according to the present disclosure can be implemented in any suitable rack that receives sample tubes.

In one non-limiting example, preparation of an amplification-ready sample can include one or more of the following steps: contacting a neutralized polynucleotide sample with an amplification reagent mixture comprising a polymerase enzyme and a plurality of nucleotides, and optionally a positive control plasmid and a fluorogenic hybridization probe selective for at least a portion of the plasmid; and/or reconstituting a lyophilized pellets with liquid to create an amplification reagent mixture solution. In some embodiments, the reagent holders provide all of the reagents required to prepare an amplification-ready sample. It will be understood that reagent holders and sample tubes described herein are provided by way of example and are not intended to limit the present disclosure. Embodiments of the present disclosure can be implemented with other suitable reagent holders and sample tubes.

### A FIRST EXAMPLE RACK ACCORDING TO THE PRESENT DISCLOSURE

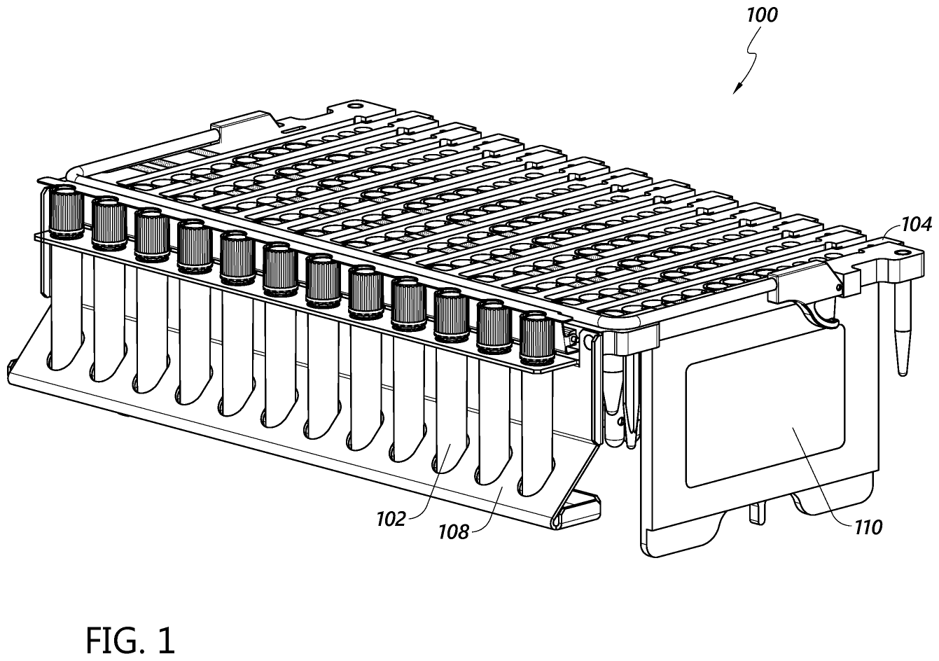

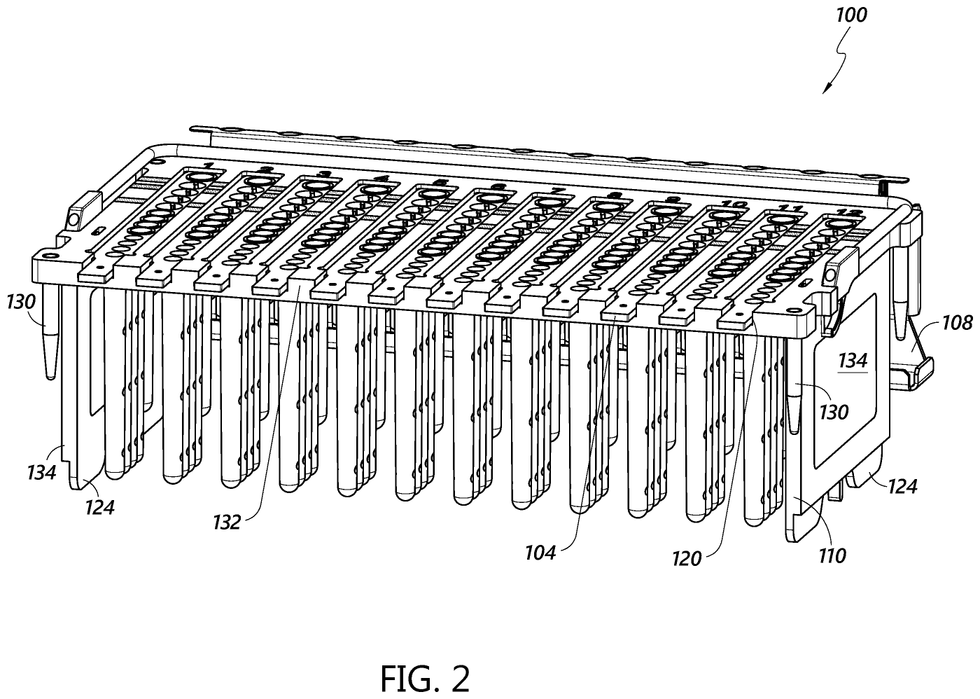

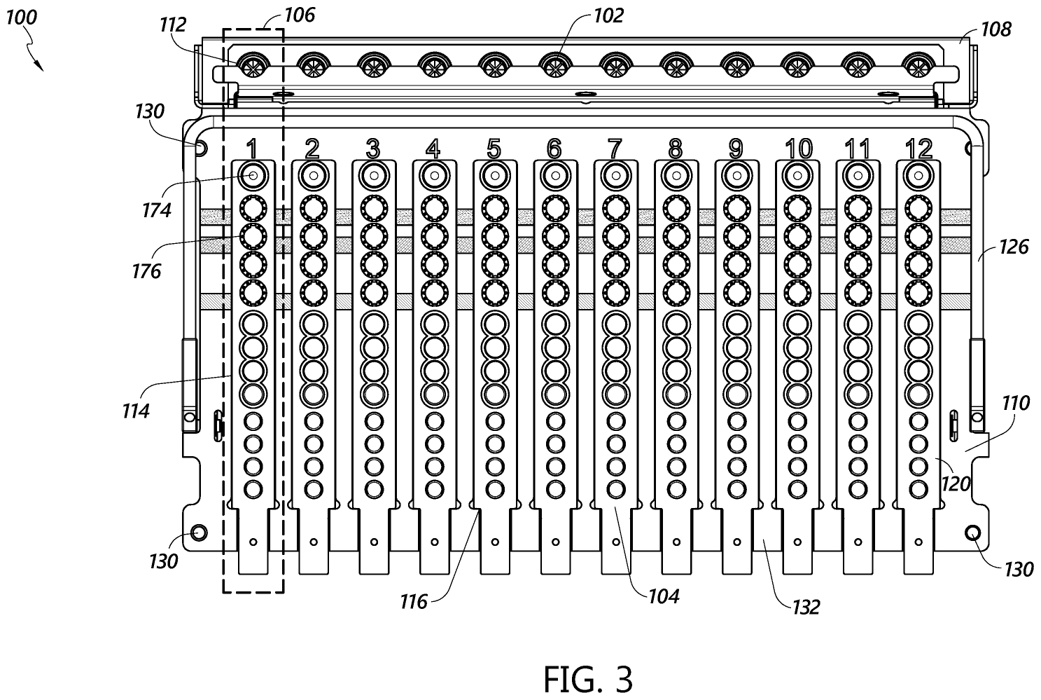

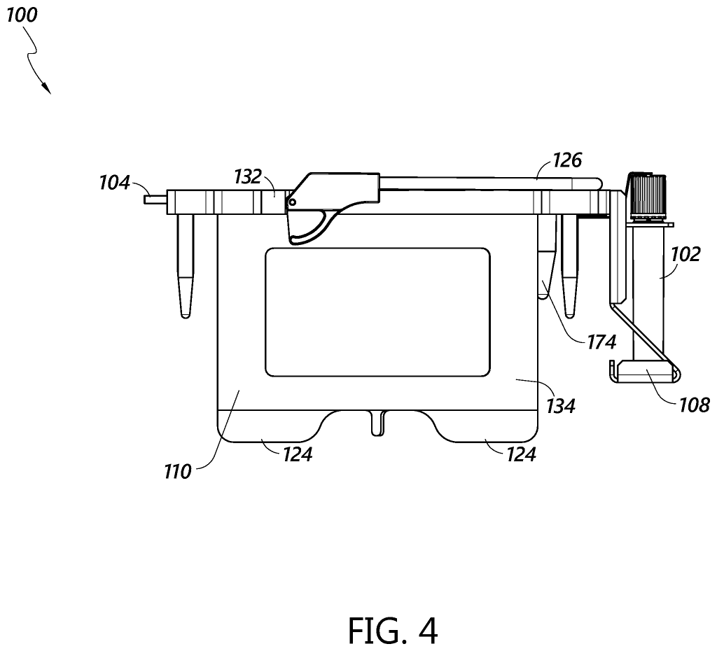

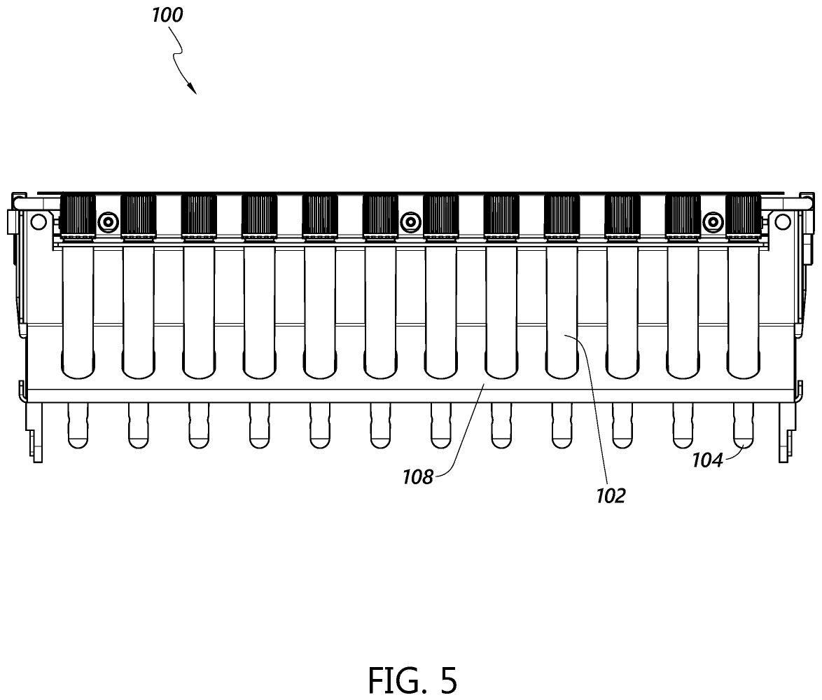

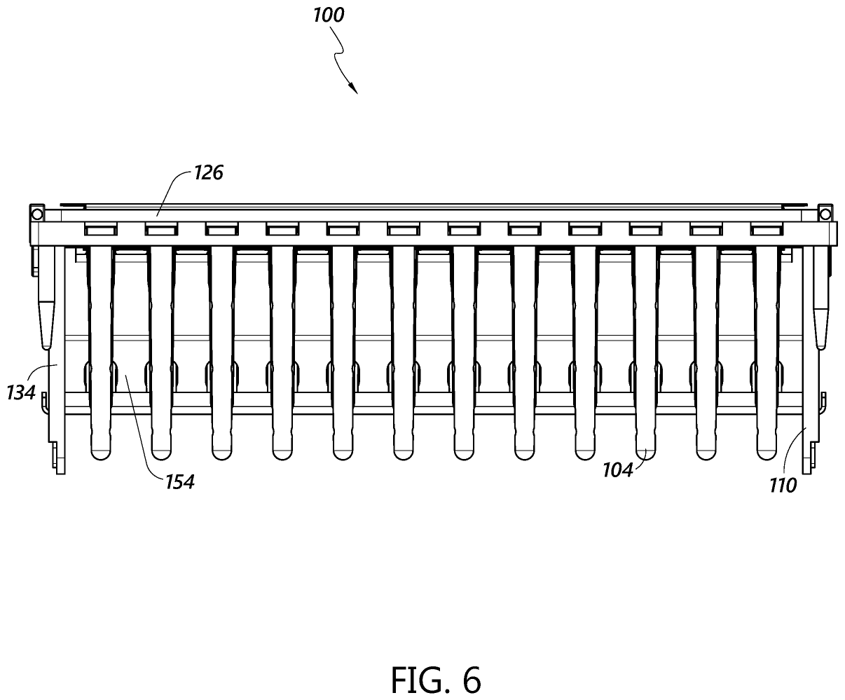

FIGS. 1-6 illustrate a rack 100 according to a first embodiment of the present disclosure. FIG. 1 shows a front perspective view of the rack 100. FIG. 2 shows a back perspective view of the rack 100. FIG. 3 shows a top view of the rack 100. FIG. 4 shows a side view of the rack 100. FIG. 5 shows a front view of rack 100. FIG. 6 shows a back view of rack 100. The rack 100 is configured to receive a plurality of sample tubes 102, and to receive a plurality of reagent holders 104. The rack 100 accepts these components in such a manner that the sample tubes 102 and reagent holders 104 can be separately and independently loaded from one another. The sample tubes 102 are in one-to-one correspondence with the reagent holders 104 in this non-limiting embodiment. Other configurations are contemplated, for example two samples tubes 102 to one reagent holder 104 or one sample tube 102 to two reagent holders 104.

The reagent holders 104 each contain reagents to extract polynucleotides from a sample and place the polynucleotides into an amplification-ready form. The reagent holder 104 can be designed for holding and transporting reagents for various purposes, including but not limited to sample preparation in a clinical context. The reagent holder 104 can comprise a process tube 174 used for various mixing and reacting processes that occur during sample preparation. For example, cell lysis can occur in process tube 174, as can extraction of nucleic acids, such as DNA or RNA of a patient, and DNA or RNA of a pathogen. The reagent holder 104 can include one or more reagent tubes 176, which can be integral with the reagent holder 104 or removable. The reagents can be in liquid or solid form, such as in lyophilized form, for carrying out extraction of nucleic acids from a sample that is associated with the rack 100. Sample preparation can include many different pipetting sequences in which a liquid dispenser pipettes substances into and out of the sample tubes 102 and the reagent holders 104 many different times.

The rack 100 is configured to accept twelve sample tubes 102 and twelve corresponding reagent holders 104. While the rack 100 is illustrated with twelve sample tubes 102, the rack 100 can receive any number of sample tubes 102. While the rack 100 is illustrated with twelve reagent holders 104, the rack 100 can receive any number of reagent holders 104. In some embodiments, the rack may accept 1, 2, 4, 6, 8, 10, 12, 16, 20, or 24 samples tubes 102. Each sample can be contained in a separate sample tube 102. In some embodiments, the rack may accept 1, 2, 4, 6, 8, 10, 12, 16, 20, or 24 reagent holders 104. Each reagent holder 102 can contain one or more reagents. Thus the embodiment of the rack 100 of FIG. 1 configured to receive twelve sample tubes 102 and twelve corresponding reagent holders 104 is exemplary. In some embodiments, the rack 100 is configured such that each of the plurality of sample tubes 102 is maintained at the same height relative to one another. In some embodiments, the rack 100 is configured such that each of the plurality of reagent holders 104 is maintained at the same height relative to one another.

The rack 100 accepts the plurality of sample tubes 102 and the plurality of reagent holders 104 in twelve lanes 106, with each lane 106 having one sample tube 102 and one reagent holder 104. The lane 106, as used herein in the context of the rack 100, is a dedicated region of the rack 100 designed to receive a sample tube 102 and corresponding reagent holder 104. While the rack 100 is illustrated with twelve lanes 106, the rack 100 can include any number of lanes 106.

The lanes 106 include a first lane and the second lane. The lanes 106 are parallel to one another. This configuration increases pipetting efficiency in some embodiments. Typically, when parallel to one another, pairs of adjacent sample lanes 106 are separated by 24 mm at their respective midpoints. Other distances are possible, such as 18 mm apart, or 27 mm apart. The distance between the midpoints can be dependent on the pitch of the nozzles in the liquid dispenser. Keeping the spacing in multiples of 9 mm enables easy loading from the rack 100 into a 96 well plate, where typically wells are spaced apart by 9 mm.

The rack 100 is configured to accept a number of sample tubes 102, such as those further described herein. The rack 100 is configured to hold and retain one or more such sample tubes 102. The rack 100 is configured to permit access to samples stored in the sample tubes 102, either on a laboratory benchtop, or situated in a dedicated region of the diagnostic apparatus. The rack 100 is configured to permit access to the sample tubes 102 to be accessed by one or more other functions of the diagnostic apparatus, such as automated pipetting.

Features of a non-limiting example rack that can be implemented in accordance with the present disclosure will now be described with reference to the rack 100 illustrated in the figures. It will be understood that other suitable racks can be implemented in accordance with the present disclosure and that the features of the rack 100 are not intended to limit embodiments of the hinge assembly described herein. The rack 100 is configured to accept a given sample tube 102 in such a way that the sample tube 102 is retained reversibly in place, and thereby remains steady while the sample is accessed in the sample tube 102. The rack 100 is configured to accept a given sample tube 102 in such a way that the sample tube 102 is held while the rack 100 is being carried from one place to another. The rack 100 is configured to retain a given sample tube 102 when the rack 100 is inserted into the diagnostic apparatus. The rack 100 is configured to accept a given sample tube 102 in such a way that the sample tube 104 is retained reversibly in place while a pipette tip enters and exits the sample tube 104. The rack 100 is configured to accept a given sample tube 102 and prevent vertical movement or liftoff during pipetting operations. Other suitable features and configurations of the rack 100 are possible.

The rack 100 can include two or more subcomponents. The rack 100 includes a sample tube holder 108 configured to accept the one or more sample tubes 102. In this non-limiting example, the rack 100 also includes a reagent housing 110 configured to accept the one or more reagent holders 104. The sample tube holder 108 and the reagent housing 110 can be coupled to form a unitary structure. The sample tube holder 108 and the reagent housing 110 can be reversibly coupled, for instance by the used of fasteners to allow assembly and disassembly of the sample tube holder 108 and the reagent housing 110. It will be understood that the sample tube holder 108 can be coupled to any suitable subcomponent, including but not limited to the reagent housing 110, in accordance with the present disclosure.

The rack 100 can be divided into one or more lanes 106. Each lane 106 of the rack 100 includes a first location 112 configured to accept a sample tube 102 and a second location 114 configured to accept a reagent holder 104. The first location 112 is located on the sample tube holder 108. The second location 114 is located on the reagent housing 110. Each lane 106 is arranged for processing of a sample contained within the sample tube 102 according to one or more sample processing steps, including mixing the sample with one or more reagents within the corresponding reagent holder.

In one non-limiting example, the rack 100 includes features to position and retain the reagent holder 104. In the illustrated embodiment, each of the second locations 114 in the respective lanes 106 comprises a mechanical key 116 configured to accept the reagent holder 104 in a single orientation. The reagent holder 104 slides horizontally into a slot 120 located in the reagent housing 110. The reagent holder 104 can engage with the reagent housing 110 via the mechanical key 116 that keeps the reagent holder 104 in place. For example, the mechanical key 116 can include a raised or recessed portion that, when engaging with a complementary portion of the reagent holder 104, permits the reagent holder 104 to snap into the second location 114. In some embodiments, an edge of the reagent holder 104 engages with a complementary groove in the upper portion of the slot 120. In some embodiments, the reagent holder 104 locks into place in the reagent housing 110, such as with a locking mechanism. The locking mechanism can be recognizable as locked by an audible or physical cue.

The reagent housing 110 can be configured so that the reagent holders 104, when positioned in the reagent housing 110, are aligned for proper pipette tip pick-up using a liquid dispenser. Furthermore, the second location 114 of each lane 106 can be deep enough to accommodate one or more pipette tips, such as contained in a pipette tip sheath, as described herein. The reagent holders 104, when positioned in the reagent housing 110, are configured to be acted upon by one or more components of the diagnostic apparatus as described herein.

The reagent housing 110 can include various features. The reagent housing 110 can have four feet 124 that serve to steady the reagent housing 110 and as position locators when inserting the rack 100 into the dedicated portion of the apparatus. The reagent housing 110 can include a handle 126. The handle 126 can be attached to the reagent housing 110 at any location, such as at a midpoint of the reagent housing 110. The portion of the reagent housing 110 that accepts the reagent holders 104 can be made of any suitable material including metals or plastics. The reagent housing 110 can be made of a metal, such as aluminum, that is both light but also can be machined to high tolerance. The reagent housing 110 can be made of a material that is sturdy enough to ensure that the reagent housing 110 remains stable when located in the diagnostic apparatus. The reagent housing 110 includes one or more registration members 130. The registration members 130 comprise four tight tolerance pegs, located one per corner of the reagent housing 110. The registration members 130 fit snugly and tightly into complementary holes in a receiving area, such as a recessed area, of the diagnostic apparatus and thereby stabilize the reagent housing 110 within the diagnostic apparatus.

The reagent housing 110 comprises a horizontal member 132, and two vertical members 134 connected to the horizontal member 132. Each of the vertical members 134 comprises two feet 124, but other configurations of the vertical member 134 and the feet 124 are contemplated. Each of the second location 114 of each respective lane 106 is a recessed portion within the horizontal member 132. The two vertical members 134 are configured to permit the reagent housing 110 to stand or maintain stability. The feet 124, attached symmetrically to the first and second vertical members 134 provide the reagent housing 110 with additional stability when positioned.

The rack 100 includes features to position and retain the sample tubes 102. The rack 100 is configured to accept a plurality of samples, each sample received in one individual sample tube 102. Samples received in the sample tubes 102 may be from a common source or a different source. As described above, each sample tube 102 is mounted adjacent to a corresponding reagent holder 104 in a single lane 106 of the rack 100.

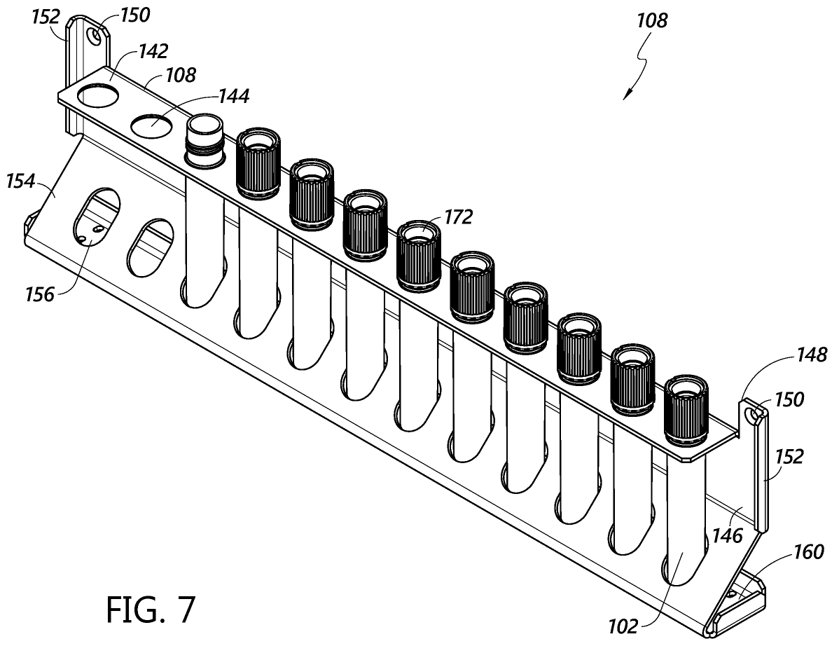

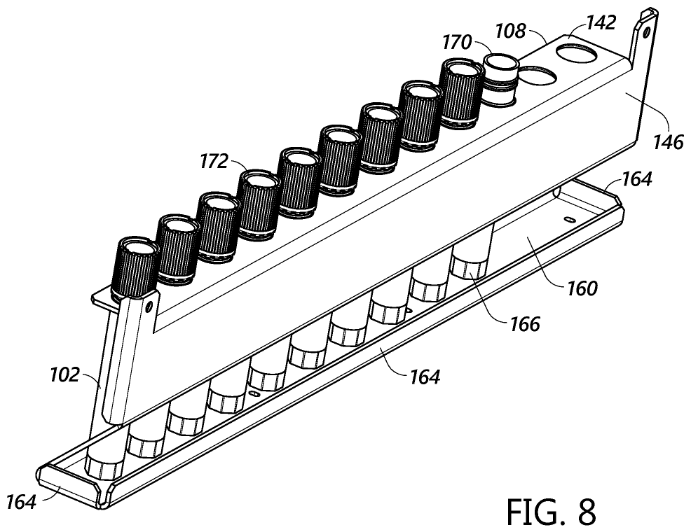

FIGS. 7 and 8 illustrate a non-limiting example sample tube holder 108 according to the present disclosure. FIG. 7 shows a front perspective view of the sample tube holder 108 and FIG. 8 shows a back perspective view of the sample tube holder 108. One non-limiting example of the sample tube holder 108 including a first portion 142, a second portion 146, a third portion 154, and a fourth portion 160 is described with reference to FIGS. 7 and 8. It will be understood, however, that a sample tube holder 108 of any suitable shape and form can be implemented in embodiments of the present disclosure and need not include all or any of the first, second, third, and fourth portions included in the illustrated embodiment.

The sample tube holder 108 includes the first portion 142. The first portion 142 is planar or substantially planar. The first portion 142 is horizontal or substantially horizontal. The first portion 142 includes a plurality of upper openings 144. The first portion 142 is configured to accept twelve sample tubes 102 through the twelve upper openings 144, respectively. While the sample tube holder 108 is illustrated with twelve upper openings 144, the sample tube holder 108 can include any number of upper openings 144. The upper openings 144 can be round or circular, but can have other cross-sectional shapes depending on the features of the sample tube 102. The number of upper openings 144 can correspond to the number of sample tubes 102 in a one-to-one correspondence. The first portion 142 can include one or more rounded edges such as rounded corners or bends to connect the first portion 142 to another portion of the sample tube holder 108.

The sample tube holder 108 includes the second portion 146. The second portion 146 is planar or substantially planar. The second portion 146 is vertical or substantially vertical. The second portion 146 can extend along a portion of a length of a sample tube 102, for instance at least 30% of the length, at least 40% of the length, at least 50% of the length, at least 60% of the length, at least 70% of the length, or any range of the foregoing values. The second portion 146 includes upper posts 148. The upper posts 148 can extend vertically upward from the first portion 142. Each upper post 148 has an opening 150 configured to accept a fastener there through. Any segment of the second portion 146 can include the one or more openings 150.

The sample tube holder 108 is configured to couple with the reagent housing 110 such that the two components of the rack 100 are rigidly connected. The opening 150 of the sample tube holder 108 is configured to align with a corresponding opening in the reagent housing 110. Any suitable fastener (for example but not limited to a screw or pin) can extend through an opening 150 of the sample tube holder 108 and a corresponding opening in the reagent housing 110 to couple the sample tube holder 108 to the reagent housing 110. While two openings 150 are illustrated, the sample tube holder 108 can include any number of openings 150.

The second portion 146 can include one or more rails 152. The rail 152 extends horizontally from the side of the second portion 146. The rail 152 extends the length of the second portion 146, or a portion thereof. The rail 152 extends in the same direction as the first portion 142.

The sample tube holder 108 of this non-limiting example includes the third portion 154. It will be understood that other example sample tube holders 108 according to the present disclosure may not include a third portion 154 and may only include some or all of the first portion 142, the second portion 146, the fourth portion 160, or any combination of these portions arranged to retain the sample tubes 102. In this example, the third portion 154 is oriented at a diagonal between the second portion 146 and the fourth portion 160. The third portion 154 extends in the same direction as the first portion 142. The first portion 142 and the third portion 154 are skewed. The third portion 154 includes a plurality of lower openings 156. The third portion 154 is configured to accept twelve sample tubes 102 through the twelve lower openings 156, respectively. While the sample tube holder 108 is illustrated with twelve lower openings 156, the sample tube holder 108 can include any number of lower openings 156. The number of lower openings 156 can correspond to the number of sample tubes 102 in a one-to-one correspondence. The lower opening 156 can have any suitable cross-sectional shape, including but not limited to an oblong, elongated opening, an oval opening, and a circular opening. The lower opening 156 is shaped and configured to accommodate the circumference of the sample tube 102. The third portion 154 can include one or more rounded edges such as rounded corners or bends to connect the third portion 154 to another portion of the sample tube holder 108.

The sample tube holder 108 includes the fourth portion 160. One or more parts of the fourth portion 160 can be planar or substantially planar. One or more parts of the fourth portion 160 can be horizontal or substantially horizontal. The first portion 142 and parts of the fourth portion 160 can be parallel. The fourth portion 160 can form a base of the sample tube holder 108. The fourth portion 160 can include one or more rails 164. The rails 164 can extend vertically from the sides of the fourth portion 160. While three rails 164 are illustrated, the fourth portion 160 can include any number of rails 164.

In methods of use according to the present disclosure, each of a plurality of sample tubes 102 is inserted into the sample tube holder 108. The distal end 166 of the sample tube 102 is first inserted into the upper opening 144 of the first portion 142. The distal end 166 of the sample tube 102 is then passed vertically, parallel to the second portion 146. The distal end 166 of the sample tube 102 is next inserted into the lower opening 156 of the third portion 154. The distal end 166 of the sample tube 102 is then passed vertically to rest against a surface of the fourth portion 160. The proximal end 170 of the sample tube 102 extends above the first portion 142 of the sample tube holder 108 when the sample tube 102 is received therein.

The proximal end 170 of the sample tube 102 can include a cap 172. The cap 172 can be a removable cap affixed to the proximal end 170. The cap 172 can include a pierceable seal configured to be pierced by a pipette tip. The piercable seal can include a metal foil, a plastic layer, an elastomeric membrane, or any combination of these or other suitable seal structures. The cap 172 can be configured to allow access, through the proximal end 170, to the sample retained in the sample tube 102. In this non-limiting embodiment, the cap 172 is configured to be penetrated by a pipette tip to allow access to the sample in the sample tube 102 via a liquid dispenser. The cap 172 extends above the first portion 142. In some instances, the cap 172 can abut the first portion 142. The cap 172 can have a larger diameter than the diameter of the upper opening 144. It will be understood that implementations of the present disclosure do not require sample tubes 102 to have caps 172 affixed to their proximal ends 170. Sample tubes 102 with open (for example, uncapped) proximal ends can be accepted and retained in sample tube holders described herein consistent with the present disclosure.

In the illustrated embodiment, the sample tube 102 is held by the upper opening 144 near the proximal end 170. The upper opening 144 can contact at least one portion of the sample tube 102. The upper opening 144 can contact two opposed portions of the sample tube 102. The upper opening 144 can contact the circumference of the sample tube 102, or a portion thereof. The round shape of the upper opening 144 can match the perimeter of the sample tube 102. The sample tube 102 is held near the distal end 166 by the lower opening 156. The lower opening 156 can contact at least one portion of the sample tube 102. The lower opening 156 can contact two opposed portions of the sample tube 102. The lower opening 156 can contact the circumference of the sample tube 102, or a portion thereof. Each of the upper opening 144 and the lower opening 156 can be a ring or an open loop. Each of the upper opening 144 and the lower opening 156 can form a hole in the sample tube holder 108. The sample tube holder 108 can be constructed of any suitable material, such as a metal.

The sample tube 102 can be held at both its top and bottom by the sample tube holder 108. The sample tube holder 108 can prevent or limit movement in a horizontal direction. The upper opening 144 and the lower opening 156 can limit movement in a horizontal direction based on the similar shape of the openings 144, 56 to the outside surface of the sample tube 102. The sample tube holder 108 can allow movement of the sample tube 102 in a vertical direction. The sample tube 102 can be freely inserted or removed from the sample tube holder 108. The sample tube 102 is moved vertically or substantially vertically to insert the sample tube 102 into the sample tube holder 108. The sample tube 102 is moved vertically or substantially vertically to remove the sample tube 102 from the sample tube holder 108. The method can be repeated to vertically insert the plurality of sample tubes 102 into the sample tube holder 108.

Advantageously, embodiments of the present disclosure allow portions of the sample tube 102 to be accessible to a sample identification verifier such as a bar code reader, when disposed within the sample tube holder 108. The front surface of each sample tube 102 can be scanned to identify the patient or the sample, as described herein. The sample tube 102 can be rotated by the user within the sample tube holder 108 such that the sample identifier faces outward. The sample tube 102 can include an identifier that encircles the sample tube 102.

### An Example Hinge Assembly According to a First Embodiment of the Present Disclosure

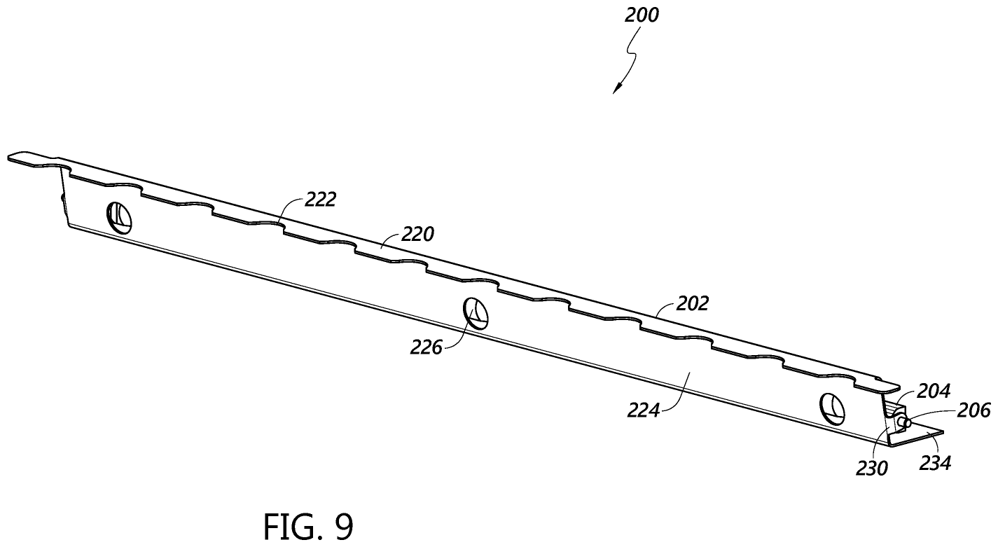

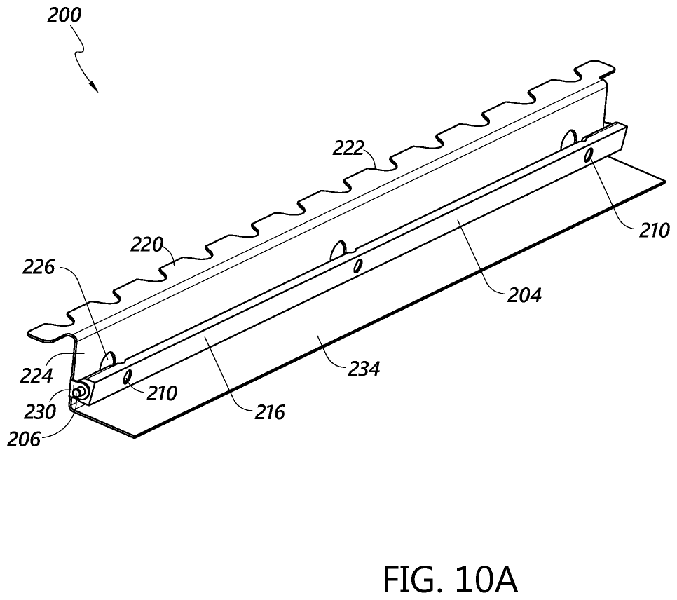

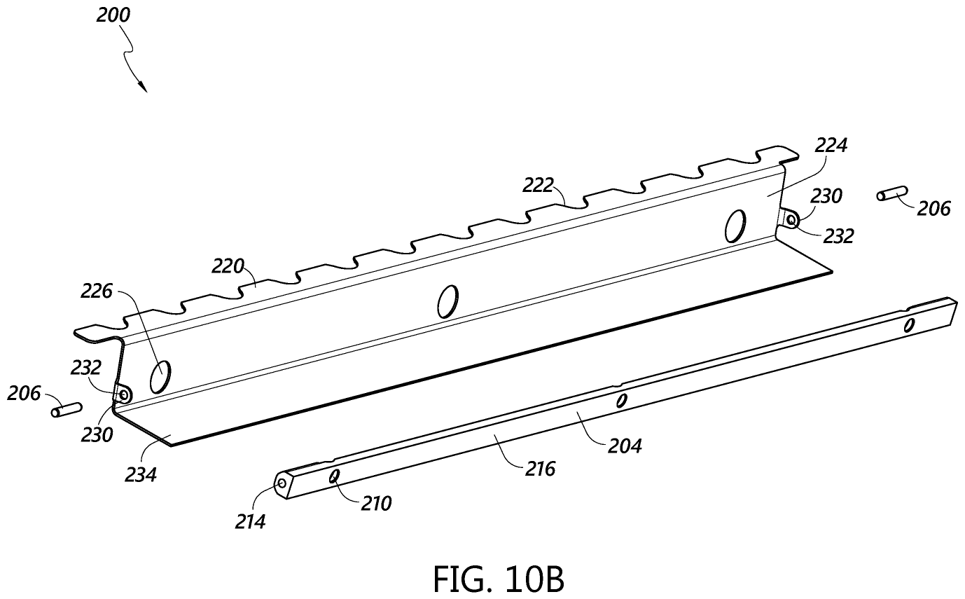

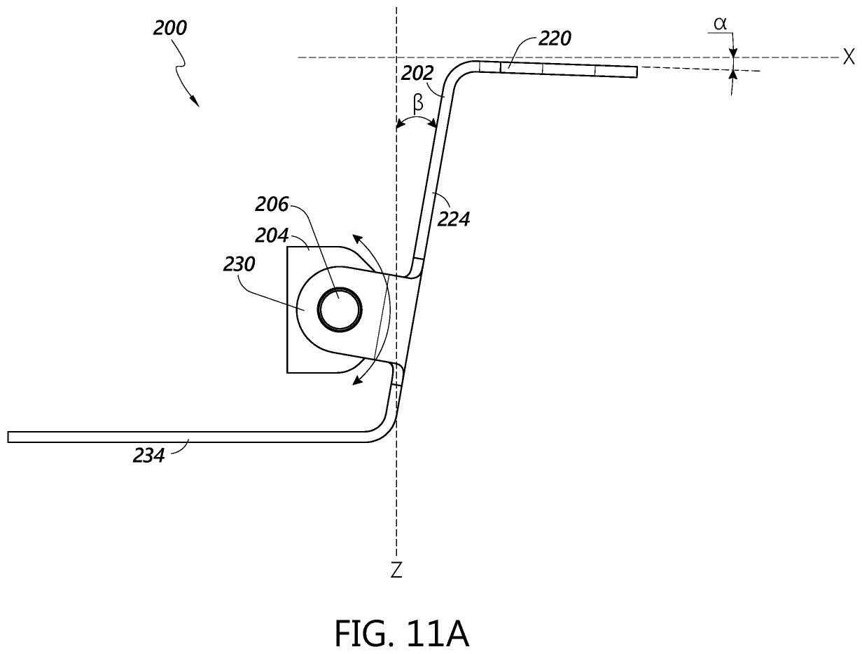

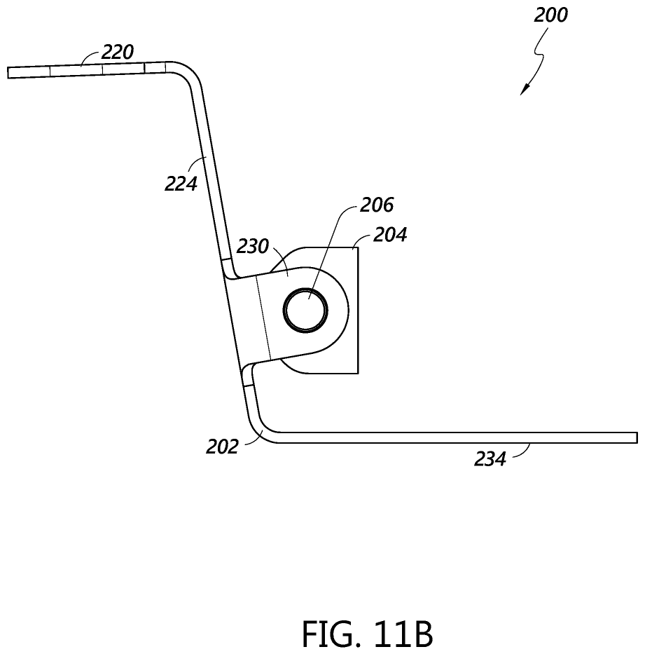

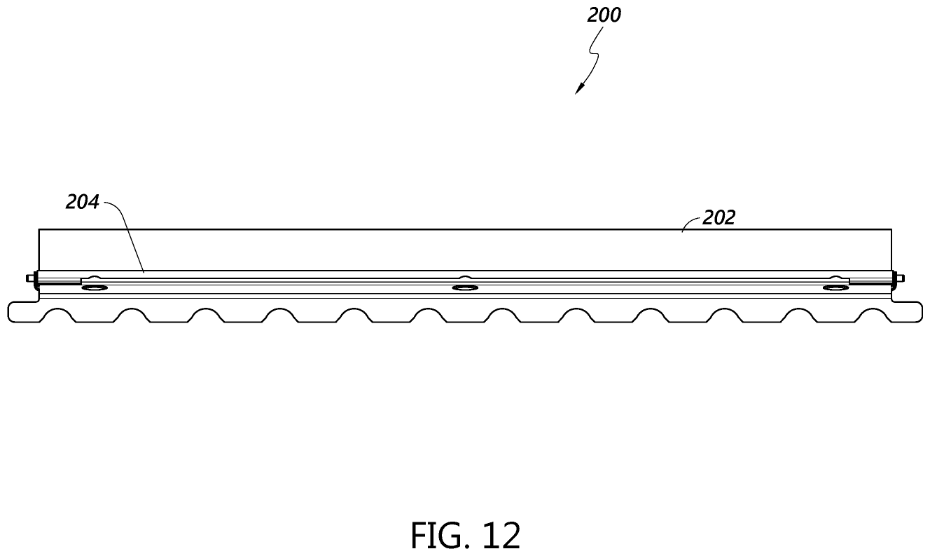

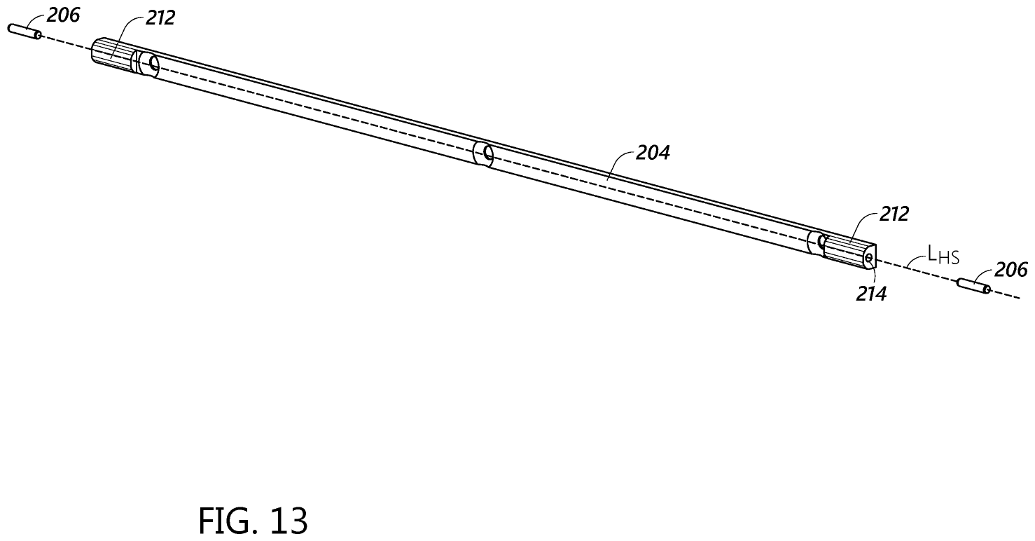

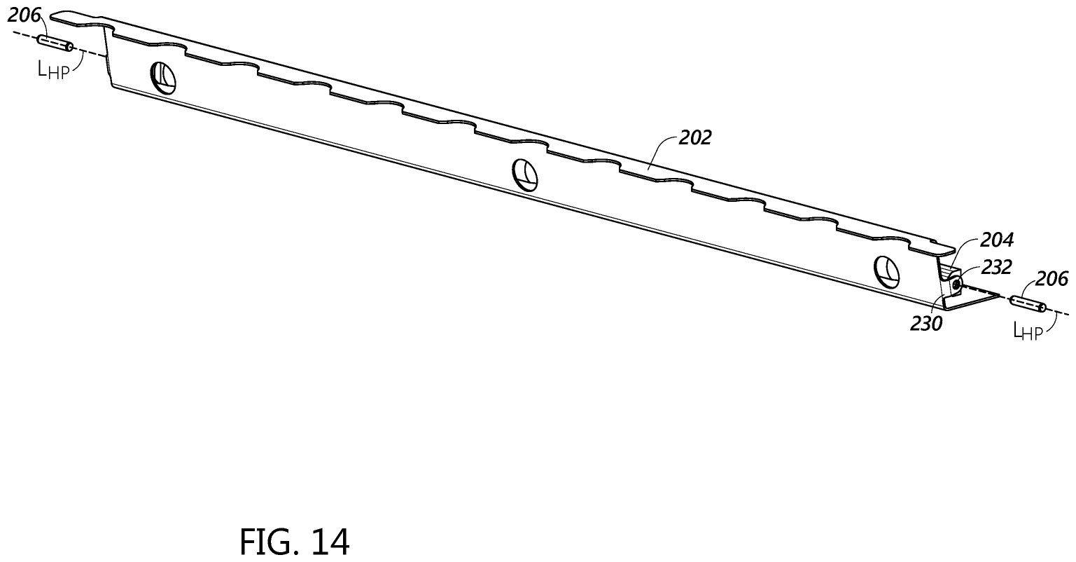

An example hinge assembly 200 according to the first embodiment of the present disclosure will now be described with reference to FIGS. 9-14. It will be understood that hinge assemblies of the present disclosure are not limited to the features of the example hinge assembly 200, and can take other forms, shapes, and dimensions consistent with the present disclosure. FIG. 9 shows a front perspective view of the hinge assembly 200. FIG. 10 shows a back perspective view of the hinge assembly 200. FIG. 11 shows a side view of the hinge assembly 200. FIG. 12 shows a top view of the hinge assembly 200. FIG. 13 shows an exploded front perspective view of a portion of the hinge assembly 200. FIG. 14 shows an exploded front perspective view of the hinge assembly 200.

The hinge assembly 200 includes a hinge plate 202. The hinge assembly 200 includes a hinge support 204. The hinge assembly 200 includes one or more hinge pins 206. FIGS. 13 and 14 illustrate the hinge support 204 and the hinge pins 206 in an exploded view. The hinge support 204 can be an elongate member. The hinge support 204 has one or more openings 210 configured to accept a fastener there through. Any segment of the hinge support 204 can include the one or more openings 210. The opening 210 is configured to align with a corresponding opening in the reagent housing 110. When a fastener extends through the corresponding openings, the hinge support 204 of the hinge assembly 200 is rigidly coupled to the reagent housing 110. While three openings 210 are illustrated, the hinge support 204 can include any number of openings 210.

The hinge support 204 can include one or more hubs 212 as illustrated in FIG. 13. The hubs 212 extend horizontally along a longitudinal axis L_{HS} of the hinge support, near the ends of hinge support 204. In the illustrated non-limiting embodiment, each hub 212 has a hollow cylinder shaped section within an opening 214 extending inward from the end of the hinge support 204. It will be understood that the present disclosure is not limited to the hubs 212 and other shapes and sizes are possible. The opening 214 can extend along the longitudinal axis L_{HS} of the hinge support 204. Each opening 214 is configured to accept a hinge pin 206. The hub 212 can be a knuckle or hollow portion creating a joint of a hinge about which the hinge plate 202 rotates. The hub 212 can be the location in which the hinge pin 206 is set. The hub 212 can be configured as a barrel or hemispherical shape. Other configurations are possible.

The hinge support 204 can include a back surface 216 as illustrated in FIG. 10. The back surface 216 can be planar to abut a planar surface of the reagent housing 110. The back surface 216 can be any shape to allow a secure connection between the hinge support 204 and the reagent housing 110 when fastened together.

The hinge pin 206 can be generally cylindrical member and the corresponding opening 214 can be correspondingly cylindrical. It will be understood that any suitably shaped and sized mating configuration can be implemented in embodiments of the present disclosure. The hinge pin 206 can provide a pivot axis about which the hinge assembly 200 can pivot. In other words, the pivoting or articulation axis of the hinge assembly 200 can be along a longitudinal axis L_{HP} of the hinge pin 206. During the pivoting motion, the hinge support 204 is configured to remain stationary. In some cases, the hinge pin 206 also remains stationary. The hinge plate 202 is configured to pivot or rotate relative to the fixed hinge support 204. The hinge pin 206 provides the axis of rotation, with all other translations and rotations being prevented or limited. The hinge assembly 200 can have one degree of freedom of motion. For example, as shown in FIG. 11A, the hinge plate 202 of hinge assembly 200 can rotate in one dimension in the clockwise or counterclockwise direction.

FIG. 11A illustrates a first side view of the hinge plate 202. FIG. 11B illustrated a second side view of the hinge plate 202. Features of the hinge plate 202 will now be described with reference to FIG. 11A. The hinge plate 202 includes a first portion 220, a second portion 224, and a third portion 234. The first portion 220 can be planar or substantially planar. In this non-limiting embodiment, when the third portion 234 is positioned parallel to axis X, the first portion 220 is bent an angle alpha (α) from horizontal, as shown in FIG. 11A. The angle α relative to axis X can be 0° from horizontal such that the first portion 220 is horizontal, 1° from horizontal, 2° from horizontal, 3° from horizontal, 4° from horizontal, 5° from horizontal, 6° from horizontal, 7° from horizontal, 8° from horizontal, 9° from horizontal, 10° from horizontal, or any range of the foregoing values. It will be understood that other configurations are possible. Referring back to FIG. 10A, the first portion 220 includes a plurality of indents 222. The first portion 220 is configured to retain twelve sample tubes 102 with the twelve indents 222, respectively. While the hinge plate 202 is illustrated with twelve indents 222, the hinge plate 202 can include any number of indents 222. The indents 222 can be rounded. The indents 222 can be circular. The indents 222 can be semi-circular or hemispherical. The indents 222 can be tapered. The number of indents 222 can correspond to the number of upper openings 144 in the sample tube holder 108 in a one-to-one correspondence. The first portion 220 can include one or more rounded edges such as rounded corners or bends to connect the first portion 220 to another portion of the hinge plate 202.

The hinge plate 202 includes a second portion 224. The second portion 224 is planar or substantially planar. In this non-limiting embodiment, when the third portion 234 is positioned perpendicular to axis Z, the second portion 224 is bent an angle beta (β) from vertical, as shown in FIG. 11A. The angle β relative to axis Z can be 0° from vertical such that the second portion 224 is vertical, 2° from vertical, 4° from vertical, 6° from vertical, 8° from vertical, 10° from vertical, 12° from vertical, 14° from vertical, 16° from vertical, 18° from vertical, 20° from vertical, or any range of the foregoing values. It will be understood that other configurations are possible. The second portion 224 can extend along a portion of a length of a sample tube 102 when the rack 100 is assembled, for instance at least 5% of the length, at least 10% of the length, at least 15% of the length, at least 20% of the length, at least 25% of the length, or any range of the foregoing values. The second portion 146 can extend along at least the length of the cap 172 (if present on the sample tube) when the rack 100 is assembled.

The second portion 224 has one or more openings 226 configured to accept a fastener or tool there through. Any segment of the second portion 224 can include the one or more openings 226. The opening 226 is configured to align with a corresponding opening 210 in the hinge support 204. The opening 226 is configured to align with a corresponding opening in the reagent housing 110. The opening 226 allows a tool, such as but not limited to a screwdriver, to extend through the opening 226. The tool can install a fastener through the opening 210 in the hinge support 204 and the opening in the reagent housing 110 to rigidly couple the hinge support 204 and the reagent housing 110. While three openings 226 are illustrated, the second portion 224 can include any number of openings. The openings 226 can be configured to provide access to the opening 210 in the hinge support 204 to facilitate affixing the hinge support 204 to the reagent housing 110.

The second portion 224 includes flanges 230. The flanges 230 generally extend in planes defined by the X and Z axes illustrated in FIG. 11A. The hubs 230 extend horizontally, near the edge of second portion 224. The hubs 230 extend in the opposite direction as the first portion 220. Each flange 230 includes an opening 232 extending through the flange 230. The openings 232 can be coaxial. Each opening 232 is configured to accept a hinge pin 206. The pair of flanges 230 is spaced to receive the hinge support 204 therebetween. The space between the pair of flanges 230 can be slightly longer than the length of the hinge support 204.

The hinge plate 202 includes a third portion 234. The third portion 234 can be planar or substantially planar. In this non-limiting embodiment, when the third portion 234 is positioned parallel to axis X, the first portion 220 is bent an angle alpha (α) from horizontal, as shown in FIG. 11A. In other embodiments, the third portion 234 may not be parallel to axis X and may be bent relative to axis X depending on the shape and dimension of the sample tube holder 108 and rack 100 with which the hinge assembly 200 interfaces. In one non-limiting implementation, the first portion 220 and the third portion 234 can be parallel or substantially parallel. The third portion 234 can form a base of the hinge plate 202.

### Example Methods of Operating a Hinge Assembly of the First Embodiment of the Present Disclosure

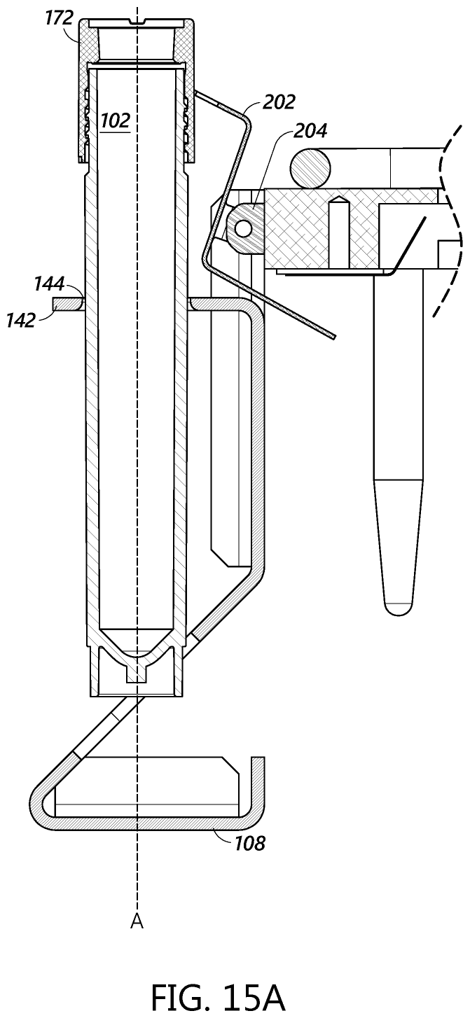

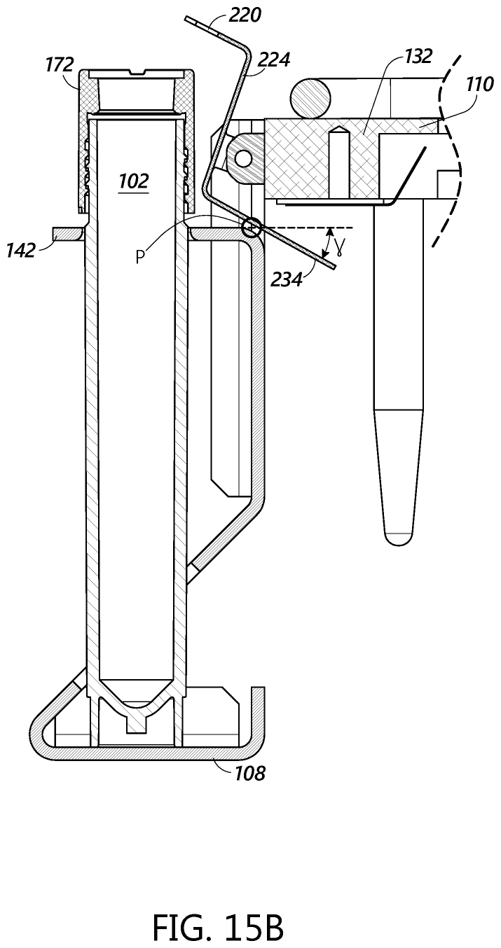

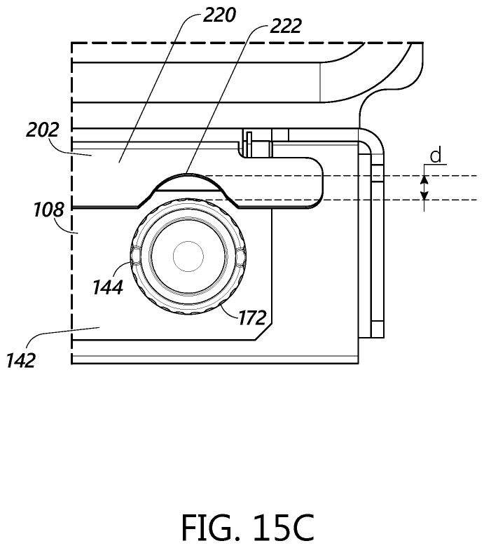

FIGS. 15A-15C show views of the operation of the hinge assembly 200 according to a first embodiment of the present disclosure. FIG. 15A is a side view of the sample tube 102 being inserted into the sample tube holder 108. FIG. 15B is a side view of the sample tube 102 fully inserted into the sample tube holder 108. FIG. 15C is a top view of the sample tube 102 and the sample tube holder 108 when the sample tube 102 is fully inserted. In a first configuration illustrated in FIGS. 15A-15C and referred to herein as a “tube insertion configuration,” the hinge assembly 200 is configured to allow the sample tube 102 to be inserted into the sample tube rack 108. The description below describes the hinge assembly 200 in this tube insertion configuration.

The first portion 220 of the hinge plate 202 is positioned closer to the reagent housing 110 in the tube insertion configuration. The first portion 220 of the hinge plate 202 is positioned further away from the upper opening 144 of the first portion 142 of the sample tube holder 108. The first portion 220 of the hinge plate 202 is rotated away from the upper opening 144 of the sample tube holder 108 (rotated toward the reagent housing 110) to provide clearance for the sample tube 102 to be inserted into the upper opening 144 of the sample tube holder 108. For example, in the tube insertion configuration, the first portion 220 of the hinge plate 202 is positioned to provide clearance for the sample tube 102 to be inserted vertically into the sample tube holder 108.

The third portion 234 of the hinge plate 202 is rotated away from the bottom of the reagent housing 110 in the tube insertion configuration. Rotating the third portion 234 of the hinge plate 202 into the configuration illustrated in FIGS. 15A-15C provides clearance for the sample tube 102 to be inserted. In this configuration, a portion of the third portion 234 of the hinge plate 202 can extend below the first portion 142 of the sample tube holder 108. In some cases, the third portion 234 of the hinge plate 202 can be positioned relative to the first portion 142 of the sample tube holder 108 at an angle gamma (γ). The angle γ can be acute. The angle γ can be 2° from horizontal, 4° from horizontal, 6° from horizontal, 8° from horizontal, 10° from horizontal, 12° from horizontal, 14° from horizontal, 16° from horizontal, 18° from horizontal, 20° from horizontal, or any range of the foregoing values. The third portion 234 of the hinge plate 202 can abut the first portion 142 of the sample tube holder 108 at a location P. Contact between the third portion 234 of the hinge plate 202 and the first portion 142 of the sample tube holder 108 can limit further rotation of the hinge plate 202 in the clockwise direction, as viewed from the perspective of FIGS. 15A and 15B.

FIG. 15C illustrates the top view of the tube insertion configuration. As in FIGS. 15A and 15B, the first portion 220 of the hinge plate 202 is rotated toward the reagent housing 110 (away from the first portion 142 of the sample tube holder 108). The indent 222 of the first portion 220 of the hinge plate 202 provides clearance for the insertion of the sample tube 102 into the sample tube holder 108 along a vertical axis A of an upper opening 144 in the first portion 142. As shown in FIG. 15C, the indent 222 is laterally offset a distance d from the upper opening 144 of the sample tube holder 108, when viewed from the top of the hinge assembly 200. The distance of lateral offset d can be a distance that allows a user to insert a sample tube 102 in the sample tube holder 108 without interference from or contact with the hinge assembly 200.

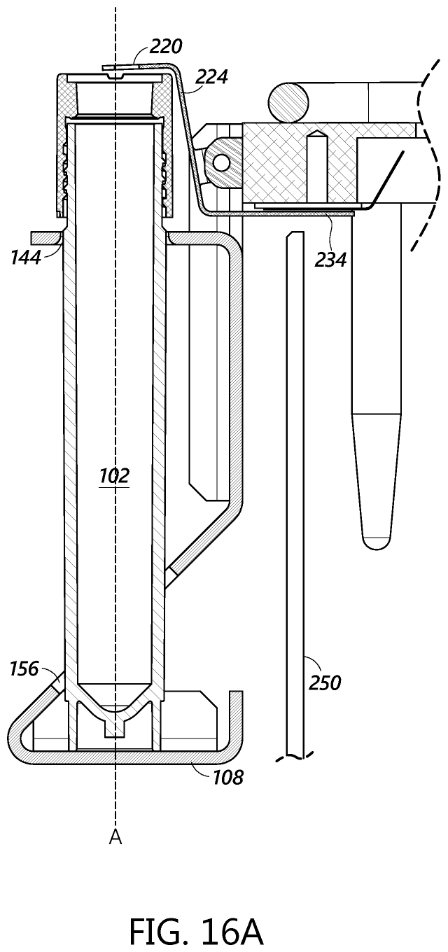

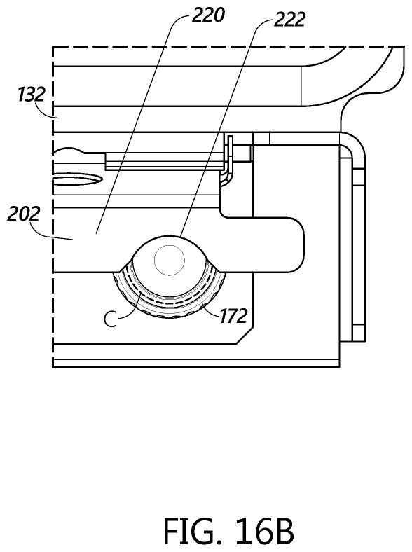

Operation of the hinge assembly 200 according to the present disclosure includes moving the hinge plate 202 from the tube insertion configuration illustrated in FIGS. 15A-15C to a second configuration illustrated in FIGS. 16A and 16B and referred to herein as a “tube retention configuration.” FIG. 16A is a side view of the hinge assembly 200 after actuation. FIG. 16B is a top view of the sample tube 102 and the sample tube holder 108 after the hinge assembly 200 is actuated. As described herein, the hinge plate 202 can pivot relative to the hinge support 204. During pivoting motion, the hinge support 204 is configured to remain stationary and the hinge plate 202 pivots relative to the stationary hinge support 204. The hinge assembly 200 is configured to allow the sample tube 102 to be retained in the vertical direction. The description below describes the hinge assembly 200 in the tube retention configuration.

In this non-limiting embodiment, the first portion 220 of the hinge plate 202 is positioned in a horizontal or substantially horizontal orientation in the tube retention configuration, as illustrated in FIG. 16A. In one non-limiting embodiment, the first portion 220 of the hinge plate 202 can be rotated counterclockwise from the perspective of FIG. 16A. In one non-limiting embodiment, the first portion 220 of the hinge plate 202 can be rotated past horizontal. In these example implementations, contact between the hinge plate 202 and the sample tube 102 (or cap 172 if applicable) limits further counterclockwise rotation of the hinge plate 202. The first portion 220 of the hinge plate 202 retains the sample tubes 102 within the sample tube holder 108. Compared with FIG. 15B, the first portion 220 of the hinge plate 202 is pivoted to contact a portion of the sample tube 102, or the cap 172 of the sample tube 102. The first portion 220 of the hinge plate 202 rests against the top surface of the cap 172 of the sample tube 102.

The indents 222 of the first portion 220 of the hinge plate 202 can be semi-circular or hemispherical to allow access to the contents of the sample tube 102. In the tube retention configuration, the indents 222 of the first portion 220 of the hinge plate 202 do not obstruct a central region or area C of the top of the sample tube 102. The indents 222 of the first portion 220 of the hinge plate 202 can be semi-circular or hemispherical to cover a portion of the cap 172 but not the central area C. The indents 222 can simultaneously retain a plurality of sample tubes 102 in the sample tube holder 108. Portions of the first portion 220, including portions surrounding the indents 222, can collectively and simultaneously apply a vertical retaining force to all sample tubes positioned in the sample tube holder 108.

The second portion 224 of the hinge plate 202 can form an angle delta (δ) relative with the vertical axis A of the upper opening 144. The angle δ can be 0° from vertical, 2° from vertical, 4° from vertical, 6° from vertical, 8° from vertical, 10° from vertical, 12° from vertical, 14° from vertical, 16° from horizontal, 18° from vertical, 20° from vertical, or any range of the foregoing values. Other configurations are possible. The second portion 224 of the hinge plate 202 is pivoted in the counterclockwise direction compared with the position in FIG. 15B.

The third portion 234 can be horizontal or substantially horizontal when the hinge assembly 200 is in the tube retention configuration. The third portion 234 of the hinge plate 202 can be parallel to the horizontal member 132 of the reagent housing 110 when the hinge assembly 200 is in the tube retention configuration. The third portion 234 of the hinge plate 202 can be parallel to the first portion 142 of the sample tube holder 108 when the hinge assembly 200 is in the tube retention configuration.

In embodiments of the present disclosure, an actuation force pivots the hinge plate 202 to move the hinge assembly 200 from the tube insertion configuration to the tube retention configuration. In some embodiments, the same actuation force pivots the hinge plate 202 to move the hinge assembly 200 from the tube retention configuration to the tube insertion configuration. In other embodiments, a second, different actuation force can move the hinge assembly 200 from the tube retention configuration to the tube insertion configuration. In one example, a user applies an actuation force to a portion of the hinge assembly 200 to rotate the hinge assembly 200 between configurations. For instance, the user can exert a downward force on the first portion 220 to move the move the hinge assembly 200 from the tube insertion configuration to the tube retention configuration. Similarly, the user can exert an upward force on the first portion 220 to move the move the hinge assembly 200 from the tube retention configuration to the tube insertion configuration. In this embodiment, the weight of the first portion 220 of the hinge plate 202 can provide a downward force to prevent vertical movement of the sample tubes 102. In another example illustrated in FIG. 16A and described in detail below, a structural feature of a receiving bay in which the rack 100 is received exerts an actuation force on the third portion 234 to move the move the hinge assembly 200 from the tube insertion configuration to the tube retention configuration. The structural feature can maintain this actuation force thus locking the hinge plate 202 against the sample tubes 102.

It will be understood that any of the first portion 220, the second portion 224, and the third portion 234 of the hinge plate 202 can be contacted by an actuation force to pivot the hinge assembly 200. For example, the first portion 220 can be pushed downward, the section portion 224 can be pushed horizontally, and/or the third portion 234 of the hinge plate 202 can be pushed upward to move the hinge plate 202 into engagement with the sample tube 102. Compared with FIG. 15B, the third portion 234 of the hinge plate 202 has been actuated to change the position of the hinge assembly 200. As viewed from the perspective of FIGS. 15A and 16A, the third portion 234 of the hinge plate 202 is actuated to rotate the hinge assembly 200 in the counter-clockwise direction. The third portion 234 of the hinge plate 202 can be a lever arm which allows pivoting of the hinge plate 202.

Embodiments of the hinge assembly 200 can be actuated to move from the tube insertion configuration to the tube retention configuration by a partition 250 in the receiving bay that receives the rack 100. The partition 250 can include a surface, a wall, a ledge, an enclosure, or any other suitable structure shaped, sized, and positioned in the receiving bay to actuate the hinge assembly 200 when the rack 100 is inserted into the receiving bay. For example, in one non-limiting example, the partition 250 can include one or more pegs, rods, or bars positioned in the receiving bay to interact with the hinge assembly 200 when the rack 100 is inserted into the receiving bay. The partition 250 is shaped and sized to partition the receiving bay into two areas, a first area and a second area. When the rack 100 is received in the receiving bay, the reagent housing 110 is positioned in the first area and the sample tube holder 108 is positioned in the second area. The partition 250 is located between the reagent housing 110 and the sample tube holder 108 when the rack 100 is located in the receiving bay.

The partition 250 acts on the hinge assembly 200 as the rack 100 is inserted in the receiving bay. As the hinge assembly 200 is transitioning from the tube insertion configuration illustrated in FIG. 15A to the tube retention configuration illustrated in FIG. 16A, the partition 250 contacts the third portion 234 of the hinge plate 202. The partition 250 applies a counterclockwise force on the third portion 234 of the hinge plate 202. Interaction of the partition 250 with the third portion 234 thus rotates the hinge plate 202 about the hinge support 204, and causes the hinge assembly 200 to transition from the tube insertion configuration to the tube retention configuration.

The hinge assembly 200 has advantages over other alternative systems designed to retain the sample tubes 102 in the sample tube holder 108 during pipetting operations. One alternative system uses a row of spring clips to apply a horizontal force on each cap 172 of the sample tubes 102 positioned in the sample tube holder 108. The spring clips can be arranged in a horizontal row that is positioned between the upper posts 148 of the second portion 146 of the sample tube holder 108. The arm of the spring clip contacts and applies a horizontal force to on one side of the cap 172 of the sample tube 102 positioned in the sample tube holder 108. This force and a counteracting force applied to the body of the sample tube 102 by the upper opening 144 of the sample tube holder 108 can constrain the sample tube 102 from moving out of the sample tube holder 108 in the horizontal direction. The distal end of the sample tube 102 can contact the fourth portion 160 of the sample tube holder 108. The force applied by the spring clip, the force applied by the upper opening 144, and friction in the contact area at the bottom of the sample tube 102 can restrain the sample tube 102 from being lifted out of the sample tube holder 108 in the vertical direction.

In some cases, variance in the dimensions of the sample tubes 102 and caps 172 can prevent the system of spring clips from consistently restraining the sample tubes 102 from moving in the vertical direction. In some cases, variance in the spring force generated by the arms of the spring clips (due to manufacturing variances, materials variances, or wear of the spring clip over time) can present the system of spring clips from consistently restraining the sample tubes 102 from moving in the vertical direction. In such cases, one or more sample tubes 102 may lift vertically out of the sample tube holder 108 when a pipette tip moves vertically upward out of the cap 172 and applies a vertical force to the sample tube 102 sufficient to vertically displace the sample tube 102.

Accordingly, the sample tube 102 may lift up during liquid dispensing operations in some prior designs. In some cases, the sample tube 102 may be retained on a pipette tip of the liquid dispenser, for instance due to frictional forces between the pipette tip and the cap 172. The spring clips may not consistently retain the sample tubes 102 in the sample tube holder 108, and in some occasions up to 25% of the sample tubes 102 may experience some degree of vertical lift by the liquid dispenser. Vertical lift of the sample tube 102 to any degree can disrupt pipetting operations and cause the liquid dispenser to malfunction or to operate at less than optimal speed and accuracy. In some extreme cases, a pipette tip may not disengage from a sample tube 102 that is not adequately restrained in the sample tube holder 108, potentially causing system interruptions and failures. In order to ensure reliability and maximum throughput, it is desirable for the number of sample tubes 102 experiencing vertical lift to be zero or close to zero.

Advantageously, embodiments of the present disclosure reliably restrain sample tubes 102 in the sample tube holder 108 and can reduce the number of tubes experiencing vertical lift to zero. Embodiments of the rack 100 that include a hinge assembly 200 according to the present disclosure reliably retain the sample tubes 102 during instrument workflow. The upper opening 144 of the sample tube holder 108 can constrain the sample tube 102 from moving in the horizontal direction. In some cases, force applied to the sample tube 102 by the hinge assembly 200 can also constrain the sample tube 102 from moving in the horizontal direction. The fourth portion 160 of the sample tube holder 108 and the hinge assembly 200 together constrain the sample tube 102 in a vertical direction. The partition 250 can lock the hinge plate 202 in the tube retention configuration, thereby locking the sample tubes 102 into place and preventing vertical lifting of the sample tubes 102. Advantageously, the shape, size, and position of the hinge assembly 200 can be tailored to adjust the maximum retaining force required to retain the sample tubes 102.

Advantageously, embodiments of the present disclosure can lock the sample tubes in one motion, reliably and consistently. The hinge plate 202 of the hinge assembly is pivoted by the actuation force of the partition 250 as the partition comes into contact with the hinge plate 202. In some embodiments, the lowering of the rack 100 relative to the partition 250 is the motion that pivots the hinge plate 202 and thus locks the sample tubes 102. The partition 250 applies an upward force on the hinge plate 202, thus pivoting the hinge plate 202 into position. Prior to lowering the rack 100, the hinge plate 202 can be freely pivoted such that the sample tube 102 can be easily loaded into the sample tube holder 108. The hinge plate 202 consistently makes contact with the plurality of sample tubes 102 such that the hinge plate 202 can simultaneous restrain all of the sample tubes 102 in the sample tube holder 108. The unitary structure of the hinge plate 202 allows a consistent force to be applied to each sample tube 201. In addition, the pivoting motion of the hinge plate 202 is repeatable such that the same actuation force causes the same pivoting motion of the hinge plate. Advantageously, the hinge plate moves easily between configurations for easy loading and unloading of batches of sample tubes during a sequence of diagnostic tests performed consecutively using the same rack, thereby minimizing user error and time to load and unload the rack, and increasing pipetting efficiency.

In some embodiments, the hinge assembly 200 contacts the sample tube 102, such as contacting the cap 172 of the sample tube 102. In some embodiments, the hinge assembly 200 applies a downward force on the sample tube 102. In some embodiments, the hinge assembly 200 in the tube retention configuration prevents all vertical movement of the sample tube 102 within the sample tube holder 108. In some embodiments, the hinge assembly 200 in the tube retention configuration allows some vertical movement of the sample tube 102 within the sample tube holder 108. In some embodiments, one or more sample tubes may vertically lift a small distance during pipetting operations, but the presence of the hinge plate 202 restrains the sample tube from moving vertically to an extent that affects performance of the pipetting system. In some embodiments, the hinge assembly 200 applies a compressive force on the sample tube 102. In some embodiments, the hinge plate 202 of the hinge assembly 200 is positioned laterally above, and in some cases covers, a portion of the sample tube 102 to prevent upward movement. In some embodiments, the hinge assembly 200 is positioned laterally above, and in some cases covers, a portion of the circumference of the cap 172 of the sample tube 102 without obstructing an area C of the cap 172 from a pipette tip.

Advantageously, the hinge plate 202 according to the present disclosure can prevent or limit vertical movement of the sample tube 102 within the sample tube holder 108. In one example, the hinge plate 202 prevents or limits vertical lift off of the sample tube 102 when the contents of the sample tube 102 are accessed by the liquid dispenser. In another example, the hinge plate 202 prevents or limits vertical movement of the sample tube 102 within the sample tube holder 108 during fluid processing operations. In a further example, the hinge plate 202 prevents or limits vertical lift of the sample tubes 102 by a pipette tip.

The hinge assembly 200 can include several advantages. The hinge assembly 200 can be easy and intuitive to use. The hinge assembly 200 can be automatically actuated such as by the simple action of inserting the rack 100 into a diagnostic apparatus, as described herein. Using the hinge assembly 200 can be a simple, self-learning process. The hinge support 204 can span the reagent housing 110, or a portion thereof, along a front surface of the reagent housing 110. The first portion 220 of the hinge plate 202 can be considered a locking member. The hinge mechanism 200 can be made of any suitable material including sheet metal.

Advantageously, embodiments of the present disclosure unlock the sample tubes in one motion, reliably and consistently. The hinge plate 202 of the hinge assembly 200 can be held in position by the partition 250 of the receiving bay that receives the rack 100. The rack 100 can be lifted relative to the partition 250 to alleviate the force of the partition 250. The hinge plate 202 is therefore free to pivot relative to the hinge support 204. The one motion of raising the rack 100 relative to the receiving bay can unlock the sample tubes 102. After raising the rack 100, the hinge plate 202 can be freely pivoted such that a first sample tube 102 can be easily unloaded from the sample tube holder 108 and the next, second sample tube 102 can be loaded. The hinge plate can be pivoted by the user from the tube retention configuration to the tube insertion configuration. The hinge plate 202 can be moved away from the sample tube holder 108 to easily load the next sample tubes.

The hinge assembly 200 does not interfere with tube loading and unloading operations. Advantageously, the hinge assembly 200 allows the user to easily load and unload the sample tubes 102 into the rack 100. The hinge assembly 200 allows the user to lock the sample tubes 102 in place when the rack 100 is placed into the diagnostic apparatus. The hinge assembly 200 is a locking mechanism that retains the sample tubes 102 in the rack 100 once it is received in the receiving bay. The hinge assembly 200 can facilitate complete retention of the sample tubes 102 within the sample tube holder 108. The hinge assembly 200 can lock the sample tubes 102 in place when the rack 100 is placed in the diagnostic apparatus. The hinge assembly 200 can act a cover over each sample tube 102. In the illustrated embodiment, all of the sample tubes 102 within the sample tube holder 108 are restrained under one physical part, the hinge plate 202.

Embodiments of the hinge assembly according to the present disclosure include additional advantages. The hinge assembly of the present disclosure can be used with any design of the sample tube 102. The hinge assembly of the present disclosure can also be used with any design of the cap 172. The hinge assembly can be backward compatible such that racks that do not have the hinge assembly can be advantageously retrofitted to include the hinge assembly. As one non-limiting example, racks with the system of spring clips can be retrofitted. In some embodiments, the system of spring clips is removed without decoupling the sample tube holder from the reagent housing. In some embodiments, the hinge assembly is installed without decoupling the sample tube holder from the reagent housing.

The hinge assembly 200 can be incorporated directly into rack 100, such as by securing fasteners as described herein. The hinge assembly 200 can be easily installed between the sample tube holder 108 and the reagent housing 110. The sample tube holder 108, the hinge support 204, and the reagent housing 110 can form a unitary structure that is inserted into the receiving bay in one fluid motion and removed from the receiving bay in one fluid motion. The hinge plate 202 is designed to pivot relative to this unitary structure. The hinge assembly 200 can be easily introduced into the manufacturing supply chain or can be installed by the user at the point of use of the rack.

FIG. 17 shows an example diagnostic apparatus 300 accordingly to the present disclosure. The rack 100 can be designed so that it can be easily inserted and removed from the diagnostic apparatus 300. The reagent housing 110 can include one or more registration members 130 that facilitate positioning of the rack 100 illustrated in FIGS. 2 and 3. The registration members 130 are configured to ensure that the rack 100 can only be placed in the diagnostic apparatus 300 in a single orientation. In addition, the registration members 130 can ensure that the rack 100 is inserted in a proper orientation to be actuated by the partition 250. It is desirable that the rack 100 be positioned correctly within the diagnostic apparatus 300, with movement limited thereafter, so that movement of the liquid dispenser will not be compromised during liquid handling operations. For instance, the registration members 130 can limit movement in two directions, such as side-to-side movement and front-to-back movement of the rack 100. Movement in the vertical direction can be limited based on the weight of the rack 100, with the user being able to lift the rack 100 from the diagnostic apparatus 300. The registration members 130 can provide stability for the rack 100 when placed in the diagnostic apparatus 300.

In some embodiments, the rack 100 or the diagnostic apparatus 300 can include a sensor configured to indicate proper placement of the rack 100 in the diagnostic apparatus 300. The sensor may communicate with a processor to provide the user with a warning, such as an audible warning, or a visual warning communicated via an interface, if the rack 100 is not seated correctly. The sensor can be configured to prevent a sample preparation process from initiating or continuing if a seating error of the rack 100 is detected. In some embodiments, the rack 100 gives the user positive feedback, such as audibly or physically, that the rack 100 is placed correctly. The positive feedback indicating that the rack 100 is properly placed in the diagnostic apparatus 300 can also indicate to the user that the hinge assembly 200 has transitioned to the tube retention configuration and the sample tubes 102 are locked in position in the sample tube holder 108.

It will be apparent that embodiments of the hinge assembly of the present disclosure can be actuated in many different ways. For example, in one non-limiting embodiment, the partition 250 is stationary and the rack 100 interacts with the partition 250 as it is lowered into the diagnostic apparatus 300, thereby actuating the hinge assembly 200. In another non-limiting embodiment, the partition 250 moves vertically from a stowed position to an engagement position to contact the hinge assembly 200 and thereby apply a force to actuate the hinge assembly 200, after the rack 100 is received in the diagnostic apparatus 300.

When placing the rack 100 within the diagnostic apparatus 300, the partition 250 is shaped and sized to come into contact with the hinge plate 202 of the hinge assembly 200 to lock the one or more sample tubes 102 in place. Advantageously, the sample tubes 102 are constrained in the rack 100, and in the diagnostic apparatus 300, in the horizontal direction by at least the upper opening 144 of the sample tube holder 108 and are constrained in the vertical direction by at least the hinge assembly 200.

The rack 100 can be designed so that it can be easily removed and reinserted into the diagnostic apparatus 300. Upon removal from the diagnostic apparatus 300, the partition 250 no longer exerts a force against the hinge plate 202 of the hinge assembly 200. The one or more sample tubes 102 can be easily removed by sliding the one or more sample tubes 102 vertically, upward. New sample tubes 102 can be easily inserted by sliding the one or more sample tubes 102 vertically, downward. The rack 100 can be reinserted into the diagnostic apparatus 300. The action of insertion can actuate the hinge assembly 200 to retain the new set of sample tubes 102. The actuation of the one or more partitions 250 can thus be automatic, requiring no further action by the user. The act of engaging the hinge assembly 200 with the partition 250 can be the same act as inserting the rack 100 within the diagnostic apparatus 300.

It will be understood that embodiments of the hinge assembly according to the present disclosure can be received in a receiving bay that does not include a partition 250. The hinge assembly 200 in such cases can be locked in place by any suitable mechanism, including but not limited to a pin, a linkage, a lever, a wedge, a cam, or a sliding bar that engages the hinge assembly 200 to pivot the hinge plate 202. In some embodiments, the mechanism also acts to lock the hinge plate 202 in the tube retention configuration. In some embodiments, the rack 100 can be loaded with one or more sample tubes 102 only prior to being inserted into the diagnostic apparatus 300 such as use with a receiving bay with the partition 250. In some embodiments, the rack 100 can be loaded with one or more sample tubes 102 prior to and after being inserted into the diagnostic apparatus 300 such as use with a receiving bay with another suitable mechanism.

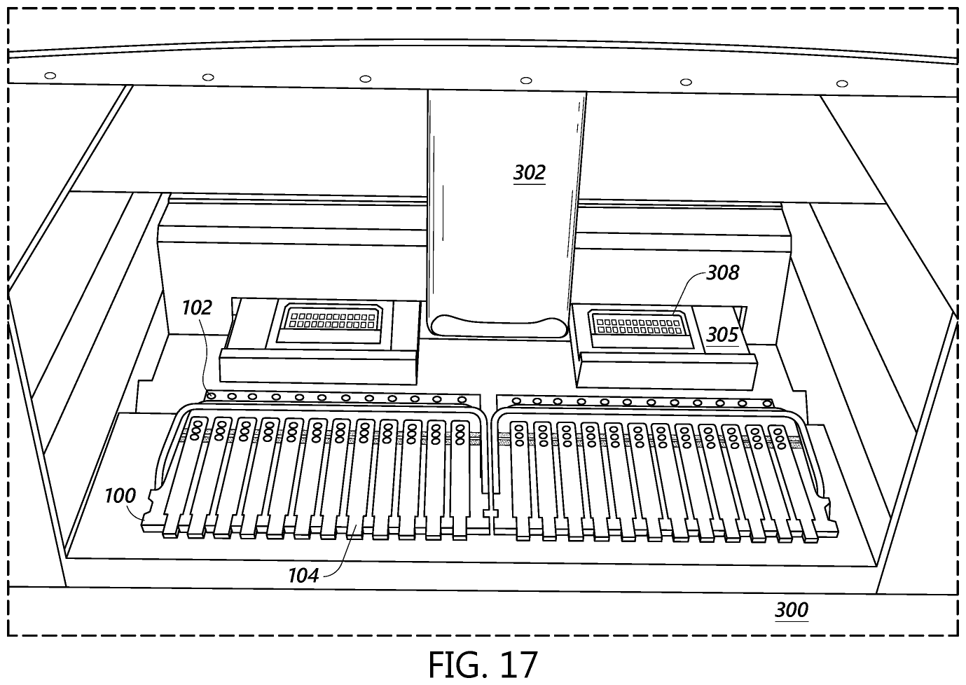

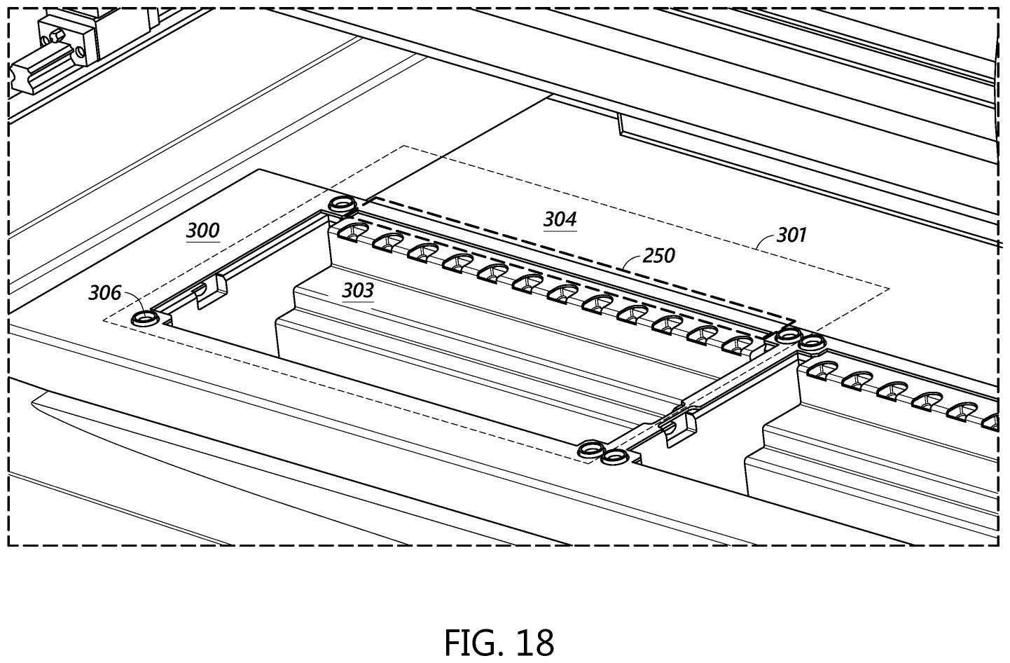

FIG. 18 shows another example of the diagnostic apparatus 300 according to the present disclosure. The diagnostic apparatus 300 includes a receiving bay 301 configured to receive the rack 100, or portions of the rack 100, according to embodiments of the present disclosure. The receiving bay 301 is shown enclosed by dashed lines in the non-limiting embodiment illustrated in FIG. 18. In this example, the receiving bay 301 includes a first portion 303 configured to receive the reagent housing 110 of the rack 100. The receiving bay 301 can include a second portion 304 separate from and adjacent to the first portion 303. The second portion 304 can include an open volume, well, or bay separate from and adjacent to the first portion 303. The rack 100 can be designed so that it can be easily inserted and removed from the diagnostic apparatus 300, for instance the reagent housing 110 can be inserted in the first portion 303 of the receiving bay 301 and the sample tube holder 108 can be inserted in the second portion 304 of the receiving bay 301. As described herein, the reagent housing 110 can include one or more registration members 130 that facilitate positioning of the rack 100 in one or more recesses 306 in the diagnostic apparatus 300. The registration members 130 are configured to ensure that the rack 100 can only be placed in the diagnostic apparatus 300 in a single orientation such that the first portion 303 receives the reagent housing 110.

The receiving bay 301 can include the partition 250, which is shown enclosed by dashed lines in the non-limiting embodiment illustrated in FIG. 18. The partition 250 is located between the first portion 303 of the receiving bay 301 and the second portion 304 of the receiving bay 301. The partition 250 can be stationary in the receiving bay 301, such as an integral wall portion of the receiving bay 301. The rack 100 interacts with the partition 250 as it is lowered into the receiving bay 301 of the diagnostic apparatus 300, for instance as the reagent housing 110 is inserted in a first portion 303 and as the sample tube holder 108 is inserted in a second portion 304. The partition 250 actuates the hinge assembly 200 as described herein.

### Example Sample Tube and Reagent Holder Loading Procedures

Example sample tube and reagent holder loading procedures according to the first embodiment of the present disclosure will now be described. In some embodiments, the rack 100 is loaded with one or more sample tubes 102 on a benchtop surface. The rack 100 can be designed so that it can be easily loaded with one or more sample tubes 102, as shown in FIGS. 15A-15C. The loading of the sample tubes 102 can be intuitive since the sample tubes 102 are inserted vertically into vertically aligned openings 144, 156. The hinge plate 202 is pivoted away from the openings 144, 156 to allow the sample tubes 102 to be loaded.

The sample tube holder 108 can include the aligned upper opening 144 and lower opening 156 which allow for the insertion of the sample tube 102. The upper opening 144 and lower opening 156 can be aligned along a vertical axis such that the sample tubes 102 can be inserted along the vertical axis A illustrated in FIG. 15A. The upper opening 144 can support and guide the sample tube 102 during further insertion. The lower opening 156 can support and guide the sample tube 102 during further insertion.

In some embodiments, the reagent housing 110 of the rack 100 is loaded with one or more reagent holders 104 prior to being inserted into the diagnostic apparatus 300. In some embodiments, the rack 100 is loaded with one or more reagent holders 104 on a benchtop surface.

In some embodiments, the rack 100 is designed to be stable on a horizontal surface such as a benchtop surface where the one or more sample tubes 102 and the one or more reagent holders 104 are loaded. The rack 100 is not easily toppled over during carriage, and, to this end, the rack 100 has one or more feet 124, attached symmetrically to the first and second vertical members 134 of the reagent housing 110. In certain embodiments, the rack has a handle 126 to ease lifting and moving, and in some embodiments, the handle 126 can be locked into a vertical position, during carriage. In some embodiments, the handle 126 is positioned about an axis displaced from an axis passing through the center of gravity of the rack 100 when loaded. The handle 126 is designed to rest at a position flush with an upper, horizontal member 132 of the reagent housing 110.

The sample tube 102 can include additional features to facilitate the sample preparation process. The sample tube 102 is designed for holding and transporting samples for various purposes. In one non-limiting embodiment, the sample tube 102 is used in sample preparation in a clinical context. The sample tube 102 can be of any suitable shape and size.

### Example Sample Tubes and Sample Tube Holders

Features of example sample tubes and sample tube holders for use with embodiments of the present disclosure will now be described. It will be understood that the following example samples tubes are non-limiting and any suitable sample tube can be used in embodiments of the present disclosure. In some cases, all of the sample tubes 102 loaded in the sample tube holder 108 are identical. In some instances, two or more sample tubes 102 loaded in the sample tube holder 108 are the same size, shape or configuration. In other cases, two or more sample tubes 102 loaded in the sample tube holder 108 are different sizes, shapes, or configurations. The diameter and length of the sample tube 102 can vary. For example, two or more sample tubes 102 loaded in the sample tube holder 108 can have the same diameter. As another example, two or more sample tubes 102 loaded in the sample tube holder 108 can have different lengths. Sample tubes received in the rack 100 that have different features can interact with the sample tube holder 108 and the hinge assembly 200 in different ways. For example, one sample tube 102 may come in contact with the fourth surface 160 of the sample tube holder 108 and one sample tube 102 may not. In some embodiments, the sample tube holder 108 is designed to hold identical sample tubes 102. In some embodiments, a second sample tube holder 108 is designed to hold identical sample tubes 102 of a different size, shape, or configuration than the first sample tube holder 108. In some embodiments, the sample tube holder 108 can be interchanged or replaced with the second sample tube holder 108 of the rack 100. In some embodiments, the sample tube holder 108 is coupled to the rack 100 and the second sample tube holder 108 is coupled to a second rack 100.

The sample tube 102 is a self-contained vessel that can prevent leakage of fluids and minimize cross-sample contamination. The sample tube 102 can include a sealing cap which allows the sample tube 102 to be transported. The sealing cap prevents any liquid from escaping by providing a fluid tight seal. The sealing cap can be coupled to the sample tube 102 by the manufacturer or by a care provider after a sample has been added to the sample tube 102. In some embodiments, the proximal end 170 of the sample tube 102 includes a threaded surface. The sealing cap can engage this threaded surface to removably couple the sealing cap to the sample tube 102. The sample tube 102 and the sealing cap can be any commercially available sample tube system.

The sample tube 102 can include a cap 172 which allows the sample tube 102 to be penetrated by a fluid transfer device, such as a pipette tip. In some embodiments, the cap 172 may not provide a fluid tight seal. The cap 172 can be coupled to the sample tube 102 at the location where the sample preparation to be performed, for example at the location of the diagnostic apparatus 300. In some embodiments, the proximal end 170 of the sample tube 102 includes a threaded surface. The cap 172 can engage this threaded surface to removably couple the cap 172 to the sample tube 102.

The cap 172 can allow access to the sample by the liquid dispenser. In some embodiments, the cap 172 includes a threaded exterior portion designed to engage the sample tube 102. In some embodiments, the cap 172 includes a penetrable septum designed to accept the pipette tip therethrough. The septum can include features to substantially limit inadvertent fluid transfer, evaporation, or leakage. The septum can include features to wipe the pipette tip during withdrawal. The cap 172 can permit access to the sample to allow one or more amplification-ready specimens to be prepared from the sample. The sample tube 102 with the cap 172 is configured for use in the diagnostic apparatus 300 that can carry out sample preparation on samples in more than one sample tube 102 simultaneously.

The sample tube 102 for use with the rack 100 can be made of any suitable material, including but not limited to a plastic. The sample tube 102 can be sufficiently rigid so that the sample tube 102 does not easily deform during routine handling and transport. The tubular portion of the sample tube 102 can be made from a single piece such as unitary or monolithic construction, with the cap 172 made from a separate construction. The sample tube 102 can be translucent. The sample tube 102 can be disposable, such as intended for a single use, following which the sample tube 102 is discarded.

### Example Liquid Dispensers

The sample tubes 102 and reagent holders 104 are configured, when received by the rack 100, to accept pipette operations both performed manually by an operator, and by a liquid dispenser 302. The liquid dispenser 302 controls fluid processing operations of any fluid, including fluid samples, and particularly multiple biological samples. The liquid dispenser 302 carries out various aspirate and dispense operations on the sample tubes 102 and the reagent holders 104. The liquid dispenser 302 can include a pipette tip sized to penetrate the cap 172 of the sample tube 102.

Typical, non-limiting features of the liquid dispenser 302 suitable for operating on sample tubes 102 and reagent holders 104 according to the present disclosure include at least: an ability to pick up pipette tips, and to return pipette tips after use; to strip and discard a pipette tip from the liquid dispenser 302 after use or upon encountering an error; and to move a pipette tip with precision from one location of a given rack 100 to another. For example, the sample from the sample tube 102 can be mixed with one or more reagents, liquid reagents can be added to solid reagents to make up solutions, and various liquid reagents and the sample can be mixed with one another during a sample preparation protocol. The liquid dispenser 302 can operate on two or more sample tubes 102 separately or simultaneously when received by the rack 100. The liquid dispenser 302 can operate on two or more reagent holders 104 separately or simultaneously when received by a rack 100. The liquid dispenser 302 can operate on two or more lanes 106 separately or simultaneously. The liquid dispenser 302 can perform certain operations in parallel. The liquid dispenser 302 can perform certain operations in series. The liquid dispenser 302 can move in multiple degrees of freedoms, such as at least three degrees of freedom.

The diagnostic apparatus 300 can be designed for carrying out automated sample preparation on multiple samples contained within the sample tubes 102, according to steps exemplified herein. The geometric arrangement of the components of the diagnostic apparatus 300 is schematic and is not intended to be limiting. Embodiments of the present disclosure can be implemented in any suitable diagnostic apparatus in which sample tubes are received in a sample tube holder. The diagnostic apparatus 300 may additionally include a microfluidic cartridge 308, in a cartridge receiving bay 305. The microfluidic cartridge 308 can be configured to carry amplify a sample and detect presence of an amplified polynucleotide in the microfluidic cartridge 308. The liquid dispenser 302 can be configured to take aliquots of fluid containing analytes of interest, such as but not limited to nucleic acid extracted from one or more samples, and direct them to other areas of the diagnostic apparatus, such as but not limited to a storage area.

The diagnostic apparatus 300 can include a processor 310, such as a microprocessor, configured to control functions of various components of the diagnostic apparatus 300, and is thereby in communication with each such component requiring control. The liquid dispenser 302 can be controlled by the processor 310. The liquid dispenser 302 is configured to carry out various suck and dispense operations on respective sample, fluids and reagents in the sample tubes 102 and the reagent holders 104. The liquid dispenser 302 can carry out such operations on multiple sample tubes 102 and the reagent holders 104 simultaneously. The diagnostic apparatus 300 can process multiple samples in parallel, with each lane 106 undergoing separate or independent steps or processes. Furthermore, the order in which the various functions are described, in the following, is not limiting upon the order in which the processor 310 executes instructions when the diagnostic apparatus 300 is operating.

The diagnostic apparatus 300 is configured to operate in conjunction with the complementary rack 100. In some embodiments, the diagnostic apparatus 300 may be capable of receiving multiple racks 100. FIG. 17 illustrate two racks 100 within the diagnostic apparatus 300. The rack 100 is configured to receive a number of biological samples in the sample tubes 102, and prepare these samples in a form suitable for work-up and diagnostic analysis. The rack 100 is configured to receive a number of reagents in reagent holders 104, which can be equipped with various components, optionally including the process tube 174, reagent tubes 176, and receptacles 180 with containers. The rack 100 is configured so that, during sample work-up, samples are processed in the respective reagent holders 104 in the respective lane 106 of the sample tube 102. In some embodiments, the processing involving mixing, heating, cooling, and/or magnetic separation.

The diagnostic apparatus 300 can be self-contained and operates in conjunction with the sample tubes 102 and the reagent holders 104 which are inserted via the rack 100 into the diagnostic apparatus 300. The diagnostic apparatus 300 may be configured for multiplexed sample analysis and/or analysis of multiple batches of samples, wherein a single rack 100 holds a single batch of samples. Each component of the diagnostic apparatus 300 may therefore be present as many times as there are batches of samples, though the various components may be configured in a common housing.

### A SECOND EXAMPLE RACK ACCORDING TO THE PRESENT DISCLOSURE

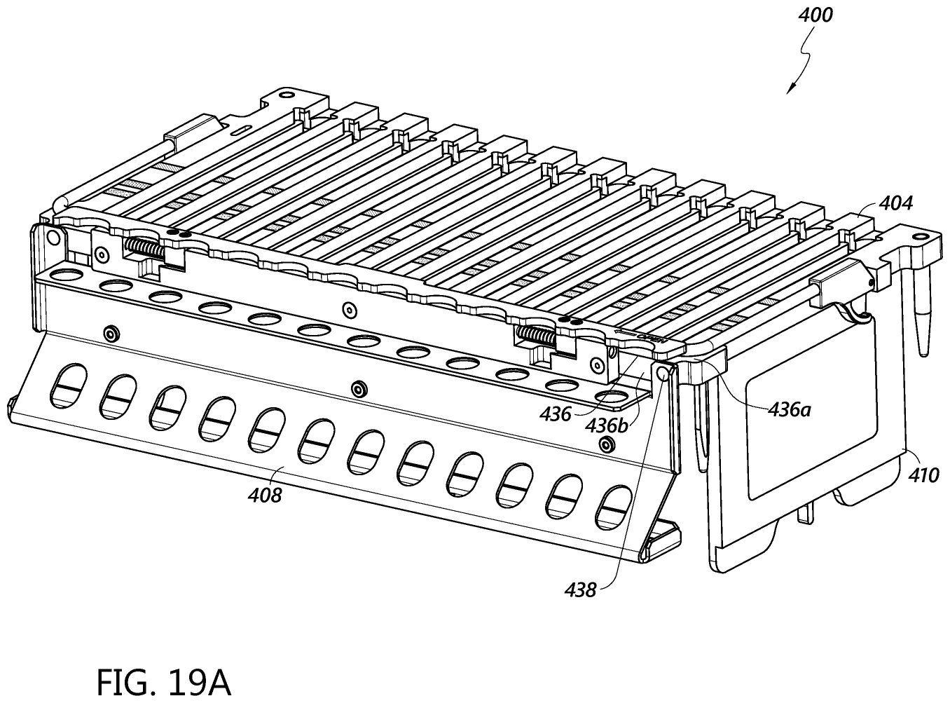

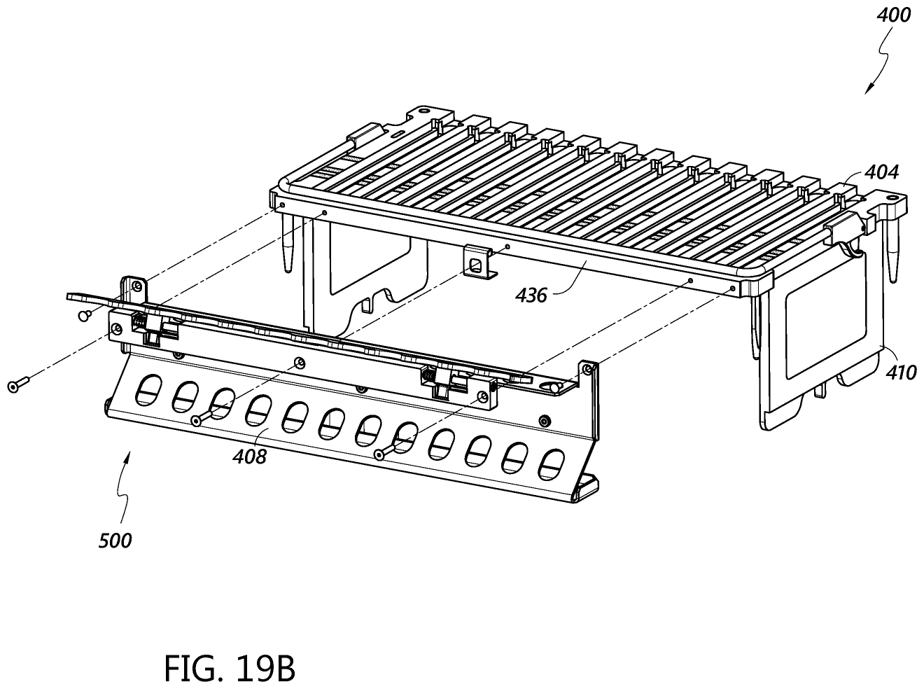

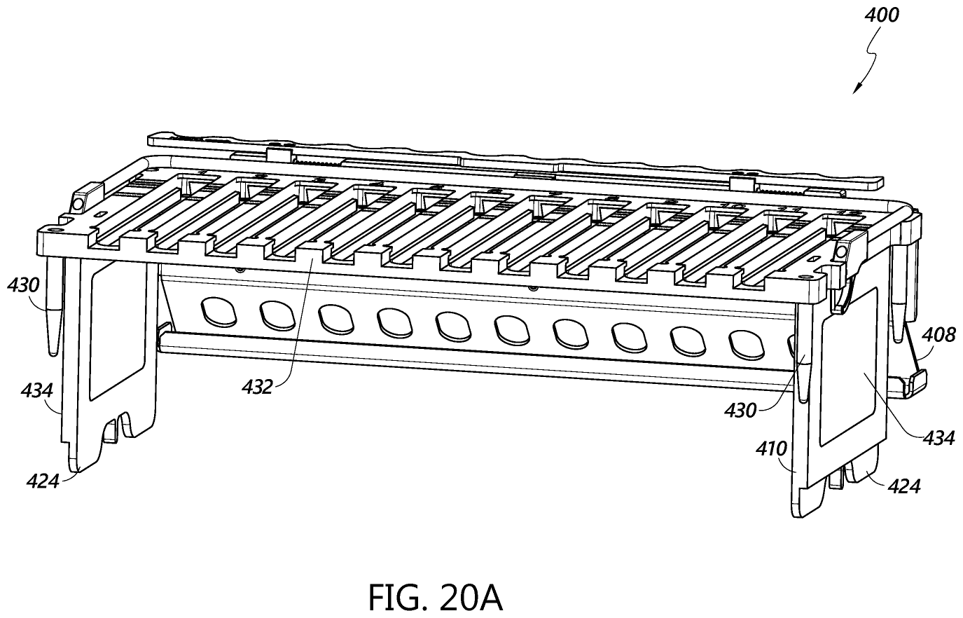

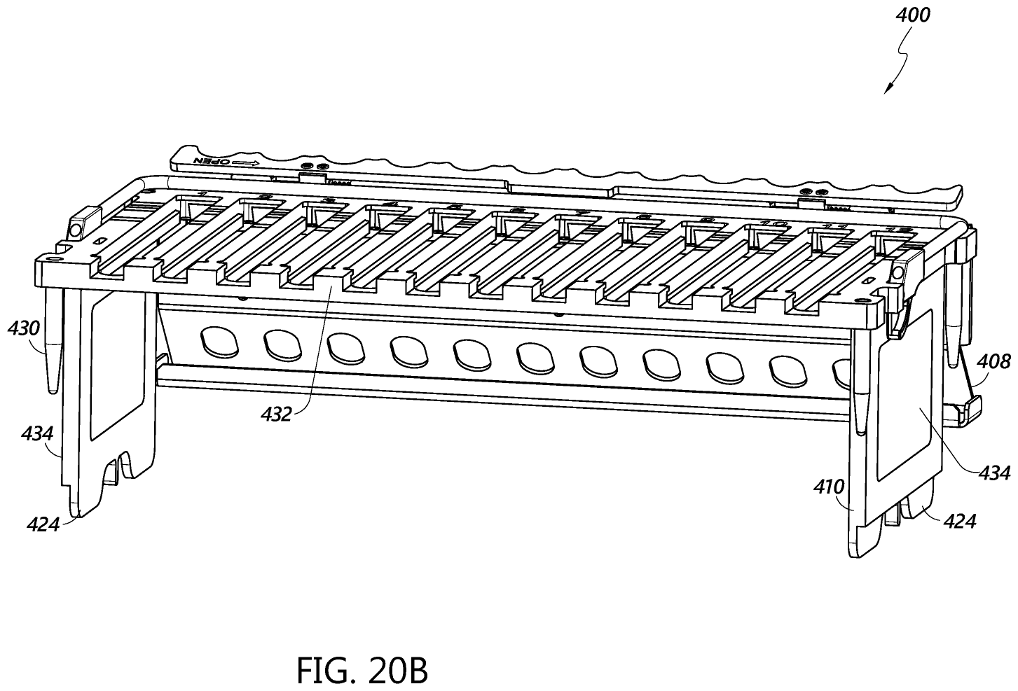

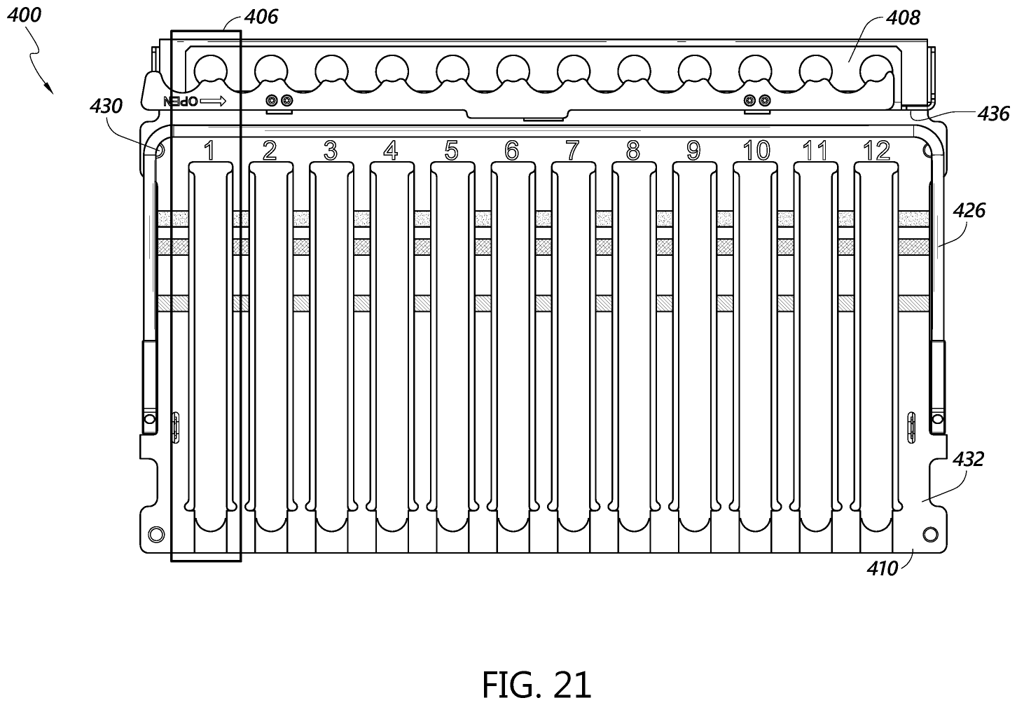

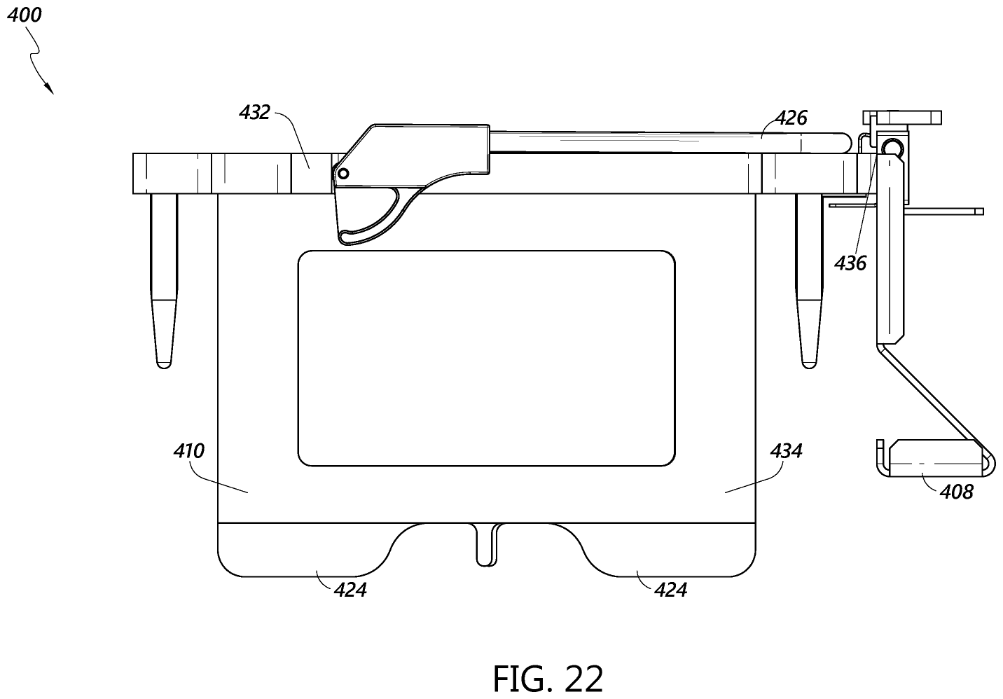

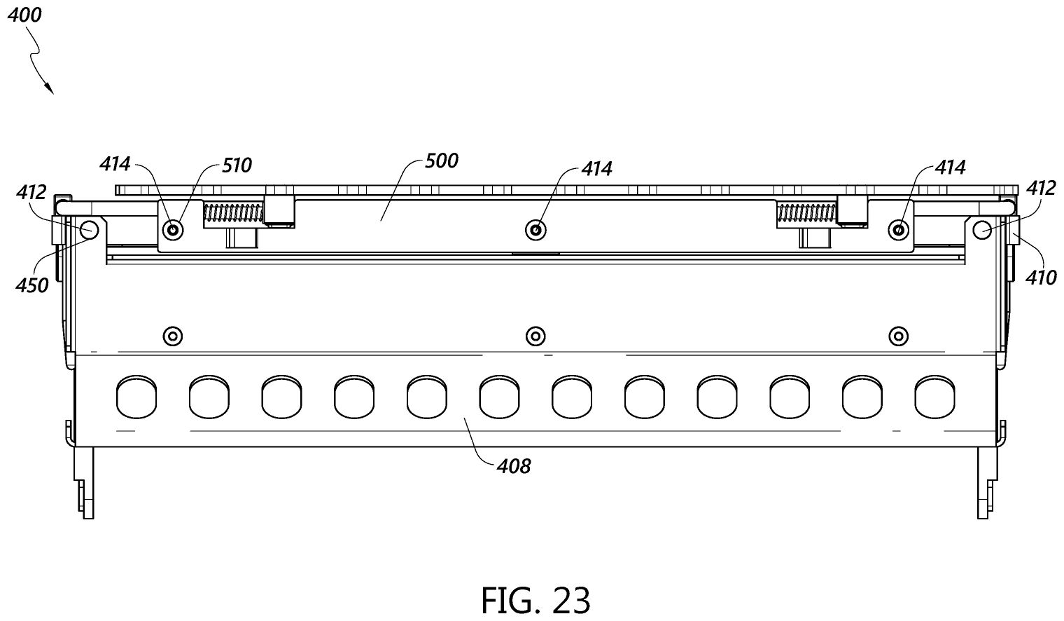

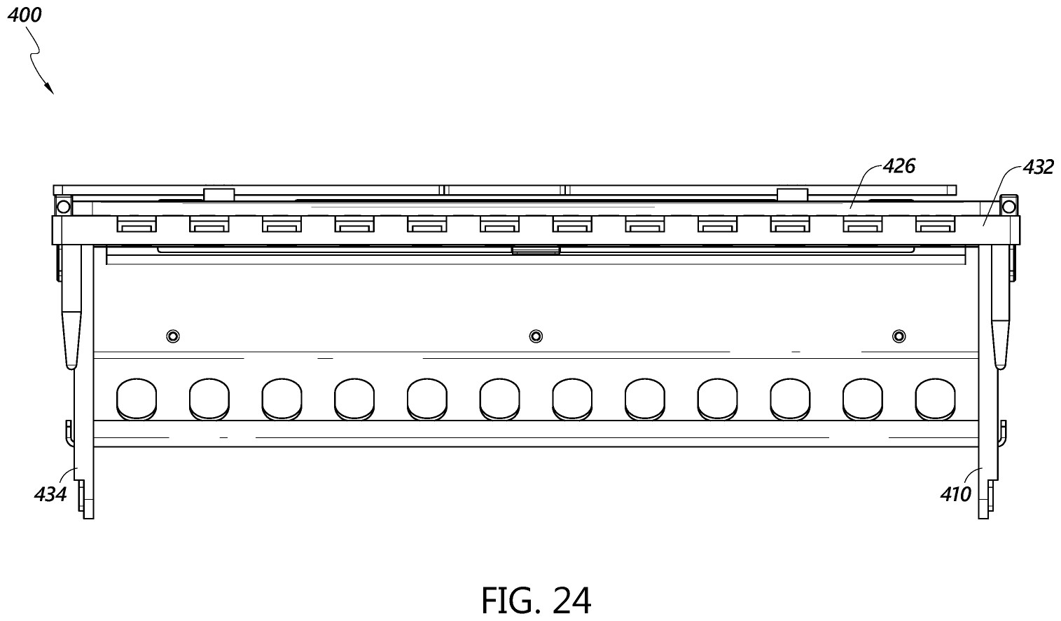

FIGS. 19-24 illustrate a rack 400 according to a second embodiment of the present disclosure. FIG. 19A shows a front perspective view of the rack 400. FIG. 19B shows an exploded front perspective view of the rack 400. FIGS. 20A-20B show a back perspective view of the rack 400. FIG. 21 shows a top view of the rack 400. FIG. 22 shows a side view of the rack 400. FIG. 23 shows a front view of rack 400. FIG. 24 shows a back view of rack 400. The rack 400 is configured to receive a plurality of sample tubes 102 and to receive a plurality of reagent holders 104. The rack 400 accepts these components in such a manner that the sample tubes 102 and reagent holders 104 can be separately and independently loaded from one another. The sample tubes 102 are in one-to-one correspondence with the reagent holders 104 in this non-limiting embodiment. The rack 400 is configured to accept twelve sample tubes 102 and twelve corresponding reagent holders 104. In some embodiments, the rack 400 may accept 1, 2, 4, 6, 8, 10, 12, 16, 20, 24, 36, 48, 60, or 72 samples tubes 102, and thus the rack 400 may accept 1, 2, 4, 6, 8, 10, 12, 16, 20, 24, 36, 48, 60, or 72 corresponding reagent holders 104. In some embodiments, the rack 400 may accept any suitable number of samples. In some embodiments, the rack 400 may accept any suitable number of reagent holders. The rack 400 can include any of the features of the rack 100 described herein.

The rack 400 can include two or more subcomponents. The rack 400 includes a sample tube holder 408 configured to accept the one or more sample tubes 102. See FIGS. 1-3 for a non-limiting embodiment of the sample tube 102. In this non-limiting example, the rack 400 also includes a reagent housing 410 configured to accept the one or more reagent holders 104. See FIGS. 1-3 for a non-limiting embodiment of the reagent holder 104. The sample tube holder 408 and the reagent housing 410 can be coupled to form a unitary structure. The sample tube holder 408 can include any feature of the sample tube holder 108 described herein. The reagent housing 410 can include any feature of the reagent housing 110 described herein. The rack 400 can be divided into one or more lanes 406. The lane 406 can have any feature of the lane 106 described herein.

The reagent housing 410 comprises a horizontal member 432, and two vertical members 434 connected to the horizontal member 432. Each of the vertical members 434 comprises two feet 424, but other configurations of the vertical member 434 and the feet 424 are contemplated. Any suitable arrangement of horizontal and vertical members can be implemented. The two vertical members 434 are configured to permit the reagent housing 410 to stand or maintain stability. The reagent housing 410 can include a handle 426.

The reagent housing 410 includes a reagent housing edge 436. The reagent housing edge 436 is where a horizontal portion 436a and a vertical portion 436b of the reagent housing 410 meet. The reagent housing edge 436 can be a ninety degree edge or a right angle edge. The reagent housing edge 436 can be an edge of the horizontal member 432.

The reagent housing edge 436 is disposed so that it is facing toward the sample tube holder 408 as described herein. The reagent housing 410 includes a first set of openings 438. The first set of openings 438 can include one or more openings. In the illustrated embodiment, the first set of openings 438 includes two openings. The first set of openings 438 are designed to couple with the sample tube holder 408 described herein.

The reagent housing 410 includes a second set of openings 440 shown in FIG. 19B. The second set of openings 440 can include one or more openings. In the illustrated embodiment, the second set of openings 440 includes three openings. The second set of openings 440 are designed to couple with a hinge assembly described herein. The first set of openings 438 can be closer to the two vertical members 434. The second set of openings 440 can be disposed between the first set of openings 438.

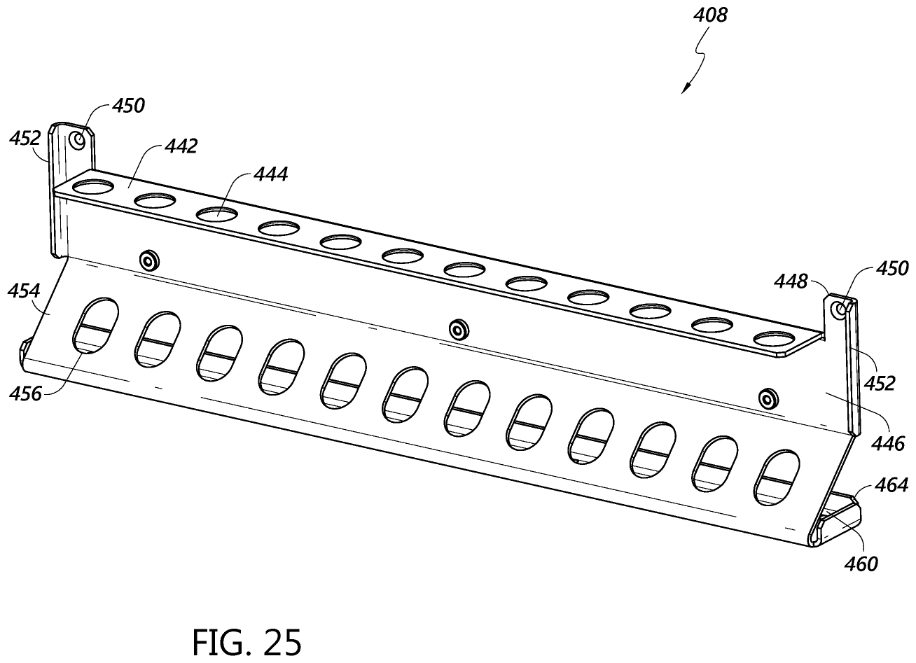

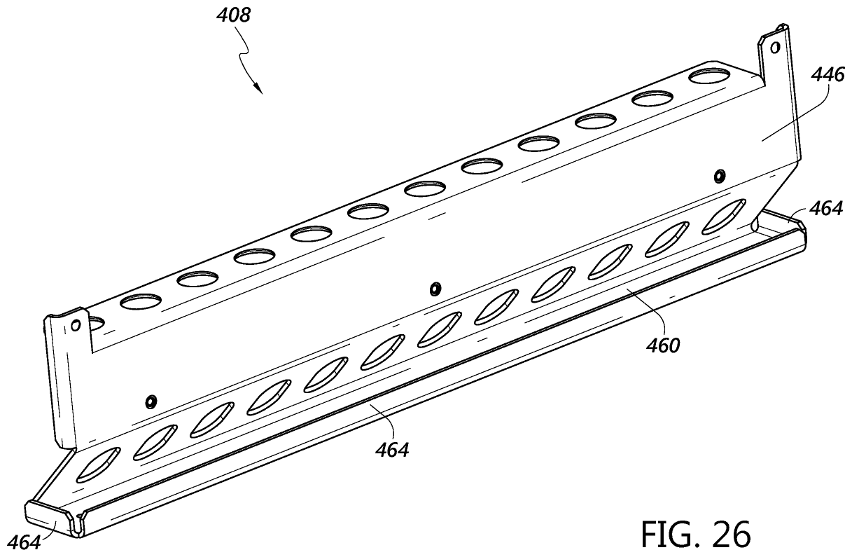

FIGS. 25 and 26 illustrate a non-limiting example sample tube holder 408 according to the present disclosure. The sample tube holder 408 includes features to position and retain the sample tubes 102. The rack 400 is configured to accept a plurality of samples, each sample received in one individual sample tube 102. FIG. 25 shows a front perspective view of the sample tube holder 408 and FIG. 26 shows a back perspective view of the sample tube holder 408. The sample tube holder 408 can have any features of the sample tube holder 108 described herein.

The sample tube holder 408 includes a first portion 442, a second portion 446, a third portion 454, and a fourth portion 460. The first portion 442 is planar or substantially planar. The first portion 442 includes a plurality of upper openings 444. The upper openings 444 can be round or circular, but can have other cross-sectional shapes depending on the features of the sample tube 102.

The sample tube holder 408 includes the second portion 446. The second portion 446 is vertical or substantially vertical. The second portion 446 includes upper posts 448. The upper posts 448 can extend vertically upward from the first portion 442. Each upper post 448 has an opening 450 configured to accept a fastener 412 therethrough. The second portion 446 can include one or more rails 452.

The sample tube holder 408 is configured to couple with the reagent housing 410 such that the two components of the rack 400 are rigidly connected. The openings 450 of the sample tube holder 408 are configured to align with the first set of openings 438 in the reagent housing 410. Any suitable fastener 412 can extend through an opening 450 of the sample tube holder 408 and a corresponding opening in the reagent housing 410 to couple the sample tube holder 408 to the reagent housing 410. The fastener 412 is illustrated in FIG. 23.

The sample tube holder 408 includes the third portion 454. In this example, the third portion 454 is oriented at a diagonal between the second portion 446 and the fourth portion 460. The third portion 454 includes a plurality of lower openings 456. The lower opening 456 can have any suitable cross-sectional shape, including but not limited to an oblong, elongated opening, an oval opening, and a circular opening. The lower opening 456 is shaped and configured to accommodate the circumference of the sample tube 102.

The sample tube holder 408 includes the fourth portion 460. One or more parts of the fourth portion 460 can be horizontal or substantially horizontal. The fourth portion 460 can form a base of the sample tube holder 408. The fourth portion 460 can include one or more rails 464.

In methods of use according to the present disclosure, each of a plurality of sample tubes 102 is inserted into the sample tube holder 408. The distal end 166 of the sample tube 102 is first inserted into the upper opening 444 of the first portion 442. The distal end 166 of the sample tube 102 is then passed vertically, parallel to the second portion 446. The distal end 166 of the sample tube 102 is next inserted into the lower opening 456 of the third portion 454. The distal end 166 of the sample tube 102 is then passed vertically to rest against a surface of the fourth portion 460. The proximal end 170 of the sample tube 102 extends above the first portion 442 of the sample tube holder 408 when the sample tube 102 is received therein. The proximal end 170 of the sample tube 102 can include the cap 172. The cap 172 extends above the first portion 442. See FIG. 7 for an embodiment of the sample tube 102 including the distal end 166, the proximal end 170, and the cap 172.

The upper opening 444 and the lower opening 456 can limit movement in a horizontal direction based on the similar shape of the openings 444, 456 to the outside surface of the sample tube 102. Advantageously, embodiments of the present disclosure allow portions of the sample tube 102 to be accessible to a sample identification verifier such as a bar code reader, when disposed within the sample tube holder 408.

### An Example Hinge Assembly According to a Second Embodiment of the Present Disclosure

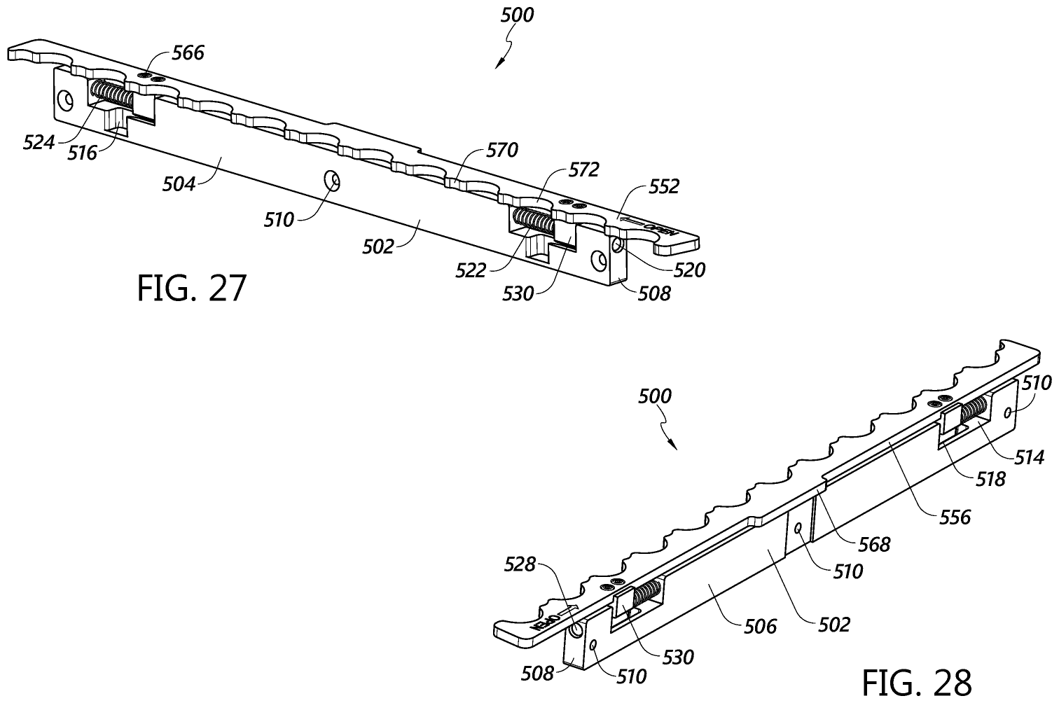

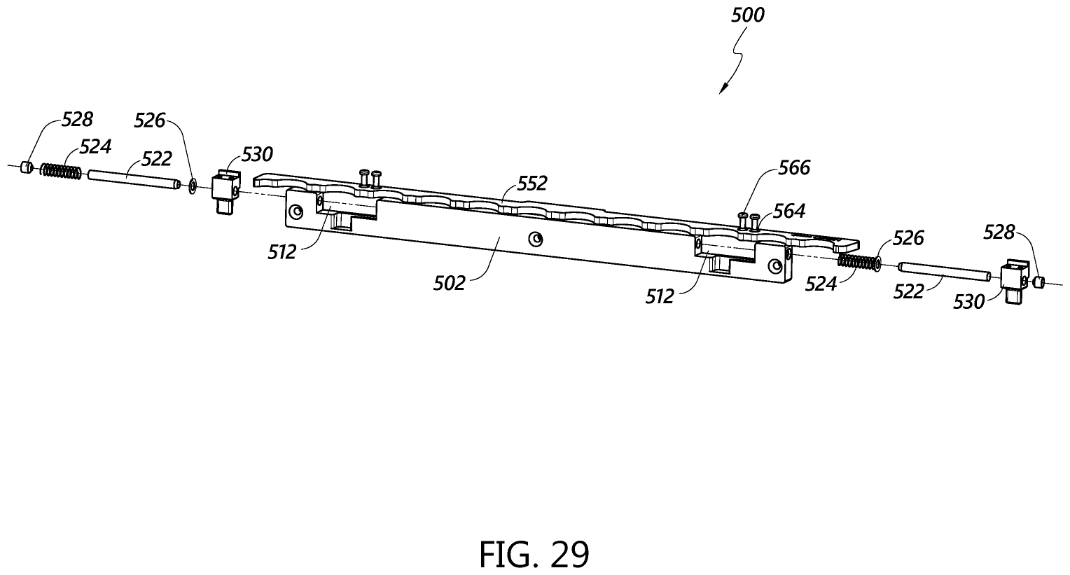

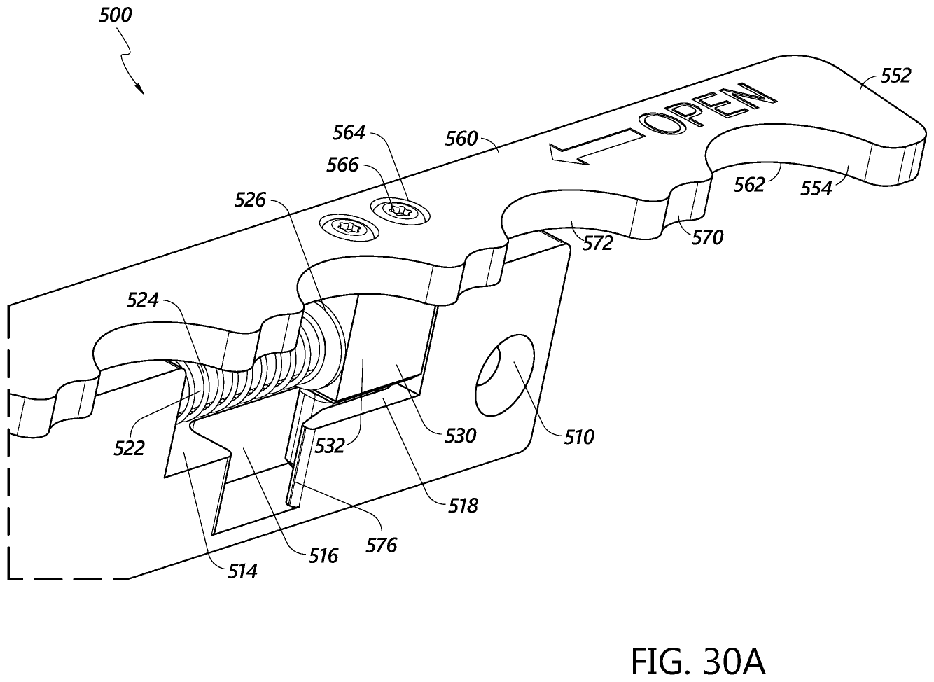

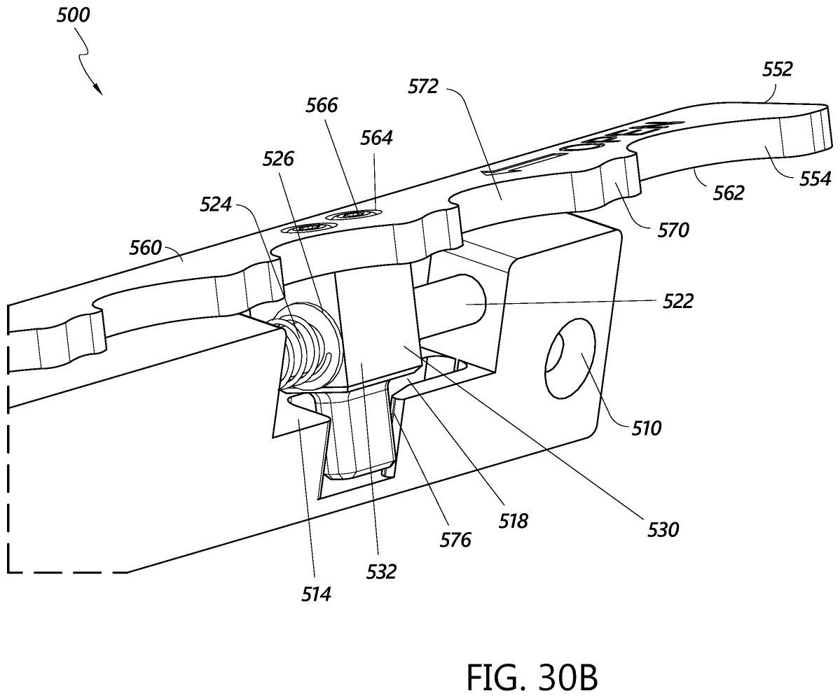

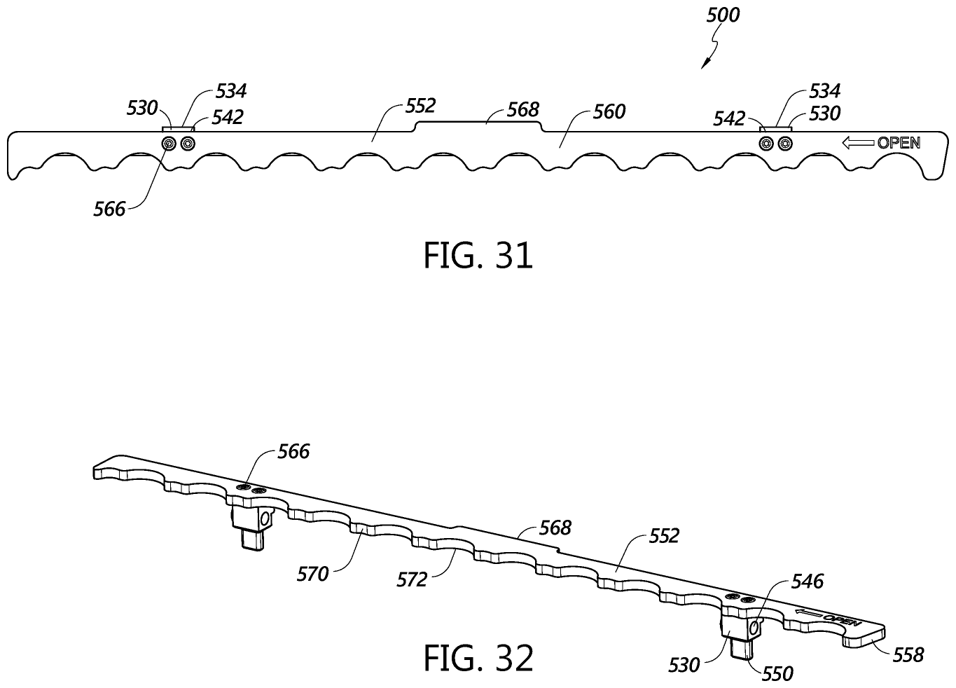

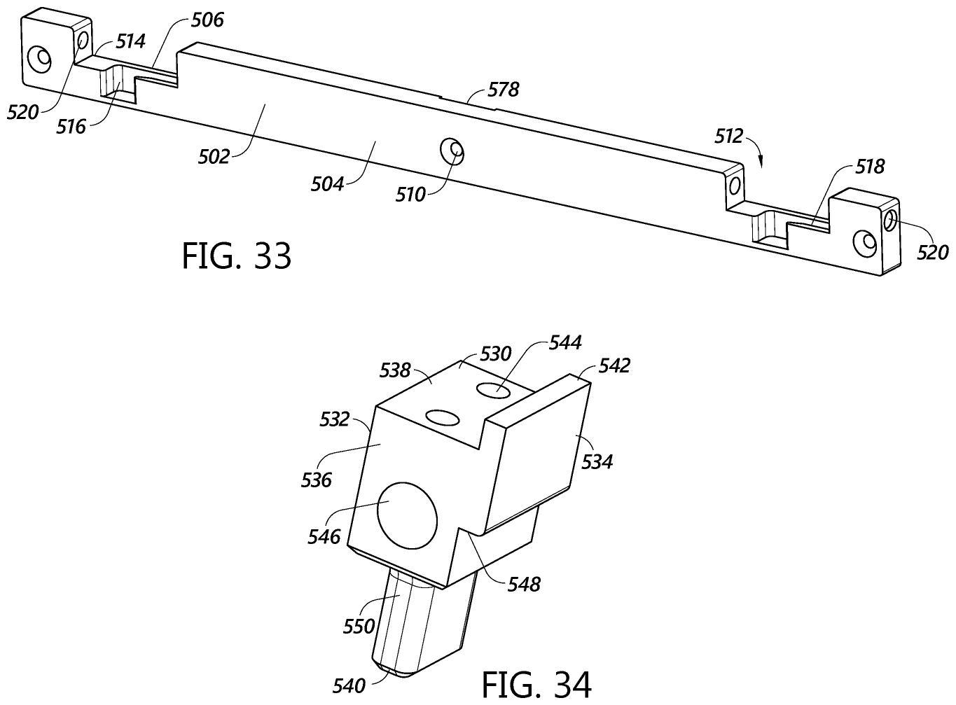

An example hinge assembly 500 according to a second embodiment of the present disclosure will now be described with reference to FIGS. 27-34. It will be understood that hinge assemblies of the present disclosure are not limited to the features of the example hinge assembly 500, and can take other forms, shapes, and dimensions consistent with the present disclosure. FIG. 27 shows a front perspective view of the hinge assembly 500. FIG. 28 shows a back perspective view of the hinge assembly 500. FIG. 29 shows a front exploded view of the hinge assembly 500. FIGS. 30A-30B shows front views of the hinge assembly 500. FIG. 31 shows a top view of the hinge assembly 500. FIG. 32 shows a view of a portion of the hinge assembly 500. FIG. 33 shows a view of a portion of the hinge assembly 500. FIG. 34 shows a view of a portion of the hinge assembly 500.

The hinge assembly 500 includes a tube insertion configuration. In the tube insertion configuration, the hinge assembly 500 can allow movement of the sample tube 102 within the sample tube holder 408 in a vertical direction. The sample tube 102 can be freely inserted or removed from the sample tube holder 408. The sample tube 102 is moved vertically or substantially vertically to insert the sample tube 102 into the sample tube holder 408. The method can be repeated to vertically insert the plurality of sample tubes 102 into the sample tube holder 408. In some methods of use, the sample tube 102 is moved vertically or substantially vertically to remove the sample tube 102 from the sample tube holder 408. In some methods of use, the rack is inverted to remove the sample tube 102 from the sample tube holder 408.

The hinge assembly 500 includes a tube retention configuration. In the tube retention configuration, the hinge assembly 500 can prevent or limit movement of the sample tube 102 within the sample tube holder 408 in a vertical direction. In some embodiments, the hinge assembly 500 can prevent or limit the sample tubes 102 from experiencing vertical lift during pipetting operations, thereby increasing pipetting efficiency. In some cases, there is some amount of vertical lift of the sample tube 102 during pipetting, for example during egress of the pipette tip from the sample tube 102. In these instances, the hinge assembly 500 in the tube retention configuration stops the sample tube 102 at a specific point during vertical travel of the sample tube 102, specifically when the sample tube 102 makes physical contact with and is physically restrained from further vertical lift by, the hinge assembly 500. In these instances, the hinge assembly 500 can stop the sample tube 102 from vertically lifting to such an extent that pipetting operations would be hindered or altogether halted due to malfunction of the liquid dispenser. The sample tubes 102 are advantageously vertically restrained by hinge assembly 500.

The hinge assembly 500 includes a hinge support 502. The hinge support 502 is a horizontal slide mount. The hinge support 502 is an elongate member. In the illustrated embodiments, the hinge support 502 is a generally rectangular shape. The hinge support 502 includes a front surface 504, a rear surface 506, and side surfaces 508. The front surface 504 faces the sample tubes 102 in use. The rear surface 506 faces the reagent housing 410 in use. The rear surface 506 can be planar to abut the vertical portion 436b of the reagent housing 410. The rear surface 506 can be any shape to allow a secure connection between the hinge support 502 and the reagent housing 410 when fastened together. The hinge support 502 can be any material including but not limited to metal and plastic.

The hinge support 502 has one or more openings 510 configured to accept a fastener 414. The one or more openings 510 extend from the front surface 504 to the rear surface 506. While three openings 510 are illustrated, the hinge support 502 can include any number of openings 510. Any segment of the hinge support 502 can include the one or more openings 510. The openings 510 are configured to align with the second set of openings 440 in the reagent housing 410. When a fastener 414 extends through the corresponding openings 510, 440, the hinge support 502 of the hinge assembly 500 is rigidly coupled to the reagent housing 410. The middle fastener 414 can also couple to self-locking tab as described herein. FIG. 23 illustrates the fastener 414. FIG. 19B illustrates the fasteners of the rack 400.

The hinge support 502 includes a cutout 512. While two cutouts 512 are illustrated, the hinge support 502 can include any number of cutouts 512. The cutout 512 includes an upper portion. The upper portion of the cutout 512 includes an upper opening 514. The upper opening 514 can be a generally rectangular opening of the cutout 512. The upper opening 514 extends from the front surface 504 to the rear surface 506. The upper opening 514 extends through the hinge support 502. In other embodiments, the upper opening 514 extends through a portion of the hinge support 502.

The cutout 512 includes a lower portion. The lower portion of the cutout 512 includes a lower opening 516. The lower opening 516 can be a generally rectangular opening. The lower opening 516 can be smaller than the upper opening 514. The lower opening 516 can be centered relative to the upper opening 514. The lower opening 516 can extend from the front surface 504 through a portion of the hinge support 502. In some embodiments, the lower opening 516 of the lower portion of the cutout 512 does not extend through the rear surface 506. In such embodiment, the lower opening 516 extends through only a portion of the hinge support 502. In other embodiments, the lower opening 516 extends through the hinge support 502.

The lower portion of the cutout 512 includes a channel 518. The channel 518 can be a generally rectangular channel. The channel 518 can be smaller than the upper opening 514. The channel 518 can be to the right of the lower opening 516 when viewed from the front of the hinge assembly 500 illustrated in FIG. 27. The channel 518 is disposed between the front surface 504 and the rear surface 506. In some embodiments, the channel 518 does not extend through the front surface 504. In some embodiments, the channel 518 does not extend through the rear surface 506. The channel 518 can form a catch, as described in greater detail below.

The hinge support 502 can include one or more bores 520. The one or more bores 520 can be coaxial. While two bores 520 are illustrated, the hinge support 502 can include any number of bores 520. The bore 520 extends horizontally through the hinge support 502. The bore 520 extends from the side surface 508 inward toward the center of the hinge support 502. The bore 520 ends at the upper opening 514, then continues toward the center of the hinge support 502 beyond the upper opening 514. In the illustrated example, each side surface 508 of the hinge support 502 can include a bore 520. In other examples, the hinge support 502 includes a single bore 520 that extends between the side surfaces 508 of the hinge support 502.

The hinge assembly 500 includes one or more hinge pins 522. The one or more hinge pins 522 can be coaxial. While two hinge pins 522 are illustrated, the hinge assembly 500 can include any number of hinge pins 522. The number of hinge pins 522 can correspond to the number of bores 520. In some embodiments, the hinge assembly 500 can include a single bores 520 and a single hinge pin 522. In some embodiments, the hinge assembly 500 can include a number of hinge pins 522 and a corresponding number of bores 520. In the illustrated embodiment, each bore 520 is configured to accept a hinge pin 522. The hinge pin 522 can be generally cylindrical member and the corresponding bore 520 can be cylindrical. The hinge pin 522 can provide a pivot axis about which components of the hinge assembly 500 can pivot. The hinge pin 522 can be disposed within the upper opening 514. The hinge pin 522 can be centered relative to the upper opening 514. The hinge pin 522 can be any material including stainless steel.

The hinge assembly 500 includes one or more springs 524. The one or more springs 524 can be coaxial. While two springs 524 are illustrated, the hinge assembly 500 can include any number of springs 524. The number of springs 524 can correspond to the number of cutouts 512 in a one-to-one correspondence. The number of springs 524 can correspond to the number of hinge pins 522 in a one-to-one correspondence. Any suitable spring 524 can be implemented in embodiments of the present disclosure. The spring 524 can be a compression spring. The springs 524 can be designed to apply a biasing force in order to regain a neutral configuration. The spring 524 can be any material including stainless steel. The spring 524 can be a 0.218″ outer diameter spring. The spring can be 1″ length spring. The hinge assembly 500 can include one or more washers 526. The washer 526 can distribute the force of the spring 524. The number of washers 526 can correspond to the number of springs 524 in a one-to-one correspondence. The hinge assembly 500 can include one or more caps 528. The cap 528 can retain the hinge pin 522 within the bore 520. The number of caps 528 can correspond to the number of hinge pins 522 in a one-to-one correspondence.

The hinge assembly 500 includes a slide lock 530. Features of a non-limiting example of a slide lock 530 will now be described but it will be understood that the present disclosure is not limited to this example any suitable slide lock can be implemented in accordance with the present disclosure. The slide lock 530 includes a front surface 532, a rear surface 534, and side surfaces 536. The front surface 532 faces the sample tubes 102 in use. The rear surface 534 faces the reagent housing 410 in use. The slide lock 530 can include a top surface 538 and a bottom surface 540. The slide lock 530 can be any material including plastic.

The top surface 538 of the slide lock 530 can form a ledge. The top surface 538 can form a right angle ledge. The top surface 538 can include a lip 542 that extends upward. The lip 542 can form a portion of the rear surface 534. The lip 542 can be a generally rectangular block. The top surface 538 has one or more openings 544 configured to accept a fastener. The one or more openings 544 extend from the top surface 538 toward the bottom surface 540. While two openings 544 are illustrated, the slide lock 530 can include any number of openings 544.

The slide lock 530 includes one or more bores 546. While one bore 546 is illustrated, the slide lock 530 can include any number of bores 546. The bore 546 extends horizontally through the slide lock 530. The bore 546 extends through the side surfaces 536. In the illustrated example, the slide lock 530 includes a single bore 546 that extends between the side surfaces 536 of the slide lock 530. The bores 546 can extend along a middle portion of the slide lock 530. The axis of the bore 546 can be transverse to the axis of the opening 544. In some embodiments, the bore 546 and the opening 544 intersect. In some embodiments, the bore 546 and the opening 544 do not intersect. The bore 546 can extend along a rotational center of the slide lock 530. The bore 546 is configured to accept a hinge pin 522 through the bore 546.

The rear surface 534 of the slide lock 530 can form a ledge. The rear surface 534 can form a right angle ledge. The rear surface 534 can include a notch 548 that extends inward. The notch 548 can form a portion of the rear surface 534. The notch 548 can be a generally rectangular notch. In some embodiments, the notch 548 and the lip 542 have the same or similar thickness. The notch 548 can extend parallel to the bore 546. The notch 548 can extend along a middle portion of the slide lock 530. The notch 548 can function as a stop to hold the hinge assembly 500 in the tube insertion configuration, as described herein. The rear surface 534 can be shaped in order to linearly slide relative to the reagent housing 410. The rear surface 534 can be generally planar. The rear surface 534 can slide relative to a planar surface of the reagent housing 410.

The slide lock 530 includes a flange 550. The flange 550 can be offset inward from the front surface 532. The flange 550 can be offset inward from the rear surface 534. The flange 550 can be centered between the front surface 532 and the rear surface 534. The flange 550 can be offset inward from the side surfaces 536. The flange 550 can be centered between the side surfaces 536. The flange 550 can form the bottom surface 540 of the slide lock 530. The flange 550 can be a generally rectangular block. The flange 550 can include one or more rounded edges.

The slide lock 530 can be assembled relative to the hinge pin 522 and the hinge support 502. The hinge pin 522 can be inserted within the bore 520 of the hinge support 502 near the side surface 508. The spring 524 can be disposed within the upper opening 514. The hinge pin 522 can be inserted through the spring 524. The washer 268 can be disposed within the upper opening 514. The hinge pin 522 can be inserted through the washer 526. The slide lock 530 can be positioned within the cutout 512. The flange 550 can be disposed within the lower portion of the cutout 512. The flange 550 can be disposed within the lower opening 516 and/or the channel 518. The hinge pin 522 can be inserted through the slide lock 530. The hinge pin 522 can be inserted into the hinge support 502. The hinge pin 522 can be secured with the cap 528. Another hinge pin 522 can be inserted within the bore 520 of the hinge support 502 near the other side surface 508 and through a second slide lock 530 in a similar manner.

The slide lock 530 can slide relative to the hinge pin 522. The slide lock 530 can slide in two directions that are generally parallel to a longitudinal axis of the hinge support 502. An upper portion of the slide lock 530 can slide within the upper opening 514 of the cutout 512. The flange 550 can slide within the lower opening 516. The flange 550 can slide within channel 518. The channel 518 is dimensioned to allow the flange 550 to slide therewithin. During the sliding motion of the slide lock 530, the hinge support 502 is configured to remain stationary. The slide lock 530 is configured to slide relative to the fixed hinge support 502.

The slide lock 530 can slide in two directions. In a first direction, the slide lock 530 compresses the spring 524 against an interior surface of the upper opening 514. In the illustrated embodiment shown in FIG. 30A, the slide lock 530 compresses the spring when the slide lock 530 slides to the left. In a second direction, the slide lock 530 decompresses the spring 524. The spring 524 can bias the spring lock 530 to move in the second direction. In the illustrated embodiment shown in FIG. 30A, the slide lock 530 decompresses the spring when the slide lock 530 slides to the right.

The slide lock 530 can rotate about the hinge pin 522 when the flange 550 is positioned in the lower opening 516. The flange 550 can rotate from a position aligned with the channel 518 to a positioned that is skewed relative to the channel 518. The flange 550 can rotate through the lower opening 516. The slide lock 530 can rotate about the hinge pin 522 when the spring 524 is compressed. The slide lock 530 can rotate about the hinge pin 522 when the slide lock 530 is slid to the right. The slide lock 530 can rotate about the hinge pin 522 after sliding the slide lock 530 to align the flange 550 with the lower opening 516. The flange 550 is not positioned within or constrained by the channel 518 in the tube insertion configuration. In the tube insertion configuration, the flange 550 has rotated from a position within the lower opening 516 (aligned with but not disposed within the channel 518) to a position where the flange 550 passes through a plane that includes the front surface 504. FIG. 30B illustrates the flange 550 is rotated out of the lower opening 516 in the tube insertion configuration.

To transition to the tube retention configuration, the slide lock 530 can be rotated to align the flange 550 with the channel 518. In some embodiments, the slide lock 530 is slid into the channel 518 by the user. In some embodiments, the spring 524 can bias the flange 550 to slide into the channel 518. The spring 524 can move the slide lock 530 toward the right as viewed from the perspective of FIG. 30B. The channel 518 can prevent or limit the flange 550 from rotating when the flange 550 is within the channel 518. The channel 518 can prevent or limit the slide lock 530 from rotating. During the sliding motion, the hinge support 502 is configured to remain stationary. The slide lock 530 is configured to slide relative to the fixed hinge support 502.

The hinge assembly 500 includes a hinge plate 552. As will be described in greater detail below, the hinge plate 552 can be rigidly coupled to two slide locks 530 such that, in use, sliding and pivoting movement of the slide locks 530 relative to the hinge support 502 causes sliding and pivoting movement of the hinge plate 552 relative to the hinge support 502. The hinge plate 552 includes a front surface 554, a rear surface 556, and side surfaces 558. The rear surface 556 faces the reagent housing 410 in use. The hinge plate 552 can include a top surface 560 and a bottom surface 562. The hinge plate 552 can be planar or substantially planar. The top surface 560 and the bottom surface 562 can be parallel. The hinge plate 552 can have a constant thickness between the top surface 560 and a bottom surface 562.

The hinge plate 552 includes one or more openings 564 configured to accept a fastener 566 therethrough. While four openings 564 are illustrated, the hinge plate 552 can include any number of openings 564. Any segment of the hinge plate 552 can include the one or more openings 564. In the illustrated embodiment, two opening 564 are disposed near a right side of the hinge plate 552 and two opening 564 are disposed near a left side of the hinge plate 552. The one or more openings 564 extend from the top surface 560 to the bottom surface 562 of the hinge plate 552.

As described herein, the top surface 538 of the slide lock 530 has one or more openings 544 configured to accept a fastener. The top surface 538 of the slide lock 530 forms a ledge shaped and sized to receive a portion of the hinge plate 552. The top surface 538 of the slide lock 530 includes a lip 542 that extends upward. The lip 542 is configured to be disposed near the rear surface 556 of the hinge plate 552. The remaining portion of the top surface 538 of the slide lock 530 extends along the bottom surface 562 of the hinge plate 552. The lip 542 can facilitate alignment between the slide lock 530 and the hinge plate 552. When the hinge plate 552 abuts the lip, the openings 544, 564 align. The one or more openings 564 of the hinge plate 552 can align with one or more openings 544 of the slide lock 530. The fasteners 566 can couple the hinge plate 552 and the slide lock 530. The hinge plate 552 and the slide lock 530 can form a unitary structure. When a fastener 566 extends through the corresponding openings 544, 564, the hinge plate 552 is rigidly coupled to the slide lock 530. The fastener 566 can be a torx screw. The fastener 566 can be 18-8 screw. The fastener 566 can be made of any material including stainless steel. In an alternative embodiment, the hinge plate 552 and one or more slide locks 530 are manufactured as a single unitary piece, for example injection molded of any suitable plastic.

The rear surface 556 of the hinge plate 552 can include a flange 568. The flange 568 can provide support to a middle portion of the hinge plate 552. The flange 568 can prevent bending of a middle portion of the hinge plate 552. The flange 568 can be a surface that receives a force and is actuated to pivot the hinge plate 552 as described in greater detail below.

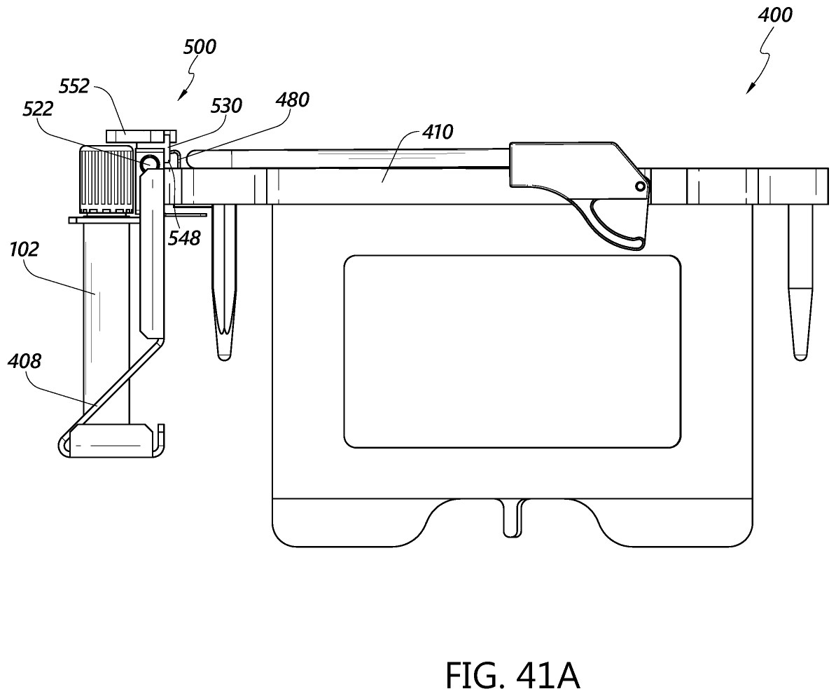

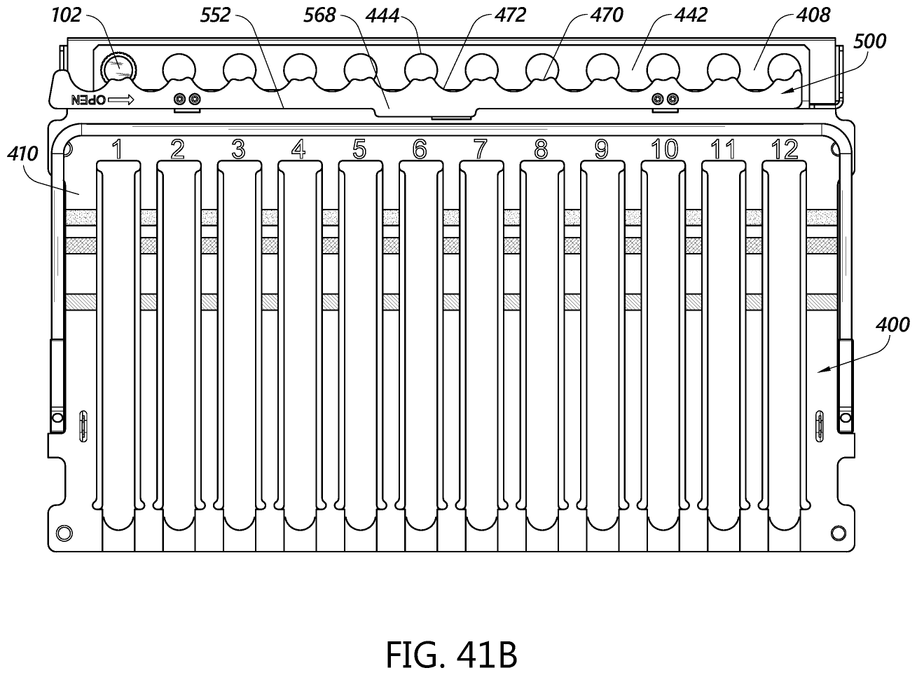

The front surface 554 of the hinge plate 552 can include a profiled edge. The front surface 554 includes a plurality of concave surfaces. The front surface 554 includes a plurality of minor indents 570. The hinge plate 552 is configured to restrain one or more sample tubes 102 received in the sample tube holder 408 from moving in a vertical direction. The one or more sample tubes 102 are restrained with a respective minor indent 570. In this example, the hinge plate 552 is configured to retain twelve sample tubes 102 received in the sample tube holder 408 with twelve minor indents 570, respectively. See FIG. 21 and FIG. 41B, which is described in greater detail below. While the hinge plate 552 is illustrated with twelve minor indents 570, the hinge plate 552 can include any number of minor indents 570.

The minor indents 570 can be rounded. The minor indents 570 can be semi-circular or hemispherical. The minor indents 570 can be a portion of a circle. The minor indents 570 can a portion of a circle, for instance 30°, 40°, 50°, 60°, 70°, 80°, 90°, 100°, 110°, 120°, 130°, 140°, 150°, 160°, 170°, 180°, 190°, 200°, 210°, 220°, 230°, 240°, 250°, 260°, 270°, or any range of the foregoing values. The minor indents 570 can be tapered. The minor indents 570 can correspond to the number of upper openings 444 in the sample tube holder 408 in a one-to-one correspondence. The minor indents 570 can include one or more rounded edges such as rounded corners or bends.

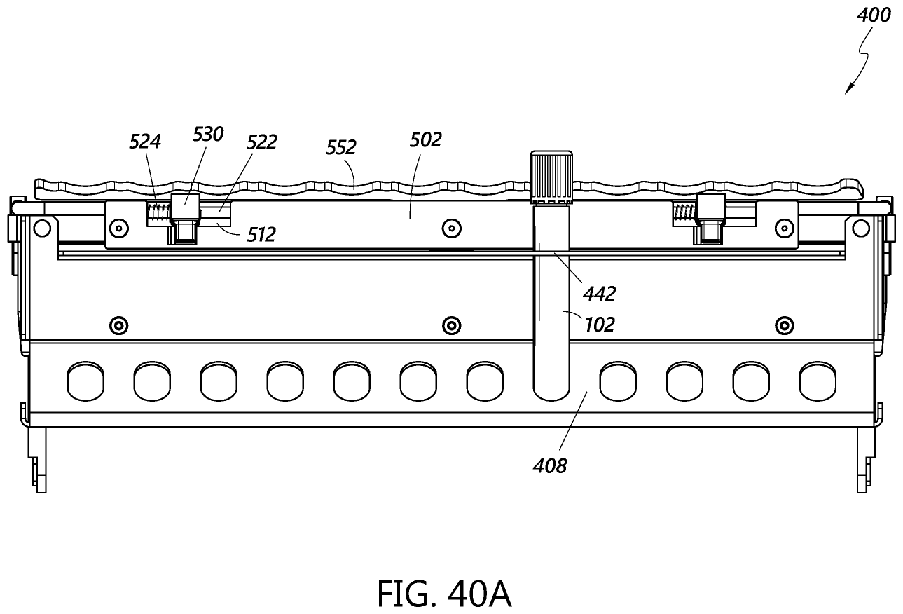

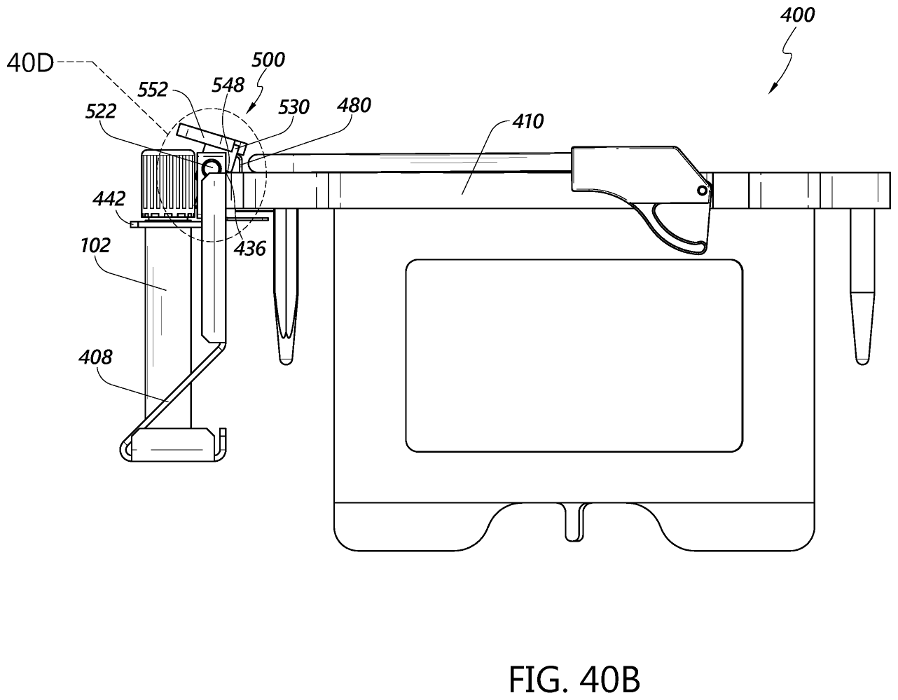

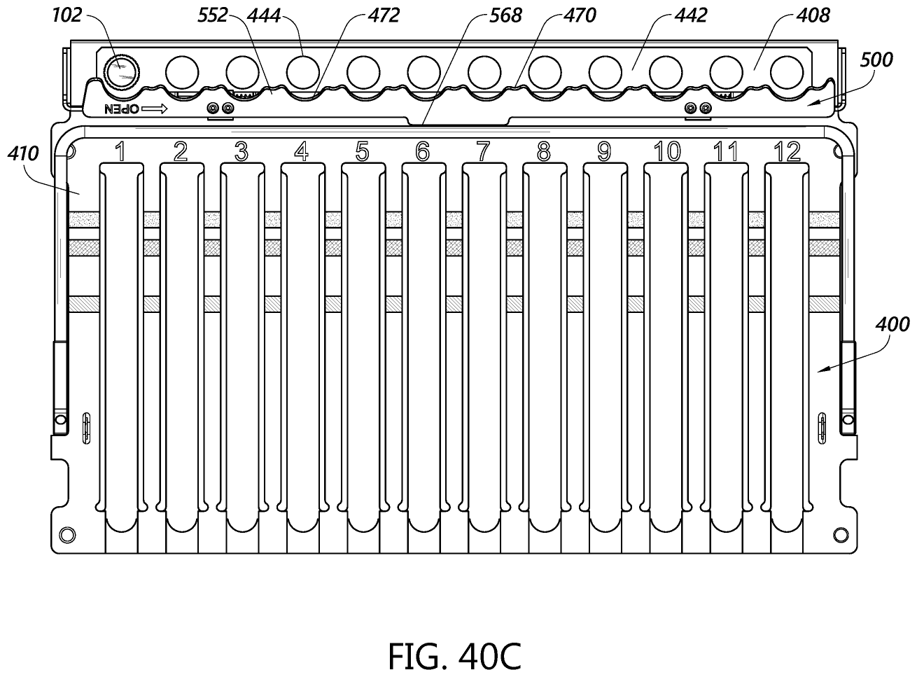

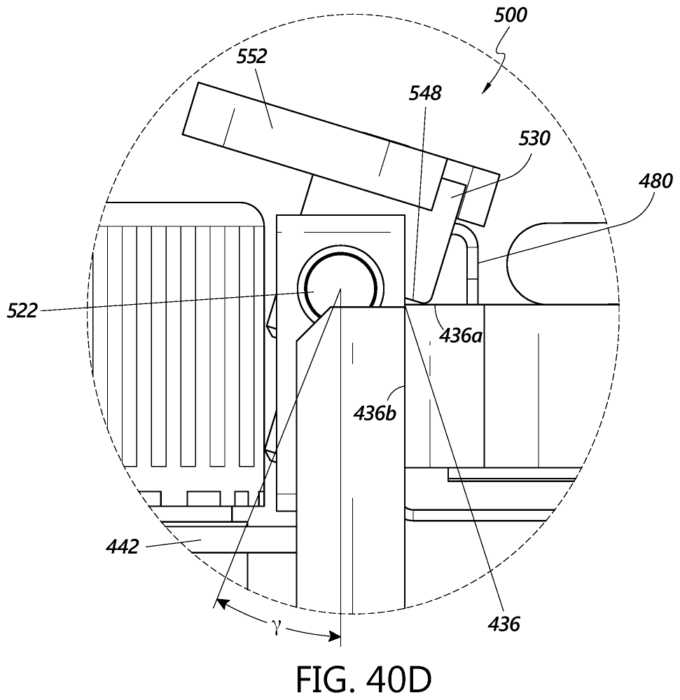

The front surface 554 includes a plurality of major indents 572. The hinge plate 552 is configured to allow insertion and removal of one or more sample tubes 102 through upper and lower openings 444, 456 of the sample tube holder 408. Movement of a sample tube 102 is permitted when the sample tube is aligned with a respective major indent 572. See FIG. 40C, which is described in greater detail below. The hinge plate 552 is configured to allow receipt of twelve sample tubes through the major indents 572 and then into upper and lower openings 444, 456 of the sample tube holder 408. The hinge plate 552 is also configured to release twelve sample tubes 102 from the sample tube holder 408 when they are aligned with the major indents 572. While the hinge plate 552 is illustrated with twelve major indents 572, the hinge plate 552 can include any number of major indents 572. The plurality of major indents 572 can be interposed between the plurality of minor indents 570. Each of the major indents 572 can be disposed to the right of a corresponding minor indent 570 when viewed from the perspective of FIGS. 31 and 32.

The major indents 572 can be rounded. The major indents 572 can be semi-circular or hemispherical. The major indents 572 can be a portion of a circle. The major indents 572 can a portion of a circle, for instance 90°, 100°, 110°, 120°, 130°, 140°, 150°, 160°, 170°, 180°, 190°, 200°, 210°, 220°, 230°, 240°, 250°, 260°, 270°, 280°, 290°, 300°, 310°, 320°, or any range of the foregoing values. The major indents 572 can be tapered. The major indents 572 can correspond to the number of sample tubes 102 in the sample tube holder 408 in a one-to-one correspondence. The major indents 572 can include one or more rounded edges such as rounded corners or bends.

In some embodiments, the minor indents 570 and the major indents 572 can have a different radius of curvature. In some embodiments, the major indents 572 can have a larger radius of curvature than the minor indents 570. In some embodiments, the minor indents 570 and the major indents 572 can have the same radius of curvature. In some embodiments, the minor indents 570 and the major indents 572 can be concave. The hinge plate can include one or more rounded edges such as rounded corners or bends that connect the minor indents 570 and the major indents 572. The minor indents 570 and the major indents 572 can form a repeating pattern.

The front surface 554 can include different features near the side surfaces 558 when viewed from the perspective of FIGS. 31 and 32. In the illustrate embodiment, the minor indent 570 closest to the left side surface 558 can be a greater portion of the circle than the other minor indents 570. The minor indent 570 closest to the left side surface 558 can be a portion of a circle, for instance 30°, 40°, 50°, 60°, 70°, 80°, 90°, 100°, 110°, 120°, 130°, 140°, 150°, 160°, 170°, 180°, 190°, 200°, 210°, 220°, 230°, 240°, 250°, 260°, 270°, or any range of the foregoing values. In the illustrated embodiment, the major indent 572 closest to the right side surface 558 can be a greater portion of the circle than the other major indents 572. The major indent 572 closest to the right side surface 558 can be a portion of a circle, for instance 90°, 100°, 110°, 120°, 130°, 140°, 150°, 160°, 170°, 180°, 190°, 200°, 210°, 220°, 230°, 240°, 250°, 260°, 270°, 280°, 290°, 300°, 310°, 320°, or any range of the foregoing values. The side surfaces 558 can be parallel. The side surfaces 558 can include one or more rounded edges. The major indents 572 and the minor indents 570 can be spaced inward from the side surfaces 558.

The minor indents 570 of the hinge plate 552 can be shaped and sized to allow access to the contents of the sample tube 102 when the hinge plate 552 is in the tube retention configuration. In the tube retention configuration, the minor indents 570 do not obstruct a central region or area C of the top of the sample tube 102. The minor indents 570 can cover a portion of the cap 172 but not the central area C. The plurality of minor indents 570 can simultaneously retain a plurality of sample tubes 102 in the sample tube holder 408. The plurality of minor indents 570 can collectively and simultaneously retain all sample tubes 102 positioned in the sample tube holder 408. The minor indents 570 of the hinge plate 552 may or may not contact the sample tubes 102 in the sample tube holder 408. In some embodiments, the minor indents 570 of the hinge plate 552 may make direct physical contact with a cap or proximal end of the sample tubes 102. In some embodiments, the minor indents 570 can be vertically offset from the sample tubes 102 in a locked or tube retention configuration. In such cases, there is a vertical space between the top of the sample tube 102 (or the cap of the sample tube 102) and the bottom of the minor indent 570 during normal operation, and the sample tube 102 only comes into contact with (and is restrained from further vertical movement by) the minor indent 570 when the sample tube 102 experiences vertical movement or liftoff during a pipetting operation.

In the tube insertion configuration, the hinge plate 552 has been slid toward the left as viewed from the perspective of FIGS. 30A and 31. The hinge plate 552 has been pivoted after sliding, as shown in FIG. 30B. In the tube insertion configuration, the major indents 572 are disposed over the caps 172 of the sample tubes 102. The major indents 572 of the hinge plate 552 allow insertion or removal of the sample tube 102. In the tube insertion configuration, the major indents 572 do not obstruct the vertical movement of the sample tube 102. The plurality of major indents 572 can allow separate or simultaneous release a plurality of sample tubes 102 from the sample tube holder 408.

### An Example Self-locking Tab According to the Second Embodiment of the Present Disclosure

An example self-locking tab for use in the second embodiment of the present disclosure will now be described. It will be understood that examples of the second embodiment do not require the self-locking tab. For example, the self-locking tab can be omitted from the second embodiment, or a different self-locking tab can be suitable implemented in the second embodiment. The self-locking tab allows the hinge plate to be mechanically pivoted by an upward force of the self-locking tab. Once pivoted, the hinge plate can slide from the tube insertion configuration to the tube retention configuration under the influence of a biasing force of the spring 524. The self-locking tab can be actuated by a receiving bay of the diagnostic apparatus 300 to ensure that the hinge assembly 500 is in the tube retention configuration during operations within the diagnostic apparatus 300.

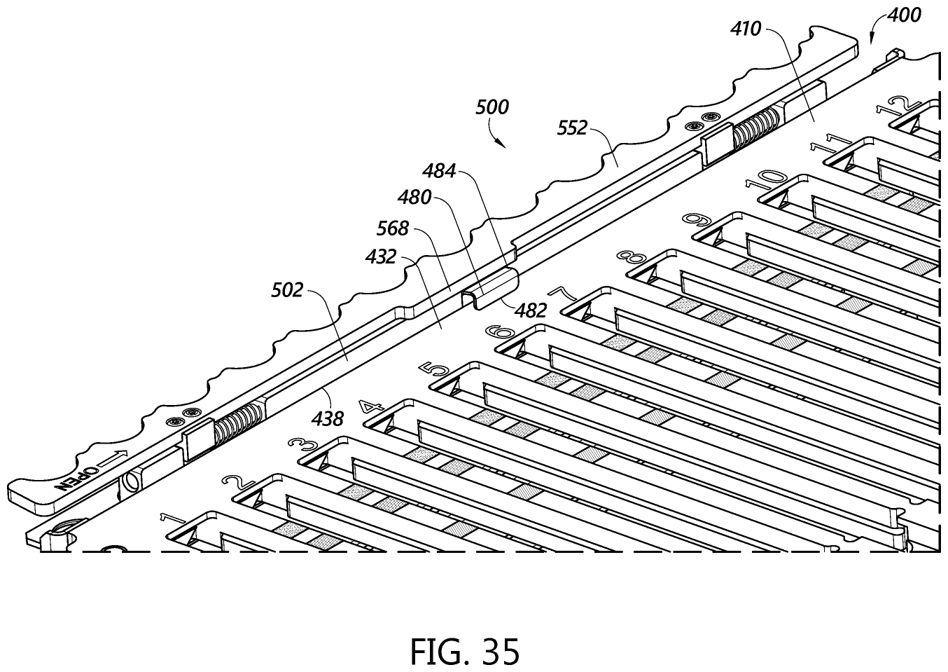

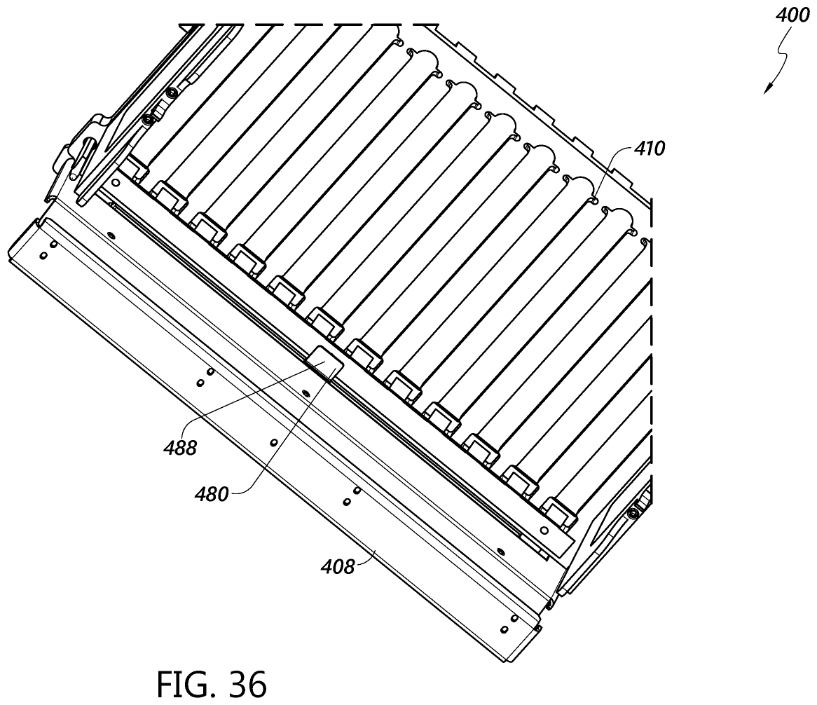

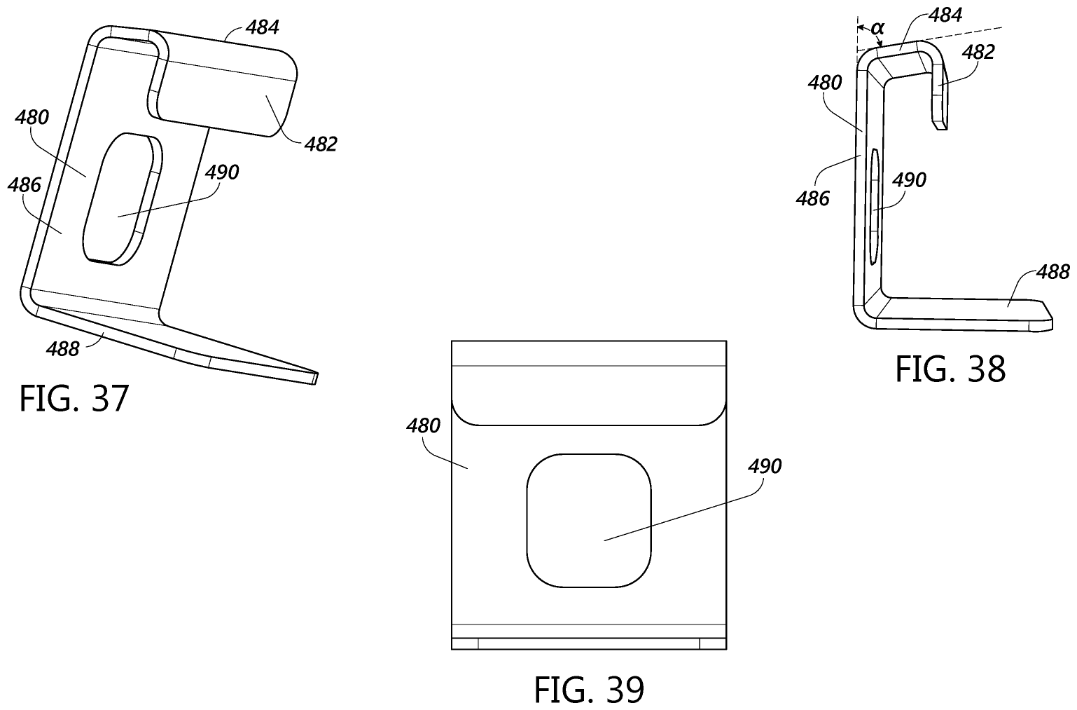

FIG. 35 shows a top view of the rack 400 with a self-locking tab 480. FIG. 36 shows a bottom view of the rack 400 with a self-locking tab 480. FIG. 37 shows a side perspective view of the self-locking tab 480. FIG. 38 shows a side view of the self-locking tab 480. FIG. 39 shows a back view of the self-locking tab 480. The self-locking tab 480 includes a first portion 482, a second portion 484, a third portion 486, and a fourth portion 488. The first portion 482 can be planar or substantially planar. In this non-limiting embodiment, the first portion 482 is vertical. The second portion 484 can be planar or substantially planar. The second portion 484 can slope downward between the first portion 482 and the third portion 486 as shown in FIG. 38. The second portion 484 can form an angle (α) from vertical as shown in FIG. 38. The angle α relative to a vertical axis can be 40° from vertical, 45° from vertical, 50° from vertical, 50° from vertical, 55° from vertical, 60° from vertical, 65° from vertical, 70° from vertical, 75° from vertical, 80° from vertical (as illustrated), 85° from vertical, 90° from vertical (e.g., horizontal), or any range of the foregoing values. The transition between the first portion 482 and the second portion 484 can be rounded. The transition between the second portion 484 and the third portion 486 can be rounded. The third portion 486 can be planar or substantially planar. In this non-limiting embodiment, the third portion 486 is vertical. The first portion 482 and the third portion 486 can be parallel.

The third portion 486 has an opening 490 configured to accept the fastener 414 therethrough. As described herein, the hinge support 502 has one or more openings 510 configured to accept one or more fasteners 414. The middle fastener 414 can also couple to self-locking tab 480. The middle fastener 414 is shown in FIG. 23. Any segment of the third portion 486 can include the one or more openings 490. The opening 490 is configured to align with a corresponding opening 440 in the reagent housing 410 and a corresponding opening 510 in the hinge support 502. The opening 490 is configured to align with a middle opening 440 of the reagent housing 410 and a middle opening 510 in the hinge support 502. The opening 490 is shaped and sized to allow the fastener 414 to move freely within but still be constrained by the opening 490. As will be described in detail below, the self-locking tab 480 is configured to move vertically relative to the fastener 414. Movement of the self-locking tab 480 is constrained by various features described in detail below. One feature that constrains movement of the self-locking tab 480 is the inner surface of the opening 490 coming into physical contact with and being restrained by the fastener 414.

The fourth portion 488 can be planar or substantially planar. In this non-limiting embodiment, the fourth portion 488 is horizontal. The transition between the third portion 486 and the fourth portion 488 can be rounded. The second portion 484 can be skewed relative to the fourth portion 488.

In use, the self-locking tab 480 is disposed between the reagent housing 410 and the hinge support 502 as shown in FIG. 35. The third portion 486 is disposed between the reagent housing 410 and the hinge support 502. The third portion 486 extends above and below the horizontal member 432 of the reagent housing 410, as shown in FIG. 35. The first portion 482, the second portion 484 and at least a portion of the third portion 486 are above the horizontal member 432, as shown in FIG. 35. The fourth portion 488 is below the horizontal member 432 as shown in FIG. 36. The first portion 482 and the second portion 484 extend away from the sample tube holder 408. The fourth portion 488 extends away from the sample tube holder 408. Referring back to FIG. 33, the hinge support 502 can include a cutout 578 configured to retain the self-locking tab 480. The cutout 578 can have a similar lateral dimension as the self-locking tab 480. The cutout 578 can allow vertical movement of the self-locking tab 480 relative to the hinge support 502.

As described above with reference to FIGS. 23 and 27, the hinge support 502 has one or more openings 510 configured to accept the fastener 414. The one or more openings 510 extend from the front surface 504 to the rear surface 506. The openings 510 are configured to align with the second set of openings 440 in the reagent housing 410. When the fastener 414 extends through the corresponding openings 510, 440, 490, the self-locking tab 480 is able to slide relative to the reagent housing 410. The opening 490 is dimensioned larger than the corresponding fastener 414. The opening 490 allows the self-locking tab 480 to slide in a vertical direction relative to the reagent housing 410. The opening 490 is oblong in the vertical direction. The opening 490 can be any shape to allow vertical movement when the self-locking tab 480 is coupled to the reagent housing 410.

The self-locking tab 480 can translate vertically in an upward direction until the fourth portion 488 makes physical contact with is and is constrained by the horizontal member 432 of the reagent housing 410. The self-locking tab 480 can translate vertically in a downward direction until the first portion 482 makes physical contact with is and is constrained by the horizontal member 432 of the reagent housing 410. The self-locking tab 480 can translate vertically until the fastener 414 abuts an upper wall or lower wall of the opening 510 as the self-locking tab 480 slides.

### Example Methods of Operating a Hinge Assembly of the Second Embodiment of the Present Disclosure

FIGS. 40A-40D show views of the operation of the hinge assembly 500 according to the second embodiment. FIG. 40A is a front view of the sample tube 102 being inserted into the sample tube holder 408. FIG. 40B is a side view of the sample tube 102 fully inserted into the sample tube holder 408. FIG. 40C is a top view of the sample tube 102 and the sample tube holder 408 when the sample tube 102 is fully inserted. FIG. 40D is a view of detail 40D of FIG. 40B. In a first configuration illustrated in FIGS. 40A-40D and referred to herein as a “tube insertion configuration,” the hinge assembly 500 is configured to allow the sample tube 102 to be inserted into the sample tube rack 408. The description below describes the hinge assembly 500 in this tube insertion configuration.

The slide lock 530 is slid to the left in the tube insertion configuration as viewed in FIG. 30A. The slide lock 530 compresses the spring 524 as shown in FIG. 30B. The flange 550 is to the left of the channel 518 as shown in FIG. 30B. The channel 518 does not retain the flange 550. The flange 550 is positioned within the lower opening 516. The flange 550 is rotated out of the lower opening 516. The flange 550 passes through the lower opening 516 in the front surface of the hinge assembly 500. A portion of the flange 550 abuts the wall 576 of the lower opening 516. The flange 550 is skewed outward from the lower opening 516. The flange 550 is rotated toward the front as shown in FIG. 30B. The flange 550 is rotated away from lower opening 516. In some cases, the flange 550 can be positioned relative to a vertical axis at an angle gamma (γ). The angle γ can be acute. The angle γ can be 2° from vertical, 4° from vertical, 6° from vertical, 8° from vertical, 10° from vertical, 12° from vertical 14° from vertical, 16° from vertical, 18° from vertical, 20° from vertical, 22° from vertical 24° from vertical, 26° from vertical, 28° from vertical, 30° from vertical, 32° from vertical 34° from vertical, 36° from vertical, 38° from vertical, 40° from vertical, or any range of the foregoing values. Although the view illustrated in FIGS. 40B and 40D appears to indicate that the flange 550 is in physical contact with the sample tube 102, this is a result of the perspective illustrated in FIG. 40D. In some embodiments, the flange 550 of the slide lock 530 does extend past the cap of the sample tube 102 in a side view. In some embodiments, the slide lock 530 is positioned so that during the range of motion the slide lock 530 never contacts the sample tube 102 (e.g., spaced in between the sample tubes 102).

In the tube insertion configuration, the hinge plate 552 is skewed relative to the first portion 442 of the sample tube holder 408. The hinge plate 552 is tilted away from the sample tubes 102. For example, the hinge plate 552 is rotated clockwise along its longitudinal axis as viewed from the perspective of FIG. 40B. The hinge plate 552 is tilted upward. The plurality of major indents 572 are aligned with the upper opening 444 of the sample tube holder 408. The hinge plate 552 is rotated toward the reagent housing 410. The hinge plate 552 is rotated to provide clearance for the sample tube 102 to be inserted past the plurality of major indents 572 and into the upper opening 444 of the sample tube holder 408. In the tube insertion configuration, the hinge plate 552 is positioned to provide clearance for the sample tube 102 to be inserted vertically into the sample tube holder 408. The tube insertion configuration also allows for tube removal. The hinge plate 552 is rotated to provide clearance for the sample tube 102 to be removed past the plurality of major indents 572 and removed from the upper opening 444 of the sample tube holder 408. The hinge plate 552 is positioned to provide clearance for the sample tube 102 to be removed vertically from the sample tube holder 408.

In the tube insertion configuration, the notch 548 of the slide lock 530 can function as a stop to hold or retain the hinge plate 552 in the tube insertion configuration, until actuated to change from the tube insertion configuration. When being held in the tube insertion configuration, the hinge plate 552 can be spring-loaded to actuate and move to the tube retention configuration. The notch 548 can abut the reagent housing edge 436 as shown in FIG. 40B. The notch 548 can provide an additional point of contact between the hinge assembly 500 and the reagent housing 410. The notch 548 can provide stability to the slide lock 530. The notch 548 can prevent further rotation of the slide lock 530. When the notch 548 abuts the reagent housing edge 436, further rotational movement in one direction can be prevented. The notch 548 can prevent further clockwise rotation of the slide lock 530 about the hinge pin 522. The notch 548 can allow counterclockwise rotation of the slide lock 530 about the hinge pin 522, from the view of FIG. 40B, until the notch abuts the housing edge 436. The notch 548 of the slide lock 530 can abut the reagent housing edge 436 along a surface of the notch 548. Contact between the notch 548 of the slide lock 530 and reagent housing 410 can limit further rotation of the hinge plate 552 in the clockwise direction, as viewed from the perspective of FIGS. 40A and 40B.

The hinge pin 522 provides the axis of rotation for rotational movement of the hinge plate 552 and the slide locks 530. In the tube insertion configuration, all other translations and rotations can be prevented or limited. The hinge plate 552 and the slide locks 530 can have one degree of freedom of rotational motion in the tube insertion configuration. For example, as shown in FIG. 40A, the hinge plate 552 and the slide locks 530 of hinge assembly 200 can rotate in the counterclockwise direction. Once rotated in the counterclockwise direction, the slide lock 530 can have additional degrees of freedom such as to allow sliding.

FIG. 40C illustrates the top view of the hinge plate 552 in the tube insertion configuration. As in FIGS. 40A and 40B, hinge plate 552 is rotated toward the reagent housing 410 (away from the first portion 442 of the sample tube holder 408). The major indents 572 of the hinge plate 552 provide clearance for the insertion of the sample tube 102 into the sample tube holder 408 along a vertical axis of an upper opening 444 in the first portion 442. As shown in FIG. 40C, the major indent 572 is laterally offset from the upper opening 444 of the sample tube holder 408, when viewed from the top of the hinge assembly 500. The distance of lateral offset can be a distance that allows a user to insert a sample tube 102 in the sample tube holder 408 without interference from or contact with the hinge plate 552.

Operation of the hinge assembly 500 according to the present disclosure includes moving the hinge plate 552 from the tube insertion configuration illustrated in FIGS. 40A-40D to a second configuration illustrated in FIGS. 41A and 41B and referred to herein as a “tube retention configuration.” FIG. 41A is a side view of the hinge assembly 500 after actuation. FIG. 41B is a top view of the sample tube 102 and the sample tube holder 408 after the hinge assembly 500 is actuated and has moved from the tube insertion configuration to the tube retention configuration. As described herein, the hinge plate 552 is coupled to the two slide locks 530 via the fasteners 566. The hinge plate 552 and the one or more slide locks 530 rotate about the hinge pin 522 as a unitary structure. The hinge plate 552 and the one or more slide locks 530 slide about the hinge pin 522 as a unitary structure. The hinge plate 552 and the one or more slide locks 530 can rotate and slide relative to the stationary hinge support 502. The description below describes the hinge assembly 500 in the tube retention configuration.

In this non-limiting embodiment, the hinge plate 552 is positioned in a horizontal or substantially horizontal orientation in the tube retention configuration, as illustrated in FIG. 41A. The hinge plate 552 and the slide lock 530 can be rotated counterclockwise from the perspective of FIG. 40A. The hinge plate 552 and the slide lock 530 can be rotated from a skewed orientation to a generally horizontal orientation. As the hinge plate 552 and the slide lock 530 rotate, the flange 550 rotates from abutting the wall 576 of the lower opening 516 to a position entirely within the lower opening 516 in which the flange 550 is between the front surface 504 and the rear surface 506 of the hinge support 502. As the hinge plate 552 and the slide lock 530 rotate, the flange 550 rotates inward toward the rear surface 506. The hinge plate 552 and the slide lock 530 can be rotated until the flange 550 is vertical or generally vertical. The hinge plate 552 and the slide lock 530 can be rotated until the flange 550 abuts a rear portion of the lower opening 516. The hinge plate 552 and the slide lock 530 can be rotated until the flange 550 is aligned with the channel 518. In these example implementations, contact between the flange 550 and rear portion of the lower opening 516 limits further counterclockwise rotation of the hinge plate 552 and the slide lock 530.

In this non-limiting embodiment, the hinge plate 552 and the slide lock 530 slide along the hinge pin 522. The spring 524 applies a force to the slide lock 530, and thus to the hinge plate 552 which is coupled to the slide lock 530. The spring 524 biases the slide lock 530 in a first direction. The spring 524 biases the slide lock 530 to move within the lower opening 516 in the first direction toward the channel 518, see FIG. 30A. The flange 550 slides within the channel 518 under the influence of the spring 524. The hinge plate 552 is positioned in a horizontal or substantially horizontal orientation when the flange 550 slides within the channel 518. The hinge plate 552 and the slide lock 530 can slide until the slide lock 530 contacts the side surface of the upper opening 514. In these example implementations, contact between the slide lock 530 and the upper opening 514 limits further sliding of the slide lock 530 relative to the hinge support 502, and thus limits further sliding of the hinge plate 552 (coupled to the slide lock 530) relative to the hinge support 502. Upon completion of this pivoting and sliding motion of the slide lock 530 and the hinge plate 552, the hinge plate 552 is in the tube retention configuration as shown in FIG. 30A.

The hinge plate 552 retains the sample tubes 102 within the sample tube holder 408 when in the tube retention configuration. Compared with FIG. 40B, the hinge plate 552 is pivoted and slid. The plurality of the minor indents 570 of the hinge plate 552 are vertically aligned with the sample tubes 102. In some embodiments, the plurality of the minor indents 570 of the hinge plate 552 overlies a portion of the sample tube 102 or the cap 172 of the sample tube 102. In some embodiments, the hinge plate 552 is vertically offset from the top surface of the cap 172 of the sample tube 102. In some embodiments, the hinge plate 552 has a small vertical clearance between the hinge plate 552 and the top surface of the cap 172 of the sample tube 102.

The minor indents 570 of the hinge plate 552 can be concave or cutout to allow access to the contents of the sample tube 102. In the tube retention configuration, the minor indents 570 allow access to the central region or area C of the top of the sample tube 102. In some embodiments, the central region or area C of the top of the sample tube 102 can include a foil cover. In some embodiments, the central region or area C of the top of the sample tube 102 can include membrane configured to be pierced. In the tube retention configuration, the minor indents 570 can be shaped similar to an outside rim or edge of the cap 172. The minor indents 570 can simultaneously retain a plurality of sample tubes 102 in the sample tube holder 408. The minor indents 570 can collectively and simultaneously apply a vertical retaining force if the sample tubes experience liftoff during pipetting operations.

In embodiments of the present disclosure, an actuation force pivots the hinge plate 552 to move the hinge assembly 500 from the tube insertion configuration to the tube retention configuration. In some embodiments, the same actuation force pivots the hinge plate 552 to move the hinge assembly 500 from the tube retention configuration to the tube insertion configuration. In other embodiments, a second, different actuation force can move the hinge assembly 500 from the tube insertion configuration to the tube retention configuration.

In some embodiments, a user applies an actuation force to a portion of the hinge assembly 500 to pivot the hinge plate 552 relative to the hinge support 502 to move the hinge assembly 500 from the tube insertion configuration to the tube retention configuration. In some embodiments, the actuation force of the spring 524 slides the hinge plate 552 in a translational direction (to the right/left as viewed from FIGS. 30A-30B) after the user pivots the hinge plate 552. In some embodiments, a user applies an actuation force to a portion of the hinge assembly 500 to move the hinge assembly 500 from the tube retention configuration to the tube insertion configuration. In some embodiments, a user applies a force to rotate the hinge plate 552. In some embodiments, a user applies a force to translate the hinge plate 552. In some embodiments, the user can exert a downward force on the hinge plate 552 to rotate the hinge plate 552. In some embodiments, the actuation force of the spring 524 translate the hinge plate 552 in a translation direction after the user applies a pivoting force on the hinge plate 552.

In another example illustrated in FIG. 41A and described in detail below, a structural feature of a receiving bay in which the rack 400 is received exerts an actuation force on the self-locking tab 480 to move the move the hinge assembly 500 from the tube insertion configuration to the tube retention configuration. The structural feature can maintain this actuation force thus locking the hinge plate 552 in the tube retention configuration.

It will be understood that any portion of the self-locking tab 480 can be contacted by an actuation force to pivot the hinge assembly 500. For example, the first portion 482, the second portion 484, the third portion 486, or the fourth portion 488 can be pushed upward to move the self-locking tab 480 into engagement with the hinge plate 552. The fourth portion 488 can be planar or substantially planar. In this non-limiting embodiment, the fourth portion 488 is horizontal. In some embodiments, the fourth portion 488 of the self-locking tab 480 is contacted by an actuation force to pivot the hinge assembly 500. The self-locking tab 480 can be actuated to change the position of the hinge assembly 500. As viewed from the perspective of FIGS. 40A and 41A, the hinge plate 552 is actuated to rotate the hinge plate 552 in the counter-clockwise direction. The second portion 484 of the hinge plate 552 can be a lever arm which allows rotation of the hinge plate 552.

Embodiments of the hinge assembly 500 can be actuated to move from the tube insertion configuration to the tube retention configuration by a partition 250 in the receiving bay that receives the rack 400. See FIG. 18. The partition 250 can include a surface, a wall, a ledge, an enclosure, or any other suitable structure shaped, sized, and positioned in the receiving bay to actuate the self-locking tab 480 when the rack 400 is inserted into the receiving bay. In the illustrated example, the partition 250 can include one or more ledges or stepped surfaces. For example, in one non-limiting example, the partition 250 can include one or more pegs, rods, or bars positioned in the receiving bay to interact with the hinge assembly 500 when the rack 400 is inserted into the receiving bay. The partition 250 is shaped and sized to partition the receiving bay into two areas, a first area and a second area. When the rack 400 is received in the receiving bay, the reagent housing 410 is positioned in the first area and the sample tube holder 408 is positioned in the second area. The partition 250 is located between the reagent housing 410 and the sample tube holder 408 when the rack 400 is located in the receiving bay.

The partition 250 acts on the self-locking tab 480 as the rack 400 is inserted in the receiving bay. The partition 250 contacts the fourth portion 488 of the self-locking tab 480. The partition 250 applies an upward force on the fourth portion 488 of the self-locking tab 480. Interaction of the partition 250 with the fourth portion 488 thus slides the self-locking tab 480 upward. The self-locking tab 480 contacts the flange 568 of the hinge plate 552. See FIGS. 35 and 40C. The rear surface 556 of the hinge plate 552 can include the flange 568. The flange 568 can extend way from the profiled front surface 554. In use, the flange 568 extends over the self-locking tab 480 when the rack 400 is assembled.

The flange 568 can be actuated to pivot the hinge plate 552. The self-locking tab 480 is pushed upward by the partition 250. The self-locking tab 480 slides relative to the fastener 414 inserted within the opening 490 of the self-locking tab 480. The second surface 484 of the self-locking tab 480 is skewed. See FIG. 38. As the self-locking tab 480 moves upward, the upward edge of the second surface 484 contacts the flange 568. The upward edge of the second surface 484 is located near the interface between the second surface 484 and the first surface 482. The upward edge of the second surface 484 is spaced from the third surface 486. The upward edge of the second surface 484 is toward the rear edge of the flange 568 to provide greater leverage to pivot the hinge plate 552.

Referring back to FIG. 18, the diagnostic apparatus 300 includes the receiving bay 301 configured to receive the rack 400, or portions of the rack 400. In this example, the receiving bay 301 includes a first portion 303 configured to receive the reagent housing 410 of the rack 400. The receiving bay 301 can include a second portion 304 separate from and adjacent to the first portion 303. The second portion 304 can include an open volume, well, or bay separate from and adjacent to the first portion 303. The rack 400 can be designed so that it can be easily inserted and removed from the diagnostic apparatus 300, for instance the reagent housing 410 can be inserted in the first portion 303 of the receiving bay 301 and the sample tube holder 408 can be inserted in the second portion 304 of the receiving bay 301. The receiving bay 301 can include the partition 250. The partition 250 is located between the first portion 303 of the receiving bay 301 and the second portion 304 of the receiving bay 301. The partition 250 can be stationary in the receiving bay 301, such as an integral wall portion of the receiving bay 301. The rack 400 interacts with the partition 250 as it is lowered into the receiving bay 301 of the diagnostic apparatus 300. The partition 250 actuates the self-locking tab 480 by providing a stop which pushes the self-locking tab 480 upward. This upward movement self-locking tab 480 acts upon the hinge plate 552 of the hinge assembly 500.

The self-locking tab 480 rotates the hinge plate 552 about the hinge support 502. Upon rotation, the spring 524 slides the hinge plate 552 and causes the hinge assembly 500 to transition from the tube insertion configuration to the tube retention configuration. In some embodiments, the self-locking tab 480 pivots the hinge plate 552 to move the hinge assembly 500 from the tube insertion configuration to the tube retention configuration. In some embodiments, the user pivots the hinge plate 552 to move the hinge assembly 500 from the tube insertion configuration to the tube retention configuration before insertion into the receiving bay. In some embodiments, the self-locking tab 480 or the user provides the pivoting motion to facilitate the transition of the hinge assembly 500 from the tube insertion configuration to the tube retention configuration.

In some embodiments, the spring 524 slides the hinge plate 552 to facilitate the transition of the hinge assembly 500 from the tube insertion configuration to the tube retention configuration. The spring 524 can provide a biasing force to slide the hinge plate 552. In some embodiments, the spring 524 slides the hinge plate 552 after the self-locking tab 480 or the user provides the pivoting motion. In some embodiments, the user pivots and slides the hinge plate 552 to move the hinge assembly 500 from the tube insertion configuration to the tube retention configuration.

While the rack 400 is within the receiving bay, the self-locking tab 480 is pushed upward by the partition 250. The self-locking tab 480 limits or prevents the hinge plate 552 from pivoting into the tube insertion configuration while the rack 400 is received within the receiving bay. The self-locking tab 480 ensures that the hinge assembly 500 is in the tube retention configuration when within the receiving bay. The self-locking tab 480 ensures that the hinge plate 552 is always horizontal or generally horizontal when placed in the diagnostic apparatus 300. FIG. 17 illustrates an embodiment of the diagnostic apparatus 300. The diagnostic apparatus 300 can be configured to actuate the self-locking tab 480, as described herein. In the tube retention configuration, the hinge plate 552 can limit vertical movement of the sample tubes 102 if the sample tubes 102 are lifted during pipetting operations.

The user can remove the rack 400 from the receiving bay of the diagnostic apparatus 300. Once the rack 400 is removed from the receiving bay, the self-locking tab 480 no longer interacts with the partition 250 and can slide downward under the influence of gravity. The second portion 484 of the self-locking tab 480 can move downward, away from the flange 568. The user can move the hinge assembly 500 from the tube retention configuration to the tube insertion configuration when the rack 400 is removed from the receiving bay. In some embodiments, the user slides then pivots the hinge plate 552 to move the hinge assembly 500 from the tube retention configuration to the tube insertion configuration. The force of the spring 524 is overcome to move the hinge assembly 500 from the tube retention configuration to the tube insertion configuration. In some embodiments, the user provides both the sliding and pivoting actuation forces to transition from the tube retention configuration to the tube insertion configuration. The user can exert a sliding force, then an upward force or clockwise force on the hinge plate 552 to move the move the hinge assembly 500 from the tube retention configuration to the tube insertion configuration. The side surface 558 of the hinge plate 552 near the right side may be easier to grasp since it is laterally offset from the closest sample tube 102 in the tube retention configuration. It will be understood that any of portion the hinge plate 552 or any portion of the slide lock 530 can be contacted by an actuation force to slide or pivot the hinge assembly 500. The hinge plate 552 can be grasped near the side surfaces 558.

After the sample tubes 102 are loaded, the user can move the hinge assembly 500 from the tube insertion configuration to the tube retention configuration when the rack 400 is removed from the receiving bay. In some embodiments, the user pivots then slides the hinge plate 552 to move the hinge assembly 500 from the tube retention configuration to the tube insertion configuration. In some embodiments, the user pivots the hinge plate 552 and the spring 524 slides the hinge plate 552 to move the hinge assembly 500 from the tube retention configuration to the tube insertion configuration. In some embodiments, the user provides only pivoting actuation forces to transition from the tube insertion configuration to the tube retention configuration. For instance, the user can exert a downward force or counterclockwise force on the hinge plate 552 to transition the hinge assembly 500. Alternatively or additionally, the self-locking tab 480 can move the hinge assembly 500 from the tube insertion configuration to the tube retention configuration

The hinge assembly 500 has advantages over other alternative systems designed to retain the sample tubes 102 in the sample tube holder during pipetting operations. Advantageously, embodiments of the present disclosure reliably restrain sample tubes 102 in the sample tube holder and can reduce the number of tubes experiencing substantial vertical lift. Embodiments of the rack 400 that include a hinge assembly 500 according to the present disclosure reliably retain the sample tubes 102 during instrument workflow. The upper opening 444 of the sample tube holder 408 can constrain the sample tube 102 from moving in the horizontal direction. In some cases, the hinge assembly 500, specifically the hinge plate 552, can constrain the sample tube 102 from moving substantially in the vertical direction. The sample tubes may have slight vertical movement due to a clearance between the cap 172 and the hinge plate 552.

The partition 250 can lock the hinge plate 552 in the tube retention configuration, thereby locking the sample tubes 102 into place and limiting vertical lifting of the sample tubes 102. The partition 250 and the self-locking tab 480 interact to apply a pivoting force to the hinge plate 552. The pivoting force of the self-locking tab 480 in combination with the biasing force of the spring 524 can transition the hinge plate 552 from the tube insertion configuration to the tube retention configuration. In some embodiments, the insertion of the rack 400 into the receiving bay ensures that the self-locking tab 480 is actuated. Advantageously, the shape, size, and position of the hinge assembly 500 can be tailored to adjust the maximum retaining force required to retain the sample tubes 102.

Advantageously, embodiments of the present disclosure can retain the sample tubes 102 in one motion, reliably and consistently. The hinge plate 552 of the hinge assembly 500 is pivoted by the actuation force of the partition 250 as the partition 250 comes into contact with the self-locking tab 480. In some embodiments, the lowering of the rack 400 relative to the partition 250 is the motion that slides the self-locking tab 480 and thus pivots the hinge plate 552. The partition 250 applies an upward force on the self-locking tab 480, thus pivoting the hinge plate 552. Once pivoted, the biasing force of the spring 524 slides the hinge plate 552. Upon the sliding of the hinge plate 552, the minor indents 572 overlie each sample tube 102 instead of the major indents 570.

The minor indents 572 of the hinge plate 552 can contact the plurality of sample tubes 102 or be spaced a small vertical distance from the plurality of sample tubes 102 in the tube retention configuration. The hinge plate 552 can simultaneous restrain all of the sample tubes 102 in the sample tube holder 408. The unitary structure of the hinge plate 552 allows a consistent force to be applied to each sample tube 102. In addition, the pivoting motion of the hinge plate 552 is repeatable such that the same actuation force causes the same pivoting motion of the hinge plate 552. Advantageously, the hinge plate 552 moves easily between configurations for easy loading and unloading of batches of sample tubes during a sequence of diagnostic tests performed consecutively using the same rack, thereby minimizing user error and time to load and unload the rack, and increasing pipetting efficiency.

In some embodiments, the hinge assembly 500 allows some vertical movement of the sample tube 102 within the sample tube holder 408 in the tube retention configuration. In some embodiments, one or more sample tubes may vertically lift a small distance during pipetting operations, but the presence of the hinge plate 552 restrains the sample tube from moving vertically to an extent that affects performance of the pipetting system. In some embodiments, the hinge assembly 500 contacts the sample tube 102, such as contacting the cap 172 of the sample tube 102 with the minor indents 572. In some embodiments, the hinge assembly 500 merely overlies the cap 172 of the sample tube 102 with the minor indents 572. In some embodiments, the hinge assembly 500 prevents substantially all vertical movement of the sample tube 102 within the sample tube holder 408 in the tube retention configuration. In some embodiments, the hinge plate 552 is positioned vertically above a portion of the sample tube 102. In some embodiments, the hinge assembly 500, specifically the minor indents 572, covers a portion of the circumference of the cap 172 of the sample tube 102 without obstructing an area C of the cap 172 from a pipette tip. Embodiments of the hinge assembly according to the present disclosure include additional advantages. The hinge assembly 500 can be used with any design of the sample tube 102. The hinge assembly 500 can also be used with any design of the cap 172.

Advantageously, the hinge plate 552 can prevent or limit vertical movement of the sample tube 102 within the sample tube holder 408 in the tube retention configuration. The hinge plate 552 can prevent or limit vertical lift off of the sample tube 102 when the contents of the sample tube 102 are accessed by the liquid dispenser. The hinge plate 552 can prevent or limit vertical movement of the sample tube 102 within the sample tube holder 108 during fluid processing operations. The hinge plate 552 can prevent or limit vertical lift of the sample tubes 102 by a pipette tip. The pipetting operations can be performed within the diagnostic apparatus 300. When within the diagnostic apparatus 300, the hinge assembly 500 is in the tube retention configuration.

The hinge assembly 500 can include several advantages. The hinge assembly 500 can be easy and intuitive to use. The hinge assembly 500 can be automatically actuated such as by the simple action of inserting the rack 400 into a diagnostic apparatus 300, as described herein. Using the hinge assembly 500 can be a simple, self-learning process. The hinge support 502 can span the reagent housing 410, or a portion thereof, along a front surface of the reagent housing 410. The hinge assembly can be easily actuated by the user, or in some embodiments, by the self-locking tab 480.

The hinge assembly 500 can lock the sample tubes 102 in place when the rack 400 is placed in the diagnostic apparatus 300. The self-locking tab 480 is a locking mechanism that locks the hinge plate 552 in a position to retain the sample tubes 102 in the rack 400. The hinge assembly 500 can facilitate complete retention of the sample tubes 102 within the sample tube holder 408. The hinge assembly 500 can act as a cover over each sample tube 102. In the illustrated embodiment, all of the sample tubes 102 within the sample tube holder 408 are restrained under one physical part, the hinge plate 552.

Advantageously, embodiments of the present disclosure unlock the sample tubes in one motion, reliably and consistently. The hinge plate 552 of the hinge assembly 500 can be held in position by the partition 250 of the receiving bay that receives the rack 400. The rack 400 can be lifted relative to the partition 250 to alleviate the force of the partition 250. The self-locking tab 480 can slide vertically away from the hinge plate 552. The user can apply a pivoting or downward force to the hinge plate 552. Upon pivoting the hinge plate 552, the hinge plate 552 can slide relative to the hinge support 502. Prior to lowering the rack 400 into the diagnostic apparatus 300 or after removing the rack 400 from the diagnostic apparatus 300, the hinge assembly 500 can be freely pivoted and slid by the user to the tube insertion configuration.

In the tube insertion configuration, the hinge plate 552 is pivoted upward from the sample tube holder 408. The major indents 570 overlie the upper openings 444 of the sample tube holder 408. The sample tubes 102 can be easily inserted without the obstruction of the hinge plate 552. A first sample tube 102 can be easily unloaded from the sample tube holder 408 and the next, second sample tube 102 can be loaded. The hinge assembly 500 does not interfere with tube loading and unloading operations. Advantageously, the hinge assembly 500 allows the user to easily load and unload the sample tubes 102 into the rack 400.

The hinge assembly 500 can be backward compatible such that racks that do not have the hinge assembly 500 can be advantageously retrofitted to include the hinge assembly 500. In some embodiments, the sample tube holder of the rack to be retrofitted can be removed from the reagent housing. As described herein, the sample tube holder is configured to couple and uncouple with the reagent housing via one or more fasteners 412. The openings of the sample tube holder are configured to align with the first set of openings in the reagent housing. Any suitable fastener 412 can extend through the sample tube holder and the reagent housing to couple the sample tube holder to the reagent housing. The one or more fasteners 412 can also decouple the sample tube holder to the reagent housing. Any prior hinge assembly or retention member can be removed from the rack to be retrofitted. In some embodiments, the sample tube holder remains in place during retrofitting. In some embodiments, the sample tube holder does not need to be decoupled from the reagent housing during the process of adding the hinge assembly to the rack.

The hinge support 502 has one or more openings 510 configured to accept a fastener 414. The one or more openings 510 extend from the front surface 504 to the rear surface 506. While three openings 510 are illustrated, the hinge support 502 can include any number of openings 510. The openings 510 are configured to align with the second set of openings in the reagent housing to be retrofitted. When a fastener 414 extends through the corresponding openings, the hinge support 502 of the hinge assembly 500 is rigidly coupled to the reagent housing to be retrofitted.

The middle fastener 414 can also couple to self-locking tab 480. When the fastener 414 extends through the corresponding openings in the hinge assembly 500, the self-locking tab 480, and the reagent housing to be retrofitted, the self-locking tab 480 is able to slide relative to the reagent housing. The opening 490 is dimensioned larger than the corresponding fastener 414. The opening 490 allows the self-locking tab 480 to slide in a vertical direction relative to the reagent housing. The opening 490 can be any shape to allow vertical movement when the self-locking tab 480 is coupled to the reagent housing. In embodiments where the sample tube holder was removed for installation of the hinge assembly 500, the sample tube holder can be coupled to the reagent housing. In some embodiments, the hinge assembly 500 is installed without decoupling the sample tube holder from the reagent housing. In some embodiments, a kit is supplied to retrofit racks. The kit can include the hinge assembly 500. The kit can include the self-locking tab 480. The kit can include the fasteners 412 to couple the sample tube holder to the reagent housing. The kit can include the fasteners 414 to couple the hinge assembly to the reagent housing. The kit can include tools such as tools for rotating the fasteners. In some embodiments, the kit can include include a 1/16th hex screw driver. In some embodiments, the kit can include 1/16th hex 1-key wrench. In some embodiments, the kit can include a threadlocking adhesive. In some embodiments, the kit can include Loctite® 242. The kit can include any additional component described herein.

The hinge assembly 500 can be incorporated directly into rack 400, such as by securing fasteners 412, 414 as described herein. The hinge assembly 500 and the self-locking tab 480 can be easily installed between the sample tube holder 408 and the reagent housing 410. The hinge assembly 500 can be easily introduced into the manufacturing supply chain or can be installed by the user at the point of use of the rack. The sample tube holder 408, the hinge assembly 500, the self-locking tab 480, and the reagent housing 410 can form a unitary structure. The unitary structure can be inserted into the receiving bay in one fluid motion and removed from the receiving bay in one fluid motion.

The rack 400 can be designed so that it can be easily inserted and removed from the diagnostic apparatuses 300, illustrated in FIGS. 17 and 18. The reagent housing 410 can include one or more registration members 430 that facilitate positioning of the rack 400. The registration members 430 can ensure that the rack 400 is inserted in a proper orientation to be actuated by the partition 250. It is desirable that the rack 400 be positioned correctly within the diagnostic apparatus 300, with movement limited thereafter, so that movement of the liquid dispenser will not be compromised during liquid handling operations. In some embodiments, the rack 400 or the diagnostic apparatus 300 can include a sensor configured to indicate proper placement of the rack 400 in the diagnostic apparatus 300.

It will be apparent that embodiments of the hinge assembly of the present disclosure can be actuated in many different ways. For example, in one non-limiting embodiment, the partition 250 is stationary and the rack 400 interacts with the partition 250 as it is lowered into the diagnostic apparatus 300, thereby actuating the hinge assembly 500. When placing the rack 100 within the diagnostic apparatus 300, the partition 250 is shaped and sized to come into contact with the self-locking tab 480. Advantageously, the sample tubes 102 are constrained in the rack 400 in the horizontal direction by at least the upper opening 444 of the sample tube holder 408 and are constrained in the vertical direction by at least the hinge assembly 500.

The rack 400 can be designed so that it can be easily removed and reinserted into the diagnostic apparatus 300. Upon removal from the diagnostic apparatus 300, the partition 250 no longer exerts a force against self-locking tab 480. The hinge plate 552 can remain in the tube retention configuration until actuated by the user. The user can pivot and/or slide the hinge plate 552 such that one or more sample tubes 102 can be easily removed by sliding the one or more sample tubes 102 vertically, upward. New sample tubes 102 can be easily inserted by sliding the one or more sample tubes 102 vertically, downward. The rack 400 can be reinserted into the diagnostic apparatus 300. The action of insertion can actuate the hinge assembly 500 to retain the new set of sample tubes 102. The actuation of the self-locking tabs 480 can be automatic, requiring no further action by the user. The act of engaging the self-locking tabs 480 with the partition 250 can be the same act as inserting the rack 400 within the diagnostic apparatus 300.

It will be understood that embodiments of the rack 400 can be received in a receiving bay that does not include a partition 250. The hinge assembly 500 in such cases can be transitioned from the tube insertion configuration to the tube retention configuration by actuation of the hinge plate 552 by the user. In some embodiments, user transitions the hinge plate 552 from the tube insertion configuration to the tube retention configuration regardless of the presence of the self-locking tab 480. In some embodiments, the self-locking tab 480 is an additional protection to ensure that the hinge assembly 500 has been actuated to the tube retention configuration. In some embodiments, the hinge assembly 500 can be locked either by the user or the self-locking tab 480. In some embodiments, the rack 400 can be loaded with one or more sample tubes 102 only prior to being inserted into the diagnostic apparatus 300 such as use with a receiving bay with the partition 250. In some embodiments, the rack 400 can be loaded with one or more sample tubes 102 prior to and after being inserted into the diagnostic apparatus 300 such as use with a receiving bay without the partition 250.

The hinge assembly 500 is a mechanical assembly that may slide and pivot for tube loading and removal when out of the diagnostic apparatus 300. In the tube insertion configuration, the hinge assembly has a stable state such that the hinge assembly is locked in this open or loadable configuration. The hinge assembly 500 is a mechanical assembly that may slide and pivot for tube retention when out of the diagnostic apparatus 300 or when within the diagnostic apparatus 300. In the tube retention configuration, the hinge assembly has a stable state such that the hinge assembly is locked in this closed configuration. The hinge assembly 500 utilizes springs and self-closing components to ensure the hinge assembly 500 exists in closed state when placed into the diagnostic apparatus 300. The sample tubes 102 are restrained vertically by covering a minimal surface area on top of the cap 172 of the sample tube 102. In the tube retention configuration, in some embodiments, the hinge plate 552 of the hinge assembly 500 does not touch tops of tubes 102. The tube retention configuration allows for pipetting operations while preventing escape of the sample samples tubes 102. The hinge assembly 500 can be considered a spring lock tube restraint. The hinge assembly 500 is relevant for sample collection and transport. The hinge assembly 500 is relevant for mechanics and automation.

The hinge assembly 500 is a mechanism that applies a vertical restraint. The hinge assembly 500 can replace other designs including a series of spring fingers as described herein. The hinge assembly 500 has two states when out of the diagnostic apparatus 300: the tube retention configuration, where the sample tubes 102 are secured and not able to escape the rack 400; and the tube insertion configuration, where a user can remove the sample tubes 102, insert the sample tubes 102, and/or remove the sample tubes 102 from the rack 400. In some embodiments, the hinge assembly 500 has only two possible states when out of the diagnostic apparatus. In some embodiments, the hinge assembly 500 can only operate in tube retention configuration when it is in the diagnostic apparatus 300. In some embodiments, the hinge assembly 500 transitions to the tube retention configuration when it is inserted into the diagnostic apparatus 300

The hinge assembly 500 works by using two springs 524 that slide the slide lock 530 and thus the hinge plate 552 from side to side within the hinge support 502 and along hinge pins 522. In the tube retention configuration, the slide lock 530 prevents rotation of the hinge plate 552. The flange 540 of the slide lock 530 is within the channel 518. The channel 518 prevents or limits rotation of the flange 540 of the slide lock 530, and thus prevents or limits rotation of the hinge plate 552 attached to the slide lock 530. In the tube retention configuration, the self-locking tab 480 can be actuated to push upward on the flange 568, for instance when the rack 400 is within the diagnostic apparatus 300. In the tube retention configuration, the self-locking tab 480 may not be actuated, for instance when the rack 400 is outside of diagnostic apparatus 300. The self-locking tab 480 is a self-closing mechanism incorporated on the design to ensure that the hinge assembly 500 is always in the tube retention configuration when placed in the diagnostic apparatus 300.

In the tube insertion configuration, the slide lock 530 is slid relative to the channel 518. The flange 540 of the slide lock 530 is initially located within the lower opening 516. The flange 540 of the slide lock 530 is then pivoted outward from the lower opening 516. The slide lock 530 is pivoted relative to the hinge support 502, and thus the hinge plate 552 attached to the slide lock 530 is pivoted relative to the hinge support 502. When the spring 524 and slide lock 530 have slid such that the flange 540 aligns with the opening in the surface 504, the flange 540 can rotate out of the lower opening 516, thereby causing the hinge plate 552 to rotate.

The hinge assembly 500 has advantages over a spring finger design that holds the sample tubes in place through contact friction. The spring constant used to generate the contact friction had variable spring constants and can be easily damaged resulting in escape of sample tubes 102. The hinge assembly 500 does not rely on friction and springs for tube restraint. In the tube retention configuration, the sample tube 102 has no clear path out of the hinge assembly 500. The sample tube 102 has a hard stop preventing it from escaping via interactions with the hinge plate 552. The hinge assembly 500 also makes it easier for a user to load and remove tubes. When the hinge assembly 500 is in the tube insertion configuration, a user has two hands free to insert and remove sample tubes 102. Under some limited circumstances, the rack can be inverted and the sample tubes 102 can be dumped out of the rack 400 all at once. In some embodiments, a single input force from a user is needed to load or unload the twelve sample tubes 102 instead of twelve individual input forces required by the users.

The hinge assembly 500 can prevent or limit vertical movement of the sample tubes 102. The hinge assembly 500 can prevent or limit the escape of the sample tube 102 from the sample tube holder 408. The hinge assembly 500 can prevent or limit the escape of the sample tubes 102 from the rack 400 during an instruments workflow. A sample tube escape would cause the run to be interrupted and require user intervention.

The hinge assembly 500 can use springs for motion. The hinge assembly 500 does not use a motor for motion. The hinge assembly 500 uses less surface area to restrain the sample tubes 102. The hinge assembly 500 is used to restrain tubes. The hinge assembly 500 uses springs for a sliding motion to close and open. The hinge assembly 500 uses a sliding hinge plate 552 for tube restraint.

The hinge plate 552 of the hinge assembly 500 is pivoted by an actuation force. In some embodiments, the self-locking tab 480 is the motion that pivots the hinge plate 552 and thus locks the sample tubes 102. Prior to utilization of the self-locking tab 480, the hinge plate 552 can be in the tube insertion configuration such that the sample tube 102 can be easily loaded into the sample tube holder 408. When in the tube retention configuration, the hinge plate 552 consistently provides a vertical restraint to the plurality of sample tubes 102 such that the hinge plate 552 can simultaneously restrain all of the sample tubes 102 in the sample tube holder 408. The unitary structure of the hinge plate 552 allows a consistent force to be applied to each sample tube 102. In addition, the pivoting motion of the hinge plate 552 is repeatable such that the same actuation force causes the same pivoting and/or sliding motion of the hinge plate 552. Advantageously, the hinge plate 552 moves easily between configurations for easy loading and unloading of batches of sample tubes 102 during a sequence of diagnostic tests performed consecutively using the same rack 400, thereby minimizing user error and time to load and unload the rack, and increasing pipetting efficiency.

The foregoing description is intended to illustrate various aspects of the present inventions. It is not intended that the examples presented herein limit the scope of the present inventions. The technology now being fully described, it will be apparent to one of ordinary skill in the art that many changes and modifications can be made thereto without departing from the spirit or scope of the appended claims.

What is claimed is:

1. An apparatus for holding sample tubes, comprising:
a sample tube holder comprising an opening configured to accept a sample tube; and
a hinge assembly comprising a hinge plate and a hinge support, the hinge plate configured to slide and pivot relative to the hinge support between a first configuration and a second configuration, the hinge plate positioned to permit insertion of the sample tube in the opening in the first configuration, the hinge plate positioned to limit vertical movement of the sample tube within the sample tube holder in the second configuration.

2. The apparatus of claim 1, further comprising a slide lock coupled to the hinge plate.

3. The apparatus of claim 2, wherein the slide lock is configured to slide and pivot relative to a hinge pin, wherein the hinge pin is coupled to the hinge support.

4. The apparatus of claim 2, further comprising a spring configured to bias the slide lock against an interior surface of the hinge support.

5. The apparatus of claim 1, further comprising a reagent housing.

6. The apparatus of claim 5, wherein the sample tube holder and the reagent housing are coupled.

7. The apparatus of claim 5, wherein the hinge support and the reagent housing are coupled.

8. The apparatus of claim 1, wherein the sample tube holder comprises a plurality of openings configured to accept a plurality of sample tubes.

9. The apparatus of claim 1, wherein the sample tube holder comprises two openings configured to accept the sample tube.

10. The apparatus of claim 1, wherein the opening constrains the sample tube in a horizontal direction when the sample tube is received in the sample tube holder.

11. The apparatus of claim 1, wherein the hinge plate is configured to limit vertical movement of the sample tube within the sample tube holder.

12. The apparatus of claim 1, wherein the hinge plate comprises a minor indent along an edge of the hinge plate, wherein the minor indent is configured to overlie a cap of the sample tube.

13. The apparatus of claim 1, wherein the hinge plate comprises a major indent along an edge of the hinge plate, wherein the major indent is configured to allow a sample tube to be removed from or inserted into the sample tube holder.

14. The apparatus of claim 1, further comprising the sample tube.

15. The apparatus of claim 1, further comprising a self-locking tab positioned relative to the hinge plate.

16. A method comprising:
inserting a sample tube into an opening of a sample tube holder;
pivoting a hinge plate relative to a hinge support;
sliding the hinge plate relative to the hinge support once pivoted, wherein the hinge plate is configured to limit vertical movement of the sample tube within the sample tube holder.

17. The method of claim 16, wherein the hinge plate slides under the biasing force of a spring.

18. The method of claim 16, wherein a top surface of the hinge plate is rotated away from a vertical axis of the sample tube when the sample tube is inserted, and wherein the hinge plate is pivoted to be generally perpendicular to the vertical axis of the sample tube.

19. The method of claim 16, further comprising inserting a pipette tip into the sample tube when the sample tube is within the sample tube holder and the hinge plate has pivoted and slid.

20. The method of claim 16, further comprising removing a pipette tip from the sample tube when the sample tube is within the sample tube holder and the hinge plate has pivoted and slid.
